(19) United States
(12) Patent Application Publication
(10) Pub. No.: US 2025/0153047 A1
(43) Pub. Date: May 15, 2025

(54) NON-TRANSITORY COMPUTER READABLE MEDIUM, INFORMATION PROCESSING METHOD, AND GAME APPARATUS

(71) Applicant: CYGAMES, INC., Tokyo (JP)

(72) Inventors: Koichi Kada, Tokyo (JP); Yuki Tamura, Tokyo (JP); Yujiro Deguchi, Tokyo (JP)

(73) Assignee: CYGAMES, INC., Tokyo (JP)

(21) Appl. No.: 19/021,540

(22) Filed: Jan. 15, 2025

Related U.S. Application Data
(63) Continuation of application No. PCT/JP2023/026104, filed on Jul. 14, 2023.

(30) Foreign Application Priority Data
Jul. 20, 2022 (JP) 2022-115240
Aug. 12, 2022 (JP) 2022-129063

(51) Int. Cl. A63F 13/537

(52) U.S. Cl. CPC A63F 13/537

(57) ABSTRACT

A non-transitory computer readable medium stores a program causing a computer to execute: enabling a player to select a first type command that enables a predetermined parameter to be obtained; displaying a possessed value of the predetermined parameter possessed by the player on a selection screen that enables the player to select the first type command; obtaining the predetermined parameter based on the first type command being selected; displaying a plurality of options based on a second type command being selected; giving the player a reward associated with the option selected by the player when the possessed value is equal to or greater than the required value; enabling the option selected by the player to be reserved when the possessed value is not equal to or greater than the required value; and displaying on the selection screen notification information corresponding to the predetermined parameter associated with the option reserved.

### CROSS REFERENCE TO RELATED APPLICATIONS

This application is a continuation application of International Application No. PCT/JP2023/026104, filed on Jul. 14, 2023, which claims priority to Japanese Patent Application No. 2022-115240, filed on Jul. 20, 2022, and Japanese Patent Application No. 2022-129063, filed on Aug. 12, 2022, the entire contents of which are incorporated by reference herein.

### BACKGROUND ART

### Technical Field

The present invention relates to an information processing program, an information processing method, and a game apparatus.

In the related art, a nurture game is known in which players nurture a character, as described in Patent Document 1 for example. In the nurture game described in Patent Document 1, a player can obtain various rewards as the game progresses.

### CITATION LIST

### Patent Literature

Patent Document 1: JP 2021-121396

### SUMMARY OF INVENTION

### Technical Problem

In a nurture game such as that described above, a player may obtain a reward by spending points or parameters possessed by the player. In this case, it is necessary for the player to frequently compare the points necessary for obtaining a reward and the points possessed by the player. Accordingly, the player may be required to perform this troublesome action.

An object of the present invention is to provide an information processing program, an information processing method, and a game apparatus capable of enhancing the operability for a player.

### Solution to Problem

To solve to above-described problem, an information processing program is provided for causing a computer to execute:
processing of enabling a player to select a first type command that enables a predetermined parameter to be obtained;
processing of displaying a possessed value of the predetermined parameter possessed by the player on a selection screen that enables the player to select the first type command;
processing of obtaining the predetermined parameter based on the first type command being selected;
processing of displaying a plurality of options in which a reward obtainable by the player and a required value of the predetermined parameter are associated, based on a second type command, different from the first type command, being selected;
processing of determining whether the possessed value of the predetermined parameter possessed by the player is equal to or greater than the required value of the predetermined parameter associated with the option selected by the player;
processing of giving the player the reward associated with the option selected by the player when the possessed value is equal to or greater than the required value;
processing of enabling the option selected by the player to be reserved when the possessed value is not equal to or greater than the required value; and
processing of displaying, on the selection screen, notification information corresponding to the predetermined parameter associated with the option reserved.

The predetermined parameter may include a plurality of predetermined parameters, and the notification information may be displayed corresponding to the predetermined parameter with the possessed value not being equal to or greater than the required value.

The notification information may be information that enables a difference between the possessed value and the required value to be identified.

The information processing program may further cause a computer to execute processing of displaying predetermined notification information based on the possessed value of the predetermined parameter possessed by the player becoming equal to or greater than the required value of the predetermined parameter associated with the reserved option.

The processing of displaying the plurality of options may include displaying the plurality of options based on an operation input by the player with respect to the notification information.

The information processing program may further cause a computer to execute processing of canceling a reservation based on the option, other than the reserved option, being selected in a state in which any one of the options is reserved.

To solve the above-described problem, an information processing method is provided that is executed by one or more computers, the information processing method including:
processing, by the one or more computers, of enabling a player to select a first type command that enables a predetermined parameter to be obtained;
processing, by the one or more computers, of displaying a possessed value of the predetermined parameter possessed by the player on a selection screen that enables the player to select the first type command;
processing, by the one or more computers, of obtaining the predetermined parameter based on the first type command being selected;
processing, by the one or more computers, of displaying a plurality of options in which a reward obtainable by the player and a required value of the predetermined parameter are associated, based on a second type command, different from the first type command, being selected;
processing, by the one or more computers, of determining whether the possessed value of the predetermined parameter possessed by the player is equal to or greater than the required value of the predetermined parameter associated with the option selected by the player;
processing, by the one or more computers, of giving the player the reward associated with the option selected by the player when the possessed value is equal to or greater than the required value;
processing, by the one or more computers, of enabling the option selected by the player to be reserved when the possessed value is not equal to or greater than the required value; and
processing, by the one or more computers, of displaying, on the selection screen, notification information corresponding to the predetermined parameter associated with the option reserved.

To solve the above-described problem, a game apparatus is provided that includes:
one or more computers, wherein
the one or more computers execute:
processing of enabling a player to select a first type command that enables a predetermined parameter to be obtained;
processing of displaying a possessed value of the predetermined parameter possessed by the player on a selection screen that enables the player to select the first type command;
processing of obtaining the predetermined parameter based on the first type command being selected;
processing of displaying a plurality of options in which a reward obtainable by the player and a required value of the predetermined parameter are associated, based on a second type command, different from the first type command, being selected;
processing of determining whether the possessed value of the predetermined parameter possessed by the player is equal to or greater than the required value of the predetermined parameter associated with the option selected by the player;
processing of giving the player the reward associated with the option selected by the player when the possessed value is equal to or greater than the required value;
processing of enabling the option selected by the player to be reserved when the possessed value is not equal to or greater than the required value; and
processing of displaying, on the selection screen, notification information corresponding to the predetermined parameter associated with the option reserved.

### Effects of Disclosure

According to the present invention, it is possible to enhance operability for a player.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram for describing an example of a home screen. FIG. 3B is a diagram for describing an example of an option setting screen. FIG. 3C is a diagram for describing an example of a profile setting screen. FIG. 3D is a diagram for describing an example of a home setting screen.

FIG. 4 is a diagram for describing a rough progression flow of a nurture game.

FIG. 5A is a diagram for describing a nurture target character selection screen. FIG. 5B is a first diagram for describing a character detail screen. FIG. 5C is a second diagram for describing the character detail screen.

FIG. 6A is a diagram for describing an ability parameter (initial value) table. FIG. 6B is a diagram for describing an aptitude parameter (initial value) table.

FIG. 6C is a diagram for describing a skill table. FIG. 6D is a diagram for describing an exclusive event table.

FIG. 7A is a first diagram for describing an inheritance character selection screen. FIG. 7B is a first diagram for describing a nurtured character list screen.

FIG. 7C is a second diagram for describing the inheritance character selection screen. FIG. 7D is a third diagram for describing the inheritance character selection screen.

FIG. 8 is a diagram for describing an inheritance system.

FIG. 9 is a diagram for describing factor information.

FIG. 10A is a diagram for describing a compatibility determination target, and FIG. 10B is a diagram for describing compatibility determination items.

FIG. 11A is a diagram for describing sorting conditions. FIG. 11B is a diagram for describing filter conditions.

FIG. 12 is a first diagram for describing a character detail dialog.

FIG. 13 is a second diagram for describing the character detail dialog.

FIG. 14 is a third diagram for describing the character detail dialog.

FIG. 15 is a diagram for describing a skill display dialog.

FIG. 16A is a first diagram for describing a support card organization screen. FIG. 16B is a diagram for describing a support card selection screen. FIG. 16C is a second diagram for describing the support card organization screen.

FIG. 17A is a diagram for describing a support card table. FIG. 17B is a diagram for describing a support effect table. FIG. 17C is a diagram for describing a base skill table. FIG. 17D is a diagram for describing a support event table.

FIG. 18A is a diagram for describing a final confirmation screen. FIG. 18B is a diagram for describing a preset selection screen.

FIG. 19 is a diagram for describing selection items in each turn.

FIG. 20 is a diagram for describing a game screen.

FIG. 21A is a first diagram for describing a training screen. FIG. 21B is a second diagram for describing the training screen. FIG. 21C is a diagram for describing a training result notification screen. FIG. 21D is a diagram for describing an event screen.

FIG. 22A is a first diagram for describing a skill screen. FIG. 22B is a second diagram for describing the skill screen.

FIG. 23A is a first diagram for describing a race selection screen. FIG. 23B is a diagram for describing a race start screen. FIG. 23C is a first diagram for describing a race result screen. FIG. 23D is a second diagram for describing the race result screen.

FIG. 24A is a diagram for describing an example of a live show preparation screen. FIG. 24B is a diagram for describing a confirmation dialog.

FIG. 25 is a diagram for describing examples of a first bonus and a second bonus.

FIG. 26 is a diagram for describing an example of path information for live show music pieces.

FIG. 27 is a diagram for describing an example of a reservation dialog.

FIG. 28A is a first diagram for describing an example of a reservation notification mark. FIG. 28B is a second diagram for describing an example of the reservation notification mark. FIG. 28C is a diagram for describing an example of the live show preparation screen in the reserved state. FIG. 28D is a diagram for describing an example of the reservation dialog in the reserved state.

FIG. 29 is a diagram for describing an example of a reserved confirmation dialog.

FIG. 30A is a diagram for describing another example of the live show preparation screen in the reserved state.

FIG. 30B is a diagram for describing an example of the confirmation dialog at the time of a reservation change.

FIG. 30C is a diagram for describing an example of a reservation change confirmation dialog.

FIG. 31 is a diagram for describing an example of a notification information dialog.

FIG. 32A is a diagram for describing an example of a live show start screen. FIG. 32B is a diagram for describing an example of a live show event screen.

FIG. 33 is a diagram for describing a rough flow of turn-start processing.

FIG. 34 is a diagram for describing a placed/not placed table.

FIG. 35A is a diagram for describing a training level table. FIG. 35B is a diagram for describing a fixed increase value (speed) table. FIG. 35C is a diagram for describing a fixed increase value table (power). FIG. 35D is a diagram for describing a bonus addition rate table.

FIG. 36A is a diagram for describing performance items associated with training items. FIG. 36B is a diagram for describing fixed increase values of performance parameters.

FIG. 36C is a diagram for describing the bonus addition rate of a performance parameter.

FIG. 37 is a diagram for describing a second event table.

FIG. 38A is a diagram for describing a nurture completion screen. FIG. 38B is a second diagram for describing the nurture completion screen. FIG. 38C is a third diagram for describing the nurture completion screen.

FIG. 39 is a diagram for describing a configuration of a memory in the player terminal and a function as a computer.

FIG. 40 is a diagram for describing a configuration of a memory in the server and a function as a computer.

FIG. 41 is a sequence diagram for describing processing of the player terminal and the server related to the nurture game.

FIG. 42 is a flowchart for describing nurture stage processing in the server.

FIG. 43 is a flowchart for describing turn-start processing in the server.

FIG. 44 is a flowchart for describing nurture stage processing in the player terminal.

FIG. 45 is a flowchart for describing turn-start processing in the player terminal.

FIG. 46 is a flowchart for describing in-turn processing in the player terminal.

FIG. 47 is a flowchart for describing command selection processing in the player terminal.

FIG. 48 is a first flowchart for describing selection processing in the player terminal.

FIG. 49 is a second flowchart for describing the selection processing in the player terminal.

FIG. 50 is a first flowchart for describing in-turn processing in the server.

FIG. 51 is a second flowchart for describing the in-turn processing in the server.

FIG. 52 is a flowchart for describing command reception processing in the player terminal.

FIG. 53 is a first diagram for describing a method of determining a live show music piece according to a modified example.

FIG. 54 is a second diagram for describing a method of determining a live show music piece according to a modified example.

### DESCRIPTION OF EMBODIMENTS

Hereinafter, an aspect of an embodiment of the present invention will be described in detail with reference to the accompanying drawings. Numerical values and the like described in the embodiments are merely examples for facilitating understanding and do not limit the present invention unless otherwise specified. In the present specification and the drawings, elements having substantially the same function and configuration are denoted by the same reference numerals, redundant description thereof will be omitted, and elements not directly related to the present invention will not be illustrated.

Overall Configuration of Information Processing System S

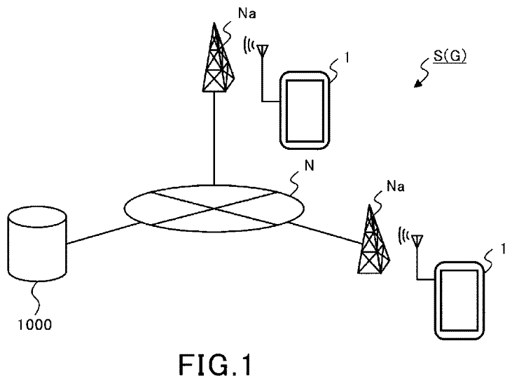

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of the game, and the game can progress through cooperation between the player terminal 1 and the server 1000.

The player terminal 1 can establish communication with the server 1000 via the communication network N. The player terminal 1 widely includes an electronic device capable of establishing a wireless or wired communication connection to the server 1000. Examples of the player terminal 1 include a smartphone, a mobile phone, a tablet device, a personal computer, and a game console. In the present embodiment, a case where a smartphone is used as the player terminal 1 will be described.

The server 1000 is communicatively connected to a plurality of the player terminals 1. The server 1000 accumulates various types of information for each player who plays the game. In addition, the server 1000 mainly performs processing such as updating the accumulated information and downloading images and various types of information to the player terminal 1 based on an operation input from the player terminal 1.

The communication base station Na is connected to the communication network N and wirelessly exchanges information with the player terminal 1. The communication network N is implemented as a cellular network, an Internet network, a local area network (LAN), a dedicated line, or the like, and realizes a wireless or wired communication connection between the player terminal 1 and the server 1000.

### Hardware Configuration of Player Terminal 1 and Server 1000

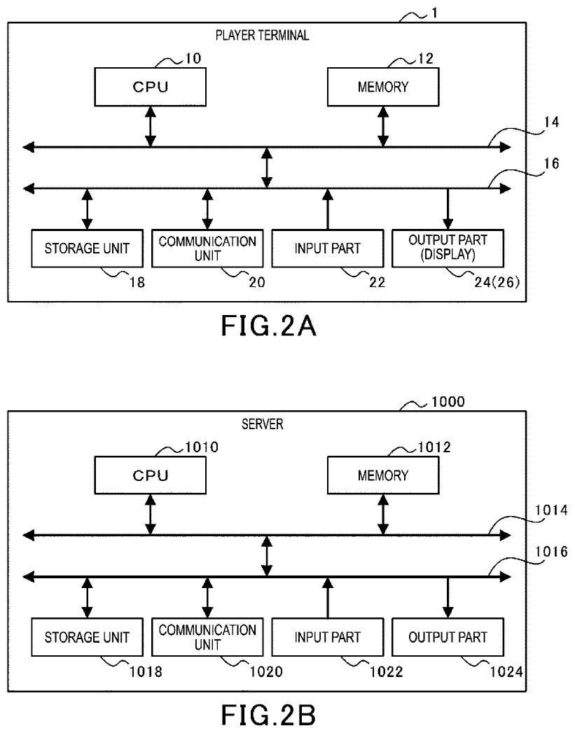

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

Note that the configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and description of the server 1000 will be omitted.

The CPU 10 operates a program stored in the memory 12 to control the progress of the game. The memory 12 is implemented as a read-only memory (ROM) or a random-access memory (RAN) and stores programs and various types of data necessary for the progress control of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is implemented as a semiconductor memory such as a dynamic random access memory (DRAM) and stores various types of programs and data. In the player terminal 1, the programs and data stored in the storage unit 18 are loaded into the memory 12 (RAN) by the CPU 10.

The communication unit 20 is wirelessly communicatively connected to the communication base station Na and exchanges information such as various types of data and programs with the server 1000 via the communication network N. In the player terminal 1, the programs or the like received from the server 1000 are stored in the memory 12 or the storage unit 18.

The input part 22 is implemented as, for example, a touch panel, a button, a keyboard, a mouse, a directional pad, or an analog controller for inputting player operations (receiving operations). Alternatively, the input part 22 may be a dedicated controller provided with the player terminal 1 or connected (externally attached) to the player terminal 1. Furthermore, the input part 22 may be implemented as an acceleration sensor that detects an inclination or movement of the player terminal 1 or a microphone that detects speech from the player. That is, the input part 22 includes various apparatuses capable of receiving input such that an intention of the player can be identified.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Game Content

Next, a game provided by the information processing system S and the game apparatus G of the present embodiment will be described. The player can possess a character obtained through a lottery called a gacha or a character distributed from the management side. In addition, the player can possess a support card obtained through a lottery or a support card distributed from the management side.

As will be described in detail below, in the game according to the present embodiment, a nurture game is provided. The player can nurture the character possessed by the player in the nurture game. In addition, the nurture game according to the present embodiment has a game property of nurturing a character while participating in a race simulating horse racing.

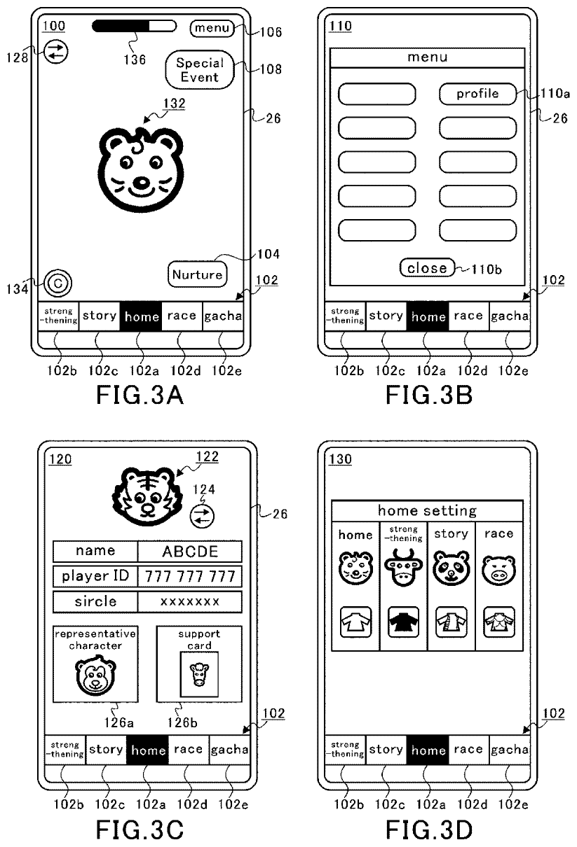

FIG. 3A is a diagram for describing an example of a home screen 100. When the game application is run on the player terminal 1, the home screen 100 is displayed on the display 26. A menu bar 102 is displayed at a lower portion of the home screen 100. The menu bar 102 is provided with a plurality of operation portions that can be operated (tapped) by the player.

Here, the menu bar 102 is provided with a home screen selection operation portion 102a, a strengthening screen selection operation portion 102b, a story screen selection operation portion 102c, a racing game selection operation portion 102d, and a gacha screen selection operation portion 102e. In the menu bar 102, the operation portion corresponding to the screen being displayed is highlighted so that the screen being displayed on the display 26 can be identified.

When the home screen selection operation portion 102a is tapped, the home screen 100 illustrated in FIG. 3A is displayed on the display 26.

When the strengthening screen selection operation portion 102b is tapped, a strengthening screen (not illustrated) is displayed. On the strengthening screen, it is possible to strengthen the character or the support card possessed by the player. The player can increase the level set for the character or the support card by strengthening the character or the support card. Various parameters are set for the character and the support card, and the parameter increases as the level increases. By increasing the parameters of the character and the support card, the player can nurture the character to have higher stats in the nurture game.

When the story screen selection operation portion 102c is tapped, a story screen (not illustrated) is displayed. Here, a story image is provided for each character appearing in the game. The player can select and view a character and a story image on the story screen.

When the racing game selection operation portion 102d is tapped, a racing game selection screen (not illustrated) is displayed. In the present embodiment, various racing games are provided in which a nurtured character nurtured in the nurture game described below can be entered. On the racing game selection screen, the player can select a racing game in which the nurtured character is entered. An example of a racing game is a team competition game in which a team formed by a plurality of nurtured characters and a team of other players selected by a computer are made to compete with each other. The team competition game has a game property of competing with other players for ranking.

When the gacha screen selection operation portion 102e is tapped, a gacha screen (not illustrated) is displayed. On the gacha screen, the player can play a so-called gacha lottery in which the player can obtain characters and support cards through a lottery by spending in-game currency.

In addition, on the home screen 100, a nurture game operation portion 104 is provided above the menu bar 102. When the nurture game operation portion 104 is tapped, a nurture game screen is displayed, and a nurture game described below is started. The nurture game is roughly divided into a preparation stage and a nurture stage. First, in the preparation stage, the player selects one character from among characters possessed by the player and sets the character as a character to be nurtured (hereinafter referred to as a nurture target character).

Further, in the preparation stage, the player sets a deck to be used when nurturing the nurture target character. The deck is formed of a plurality of inheritance characters, which will be described in detail below, and a plurality of support cards. Thus, in the nurture game, the inheritance characters and the support cards forming the deck are used.

When the settings for the nurture target character and the deck (the inheritance characters and the support cards) are completed, the processing transitions from the preparation stage to the nurture stage, and the game for nurturing the nurture target character is started. In the nurture game, parameters of the nurture target character can be changed. The player can possess the character nurtured in the nurture game as a nurtured character. As described above, the player can form a team of nurtured characters possessed by the player and use the nurtured characters in a team competition game or the like.

As described above, the main purpose of the game according to the present embodiment is to nurture nurtured characters via the nurture game and to increase the ranking in the team competition game using the nurtured characters.

In addition, in the present embodiment, a function for sharing a nurtured character or a support card among players and a function for sharing information among a plurality of players are provided. The player can set a nurtured character and a support card that can be used by another player in the nurture game. To be specific, as illustrated in FIG. 3A, a settings operation portion 106 is provided in an upper right portion of the home screen 100. When the settings operation portion 106 is tapped, an option setting screen 110 is displayed.

FIG. 3B is a diagram for describing an example of the option setting screen 110. The option setting screen 110 is a screen on which various types of information can be confirmed and set. The option setting screen 110 is provided with a plurality of operation portions, and when an operation portion is tapped, information corresponding to the operation portion can be confirmed and set.

The operation portions of the option setting screen 110 include a profile setting operation portion 110a and a close operation portion 110b. When the close operation portion 110b is tapped, the option setting screen 110 is closed and the home screen 100 is displayed. When the profile setting operation portion 110a is tapped, a profile setting screen 120 is displayed.

FIG. 3C is a diagram for describing an example of the profile setting screen 120. On the profile setting screen 120, the player can confirm and set their own profile information. The profile information includes a profile character, a player name, a player ID, a circle they belong to, a representative character, and a rental card.

The profile character functions as a character that is displayed when the player's information is viewed by another player. For example, the profile character is displayed when using a circle function, the circle being a place for sharing information with other players. On the profile setting screen 120, a profile character image 122 that is currently set is displayed. Near the profile character image 122, a change button 124 is provided. When the change button 124 is tapped, a profile character change screen (not illustrated) is displayed. The player can change the profile character on the profile character change screen.

The profile setting screen 120 displays the player name set by the player, the player ID given to the player, and the name of the circle the player belongs to. The profile setting screen 120 is provided with a representative character setting operation portion 126a and a rental card setting operation portion 126b.

When the representative character setting operation portion 126a is tapped, a representative character setting screen (not illustrated) is displayed. The player can set any one of the nurtured characters nurtured by the player as a representative character on the representative character setting screen. In the representative character setting operation portion 126a, an icon image indicating the currently set representative character is displayed. As will be described in detail below, the representative character can be used for forming a deck as an inheritance character in the nurture game played by another player.

When the rental card setting operation portion 126b is tapped, a rental card setting screen (not illustrated) is displayed. The player can set any one of the support cards possessed by the player as a rental card on the rental card setting screen. In the rental card setting operation portion 126b, an icon image indicating the currently set rental card is displayed. As described above, a support card set as a rental card can be used for forming a deck by another player and is used in the nurture game played by another player.

Although not described in detail, when the setting of the profile information is changed on the profile setting screen 120, setting change information is transmitted to the server 1000. In the server 1000, profile information is stored for each player.

Further, as illustrated in FIG. 3A, a setting icon 128 is displayed on the home screen 100. When the setting icon 128 is tapped, a home setting screen 130 is displayed.

FIG. 3D is a diagram for describing an example of the home setting screen 130. The player can set a home screen setting character 132 to be displayed on the home screen 100 on the home setting screen 130. The player can set four home screen setting characters 132 to be displayed on the home screen 100.

Although not illustrated, when a flick operation in the left-and-right direction is input on the home screen 100, the screen displayed on the display 26, that is, the display of the home screen 100, is switched. The four currently set home screen setting characters 132 are displayed on the home screen 100. The home screen setting character 132 is assigned with the function of each operation portion displayed on the menu bar 102. Thus, when the home screen setting character 132 displayed on the home screen 100 is tapped, the screen is switched in the same manner as when the operation portion of the menu bar 102 is tapped.

On the home setting screen 130, a character image corresponding to each of the four currently set home screen setting characters 132 and the corresponding operation portion are distinguishably displayed. When a character image displayed on the home setting screen 130 is tapped, a character selection screen (not illustrated) is displayed. The player can select the home screen setting character 132 on the character selection screen. Further, the player can set a costume of the home screen setting character 132 on the home setting screen 130.

As illustrated in FIG. 3A, a circle icon 134 is displayed on the home screen 100. When the circle icon 134 is tapped, a circle screen is displayed. The player can exchange information with other players belonging to the same circle on the circle screen.

In addition, in the present embodiment, various limited-time events are held irregularly. A special event icon 108 is displayed on the home screen 100 during the active period of the special event which is a limited-time event. When the special event icon 108 is tapped, a special event screen is displayed. On the special event screen, for example, the player can exchange special event points provided only in the special event with various rewards.

When the nurture game operation portion 104 is tapped on the home screen 100, a nurture game screen is displayed and the nurture game is started. The player can play the nurture game by spending game points. The game points are given to the player at a rate of a predetermined value (for example, +1) every predetermined amount of time (for example, 10 minutes). An upper limit value (for example, 100) is set for the game points that can be possessed by the player, and the player can possess game points within the range of the upper limit value. A game point display bar 136 is provided in an upper portion of the home screen 100, and a ratio of the currently possessed game points to the upper limit value is visually displayed.

The game points are subtracted by a predetermined value (for example, −30) at a time when the nurture game is started. Thus, when the player does not possess the required game points, the player cannot start the nurture game. However, the player can possess an item for recovering game points and can recover game points using the item. For example, this item can be given as a reward in the nurture game or the team competition game or can be obtained by spending in-game currency. Hereinafter, the nurture game will be described in detail.

### Nurture Game

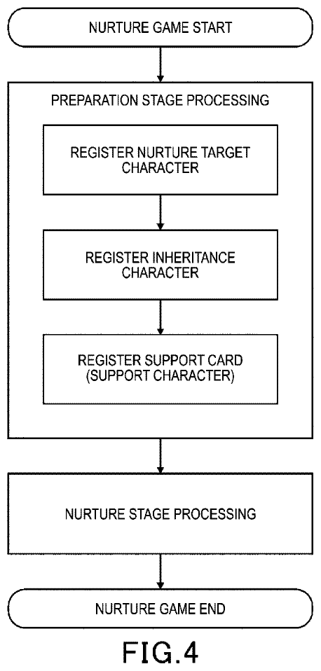

FIG. 4 is a diagram for describing a rough flow of the nurture game. The nurture game is roughly divided into a setting game and a nurture main game. As will be described in detail below, the nurture main game is a game in which one nurture target character selected from among the characters possessed by the player is nurtured as a nurture target character.

In addition, the setting game is a game in which the player registers the nurture target character and a deck (inheritance characters and support cards), with this corresponding to the preparation stage of the nurture game. Hereinafter, the processing executed in the setting game is referred to as preparation stage processing, and the processing executed in the nurture main game is referred to as nurture stage processing. Here, in order to facilitate understanding, a rough flow of the preparation stage processing and the nurture stage processing will be described first.

### Preparation Stage Processing

In the preparation stage processing, registration of a nurture target character and registration of a deck (inheritance characters and support cards) are mainly performed. Note that the support cards are for assisting the nurturing of the nurture target character. One character is always associated with each support card, and the character associated with the support card registered in the preparation stage processing assists the nurturing of the nurture target character. Hereinafter, a character associated with a support card is referred to as a support character.

### Registration of Nurture Target Character

When the player taps the nurture game operation portion 104 on the home screen 100, a scenario selection screen (not illustrated) is displayed. In the present embodiment, a plurality of scenarios of the nurture main game are provided. In each scenario of the nurture main game, a final goal, a goal for during the game, and the like are set, and the player needs to sequentially clear the set goals. The goal, a time period until the goal is achieved, and the like are different for each scenario. The player can select any one of the plurality of scenarios on the scenario selection screen. Here, a case where a predetermined scenario is selected will be described.

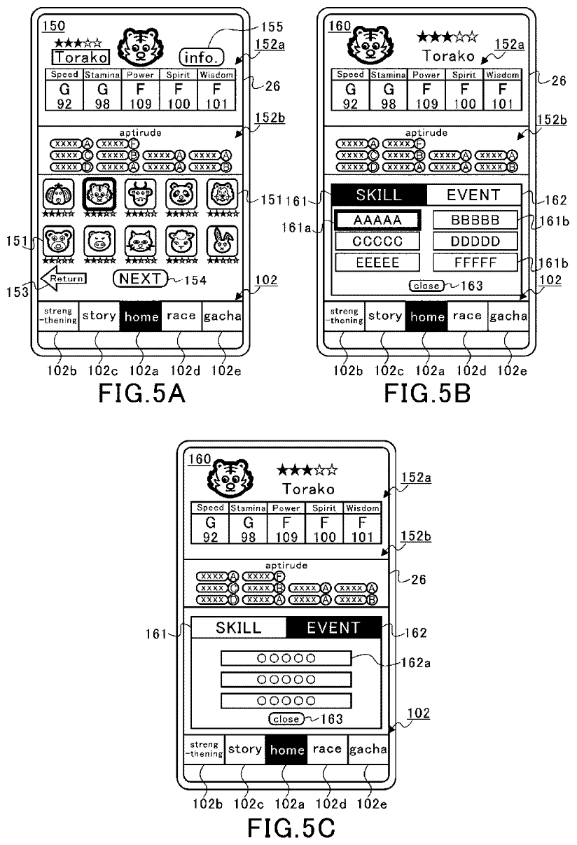

FIG. 5A is a diagram for describing a nurture target character selection screen 150. At a central portion of the nurture target character selection screen 150, a plurality of character icons 151 are displayed and a list of characters possessed by the player is displayed. In addition, an ability parameter display portion 152a and an aptitude parameter display portion 152b are displayed in an upper portion of the nurture target character selection screen 150. In addition, a return operation portion 153 denoted by “Return” and a next operation portion 154 denoted by “NEXT” are displayed in a lower portion of the nurture target character selection screen 150.

In the present embodiment, an initial value of the ability parameter is set for each character, and the initial value of the ability parameter of the character corresponding to the character icon 151 selected by the player is displayed as a numerical value in the ability parameter display portion 152a. In the present embodiment, the larger the numerical value of the ability parameter is, the higher the ability is.

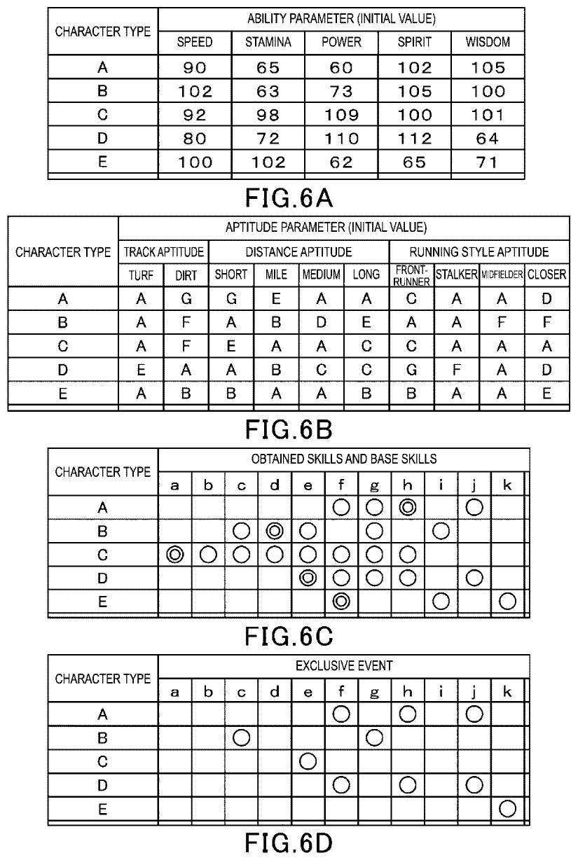

FIG. 6A is a diagram for describing an ability parameter (initial value) table. In the present embodiment, as illustrated in FIG. 6A, initial values of ability parameters for each character are stored in the ability parameter (initial value) table. Then, based on the initial values of the ability parameters stored in the ability parameter (initial value) table, the initial values of the ability parameters are displayed in the ability parameter display portion 152a.

In the present embodiment, an initial value of an ability parameter is set for each one of a plurality of types of abilities for each character. To be more specific, a speed ability parameter denoted by “Speed” in the ability parameter display portion 152a, a stamina ability parameter denoted by “Stamina” in the ability parameter display portion 152a, a power ability parameter denoted by “Power” in the ability parameter display portion 152a, a spirit ability parameter denoted by “Spirit” in the ability parameter display portion 152a, and a wisdom ability parameter denoted by “Wisdom” in the ability parameter display portion 152a are provided as the ability parameters.

Note that the initial values of the ability parameters for each character are increased by operations of the player or the like. For example, each character is provided with stat levels of five stages, and the player can increase the stat level of the character by spending in-game currency and predetermined items. As the stat level of the character increases, the initial value of the ability parameter of the character increases. The initial values when the character is at a predetermined level is illustrated in FIG. 6A. Note that the player can increase the value of the ability parameters in the nurture main game. That is, the goal of the nurture main game is to nurture a character to have higher numerical values for the ability parameters.

In the present embodiment, an aptitude parameter (initial value) is set for each character. As illustrated in FIG. 5A, the initial values of the aptitude parameters of the character corresponding to the character icon 151 selected by the player are displayed with an alphabetical letter in the aptitude parameter display portion 152b.

FIG. 6B is a diagram for describing an aptitude parameter (initial value) table. In the present embodiment, as illustrated in FIG. 6B, the initial values of the aptitude parameters for each character are stored in the aptitude parameter (initial value) table. The initial values of the aptitude parameters are set to any one of seven levels of alphabetical letters A to G. For the initial values of the aptitude parameters, A indicates the highest aptitude and G indicates the lowest aptitude. Based on the initial values of the aptitude parameters stored in the aptitude parameter (initial value) table, the initial values of the aptitude parameters are displayed in the aptitude parameter display portion 152b.

In the present embodiment, an initial value of the aptitude parameter is set for each one of a plurality of types of aptitude for each character. Specifically, the aptitude parameters include aptitude parameters related to track aptitude for turf and dirt; aptitude parameters related to distance aptitude for short distance, mile, medium distance, and long distance; and aptitude parameters related to running style aptitude for front-runner, stalker, midfielder, and closer.

In the nurture game, the player can enter the nurture target character in various races. At this time, if the aptitude of the nurture target character that matches the race content is high, the nurture target character will be more advantageous in the developments of the race.

The initial values of the aptitude parameters for each character may be increased by spending in-game currency. Further, the values of the aptitude parameters may change in the nurture main game. Further, in the nurture main game, the aptitude parameter may be set to S, which is a higher aptitude than A.

FIG. 5B is a first diagram for describing a character detail screen 160. FIG. 5C is a second diagram for describing the character detail screen 160. When tapping and holding the character icon 151 on the nurture target character selection screen 150, the character detail screen 160 is displayed on the display 26. On the character detail screen 160, the details of the abilities of the character corresponding to the character icon 151 which was tapped and held on the nurture target character selection screen 150 are displayed.

A skill operation portion 161 and an event operation portion 162 are displayed at a central portion of the character detail screen 160. As illustrated in FIG. 5B, when the character detail screen 160 is first displayed, the skill operation portion 161 is highlighted, and the skills provided for each character are displayed. A skill is an ability that may be activated when a predetermined condition is satisfied while a race is being executed as described below. Activating skills gives each character an advantage in the developments of the race.

FIG. 6C is a diagram for describing a skill table. As illustrated in FIG. 6C, the skill table stores the skills of each character possessed by the player. Based on the skills stored in the skill table, the skills are displayed on the character detail screen 160 as illustrated in FIG. 5B. Note that a skill is not activated just by being in possession of it and first becomes possible to be activated by being obtained. Hereinafter, a skill in a state in which the skill can be activated by the character is referred to as an obtained skill.

One obtained skill is set for the character from the beginning of the nurture main game. In addition to the obtained skill, a plurality of base skills are set for the character. A base skill is a skill that can be obtained by spending skill points described below after the start of the nurture main game. That is, a base skill can become an obtained skill in exchange for skill points.

In the present embodiment, a skill corresponding to “⊚” in the skill table illustrated in FIG. 6C is displayed as an obtained skill on the character detail screen 160 in FIG. 5B. Further, a skill corresponding to “◯” in the skill table illustrated in FIG. 6C is displayed as a base skill on the character detail screen 160 illustrated in FIG. 5B. In the present embodiment, as illustrated in the character detail screen 160 in FIG. 5B, the obtained skill is highlighted so that the obtained skill and the base skill can be easily distinguished from each other.

In FIG. 5B, as the skill provided for each character, one obtained skill is displayed in an obtained skill display field 161a and seven base skills are displayed in a base skill display field 161b, but the present invention is not limited thereto. For example, the number of obtained skills and base skills may be different for each character. Further, for example, the number of obtained skills or base skills for each character may be increased by an increase in the level of the character, spending of in-game currency or items, and the like.

When the player taps the event operation portion 162 of the character detail screen 160, the content of the character detail screen 160 is switched as illustrated in FIG. 5C, and an exclusive event display field 162a indicating an exclusive event provided for each character is displayed. In this case, the event operation portion 162 is highlighted as illustrated in FIG. 5C. The exclusive event is generated when a predetermined condition is satisfied in the nurture main game and is used to display a story related to a character appearing in the nurture game or to change a value of an ability parameter.

FIG. 6D is a diagram for describing an exclusive event table. As illustrated in FIG. 6D, the exclusive event table stores an exclusive event for each character possessed by the player. Based on the exclusive event stored in the exclusive event table, the exclusive event is displayed on the character detail screen 160 as illustrated in FIG. 5C. Note that the exclusive event may include a hint event that enables a character to possess or obtain a skill, an ability event that increases or decreases the numerical value of an ability parameter of the character, and the like.

Note that the exclusive event displayed in the character detail screen 160 illustrated in FIG. 5C may be entirely executed during the nurture main game, may be at least partially executed during the nurture main game, or need not be entirely executed during the nurture main game when a predetermined condition is not satisfied. Also, for example, the number of exclusive events provided for each character may increase due to an increase in the level of the character, spending of in-game currency or items, and the like. In addition, when a predetermined condition is satisfied, an exclusive event that is not displayed as an exclusive event may be executed during the nurture main game.

As illustrated in FIGS. 5B and 5C, a close operation portion 163 denoted by “close” is displayed at a lower portion of the character detail screen 160. When the close operation portion 163 of the character detail screen 160 is tapped, the display of the character detail screen 160 is terminated, and the nurture target character selection screen 150 is displayed on the display 26.

When the return operation portion 153 is tapped on the nurture target character selection screen 150 illustrated in FIG. 5A, the home screen 100 illustrated in FIG. 3A is displayed on the display 26. The nurture target character selection screen 150 is provided with a nurture information display button 155. When the nurture information display button 155 is tapped, a nurture information display screen (not illustrated) is displayed. The player can confirm the information related to the character selected on the nurture target character selection screen 150 on the nurture information display screen.

A clear goal tab is provided on the nurture information display screen. Here, the goal of the nurture game is to produce a stronger nurtured character by nurturing a character selected as the nurture target character from among characters possessed by the player. As will be described in detail below, the nurture main game includes a plurality of turns, and the player needs to make the nurture target character train or participate in a race for each turn.

A plurality of clear goals are set for each character. When the clear goal tab is tapped, a list of clear goals set for the selected character is displayed on the nurture information display screen. A race in which the nurture target character can be entered is predetermined for each turn.

Further, when the nurture target character is entered in the race, the nurture target character can obtain fans, winning points, and special currency. In each race, the fans, the winning points, and a base obtaining number for the special currency are determined for each placing, and the higher the placing, the larger the numerical values of the fans, the winning points, and the special currency to be obtained. In addition, a difficulty is set for each race, and in a race with a higher difficulty, more fans, more winning points, and more special currency can be obtained. For example, races of GI, GII, and GIII grades called graded races are provided in the race. The level of the grades increases in the order of GIII, GII, and GI. A race with a higher grade has a higher difficulty and also allow more fans, winning points, and special currency to be obtained.

Here, the number of fans that can be obtained by running in the race is calculated by adding a bonus obtaining number to the base obtaining number determined for each placing. Specifically, a correction value is determined based on the race result, and the bonus obtaining number is calculated by multiplying the base obtaining number by the correction value. The total number of the bonus obtaining number and the base obtaining number is the number of fans obtained by the nurture target character. For example, when the race result is first place, the correction value increases as the difference between the nurture target character and the second place character increases. In addition, when the race result is from second to fifth place, the correction value increases as the difference between the nurture target character and the first character decreases.

The nurture target character activates a skill at a predetermined probability during the race. At this time, as the number of activated skills increases, the correction value increases. As described above, in each race, the condition for adding the number of fans is determined, and the number of fans to be obtained increases depending on various race results other than the placing and the progress of the race. However, the number of fans obtained by the nurture target character is at least equal to or greater than the base obtaining number corresponding to the placing.

In some races, the number of fans is set as a race entry condition. When the number of fans obtained by the nurture target character is less than the number of fans set as the race entry condition, the player cannot enter the nurture target character in the race. The higher the difficulty of a race, the greater the number of fans required to enter in the race.

In this way, a plurality of clear goals are set for each character. By achieving a clear goal, the player can continue the nurture main game until the final turn. On the other hand, when the clear goal cannot be achieved, the nurture main game ends in this turn.

As described above, the player can select a nurture target character while checking various information of each character on the nurture target character selection screen 150 illustrated in FIG. 5A. When the next operation portion 154 is tapped on the nurture target character selection screen 150, the selected character is set as the nurture target character, and an inheritance character selection screen 170 is displayed on the display 26.

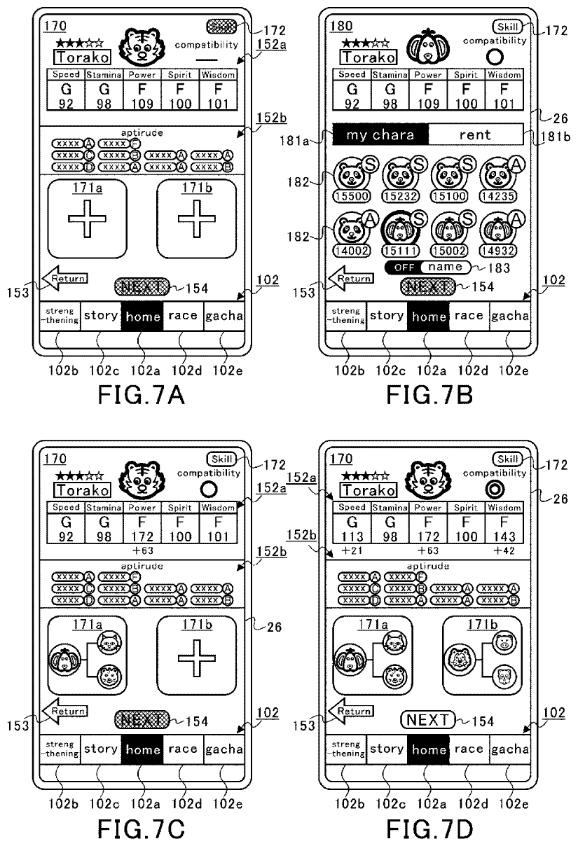

Registration of Inheritance Character FIG. 7A is a first diagram for describing the inheritance character selection screen 170. FIG. 7B is a first diagram for describing a nurtured character list screen 180. FIG. 7C is a second diagram for describing the inheritance character selection screen 170. FIG. 7D is a third diagram for describing the inheritance character selection screen 170. The inheritance character selection screen 170 is a screen for the player to register an inheritance character.

An inheritance character is a character that causes the nurture target character to inherit an ability value, a skill, or the like. The player can select two inheritance characters from the nurtured characters possessed by the player and representative characters of other players extracted in accordance with a predetermined extraction condition, such as the representative characters of friends such as followers, and use the representative characters to form a deck and register the representative characters. Note that only one representative character of another player can be used as an inheritance character to form a deck in one nurture game.

The inheritance character selection screen 170 is provided with the ability parameter display portion 152a, the aptitude parameter display portion 152b, a first inheritance character selection region 171a, and a second inheritance character selection region 171b. When the screen transitions from the nurture target character selection screen 150 to the inheritance character selection screen 170, the first inheritance character selection region 171a and the second inheritance character selection region 171b are displayed as blank fields as illustrated in FIG. 7A.

When the first inheritance character selection region 171a or the second inheritance character selection region 171b is tapped, the nurtured character list screen 180 illustrated in FIG. 7B is displayed. The nurtured character list screen 180 is provided with a my character tab 181a and a rental tab 181b. Below the my character tab 181a and the rental tab 181b, a nurtured character list display region is provided. A nurtured character icon 182 is displayed in the nurtured character list display region.

In a state where the my character tab 181a is selected, the nurtured character icons 182 corresponding to the nurtured characters possessed by the player are displayed as illustrated in FIG. 7B. Although not illustrated, in a state where the rental tab 181b is selected, the representative character of a friend, that is, the nurtured character icon 182 corresponding to the nurtured character nurtured by a friend is displayed.

Further, when the nurtured character icon 182 is tapped, the nurtured character corresponding to the nurtured character icon 182 is put in a provisionally selected state. When the nurtured character icon 182 is tapped, the inheritance character selection screen 170 is displayed as illustrated in FIG. 7C. At this time, for example, when the first inheritance character selection region 171a is tapped to display the nurtured character list screen 180 and the nurtured character icon 182 is tapped on the nurtured character list screen 180, an image indicating the nurtured character in the provisionally selected state is displayed in the first inheritance character selection region 171a.

In this state, for example, when the second inheritance character selection region 171b is tapped to display the nurtured character list screen 180 and the nurtured character icon 182 is tapped on the nurtured character list screen 180, an image indicating the nurtured character in the provisionally selected state is displayed in the second inheritance character selection region 171b as illustrated in FIG. 7D.

In addition, the nurtured character is stored in association with information related to the inheritance character used in the nurturing. In the first inheritance character selection region 171a, information related to the inheritance character used when nurturing the nurtured character is displayed.

FIG. 8 is a diagram for describing an inheritance system. In the nurture game, various effects such as an increase in the values of an ability parameter and an aptitude parameter of the nurture target character are achieved based on the factor information of the inheritance character. Here, two inheritance characters are set for one nurture target character, and these inheritance characters are the previously produced nurtured characters. Thus, when a nurtured character set as an inheritance character is produced, two inheritance characters are set for the nurtured character.

As illustrated in FIG. 8, the nurture target character of the nurture main game to be started is set to the current generation. Further, two nurtured characters set as inheritance characters for the nurture target character are set as first inheritance generation. Further, two nurtured characters are set as inheritance characters at the start of the nurturing of the first inheritance generation nurtured character. The two nurtured characters set as inheritance characters when the nurtured character of the first inheritance generation is produced are set as second inheritance generation.

In this case, as illustrated in FIG. 8, the nurtured characters of the first inheritance generation and the second inheritance generation have an effect on the nurture target character of the current generation. As described above, since two inheritance characters (first inheritance generation) are set for one nurture target character, a total of six nurtured characters have an effect on one nurture target character.

For example, one of the two first inheritance generation nurtured characters and the two second inheritance generation nurtured characters that are inheritance characters of this nurtured character form a first inheritance group. In a similar manner, the other of the two first inheritance generation nurtured characters and the two second inheritance generation nurtured characters that are inheritance characters of this nurtured character form a second inheritance group.

As illustrated in FIG. 7D, in the first inheritance character selection region 171a, icons corresponding to one first inheritance generation nurtured character and two second inheritance generation nurtured characters forming the first inheritance group are displayed. In a similar manner, in the second inheritance character selection region 171b, icons corresponding to one first inheritance generation nurtured character and two second inheritance generation nurtured characters forming the second inheritance group are displayed.

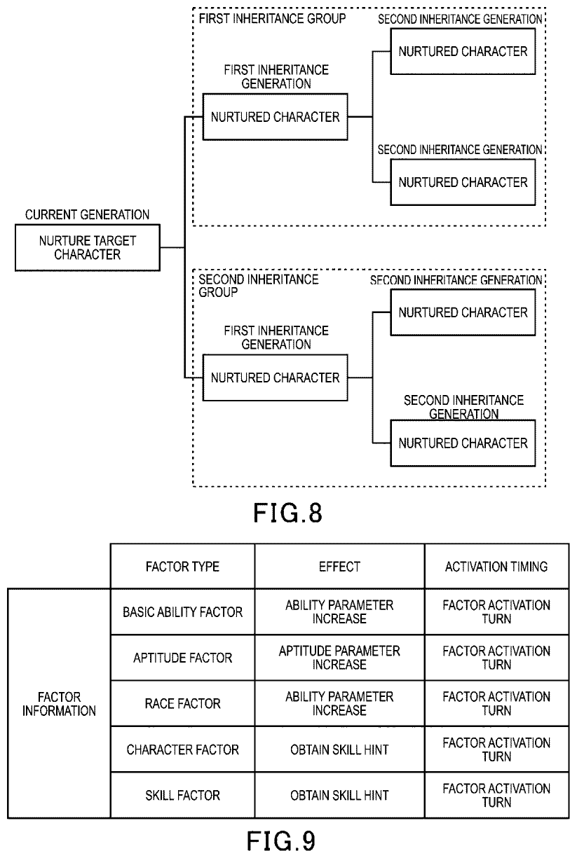

FIG. 9 is a diagram for describing factor information. As will be described in detail below, when the nurture game is completed, the nurture target character is registered as a nurtured character, and at this time, factor information is stored in association with the nurtured character. Specifically, when the nurturing of the nurtured character is completed, a factor to be obtained by the nurtured character is determined through a lottery. Then, factor information indicating the factor gained through the lottery is associated with the nurtured character. In other words, at the completion of the nurture game, the nurtured character can obtain the factor gained through the lottery.

However, the factor obtained by the nurtured character does not affect the abilities of the nurtured character themselves. For example, the nurtured character can be entered in a racing game such as a team competition game. At this time, in the race, a simulation, that is, computational processing of determining the placing and the race developments is performed based on the ability parameters, the aptitude parameters, the obtained skills, and the like of all the nurtured characters running. Since the factor of the nurtured character is not used in the computational processing, even if the nurtured character has a large number of factors, the nurtured character is not given an advantage in the race.

When the nurtured character is set as the inheritance character, the factor of the nurtured character affects only the nurture target character. Factors that can be obtained by the nurtured character are classified into a plurality of types. Basic ability factor, aptitude factor, race factor, character factor, and skill factor as factor types in FIG. 9. Each factor is set to one of a plurality of levels. Here, three factor levels, level 1, level 2, and level 3, are provided as factor levels.

The factor level is determined through a lottery. At this time, after the factors to be obtained by the nurtured character are determined, the factor level may be determined through the lottery for each of the obtained factors. Alternatively, a success ratio may be set for each combination pattern of a factor and a factor level, and any combination pattern may be determined based on the set success ratio. In this case, the factor to be obtained and the factor level are determined at the same time.

For factor levels, level 3 has the largest effect and level 1 has the least effect. In the lottery for determining the factor level, the success probability of level 3 is set to be the lowest and the success probability of level 1 is set to be the highest. However, the success probability of the factor to be obtained or the success probability of the factor level may be changed depending on the result of the nurture game. In this case, for example, a higher factor level may be determined for a nurtured character that has a higher ability parameter or evaluation score.

The basic ability factor increases the ability parameter of the nurture target character. Five basic ability factors are provided including a speed factor, a stamina factor, a power factor, a spirit factor, and a wisdom factor. The nurtured character always obtains one basic ability factor from among the five basic ability factors. The five basic ability factors correspond to the five ability parameters for speed, stamina, power, spirit, and wisdom. For example, when the nurtured character of the first inheritance generation or the second inheritance generation has a speed factor, the ability parameter for the speed of the nurture target character increases.

At this time, the increase value of the ability parameter for speed varies depending on the factor level of the speed factor. For example, when the factor level of the speed factor is level 1, the ability parameter for speed for the nurture target character increases by “7”; when the factor level is level 2, the ability parameter increases by “13”; and when the factor level is level 3, the ability parameter increases by “21”. Thus, if a total of six nurtured characters including two first inheritance generation characters and four second inheritance generation characters all have a speed factor of level 3, the ability parameter for speed for the nurture target character increases by a maximum of 126 (increase value 21×6).

However, an activation timing and an activation condition are set for each factor. Thus, even if the inheritance character has a factor, if the activation condition is not satisfied at the activation timing, there is no effect on the nurture target character.

As described above, the nurture main game is composed of a plurality of turns, and of these, a predetermined turn is set as a factor activation turn. For example, three turns, namely the first turn, the 30th turn, and the 54th turn of the nurture main game are set as factor activation turns. In these factor activation turns, whether to activate is determined for each factor, and in a case where it is determined to activate the factor, the activation condition of the factor is satisfied, and the effect corresponding to the factor is achieved.

Whether to activate the basic ability factor is determined through a lottery. At this time, the probability of success in the lottery as to whether to activate the basic ability factor, that is, the probability of activating the basic ability factor (hereinafter referred to as the activation probability) may be different in the three factor activation turns. Here, in the first turn, the activation probability of the basic ability factor is set to 100% regardless of the factor level. Also, in the 30th turn and the 54th turn, the activation probability of the basic ability factor varies depending on the factor level. For example, in the 30th turn and the 54th turn, the activation probability of a level 3 basic ability factor is set to 100%, the activation probability of a level 2 basic ability factor is set to 90%, and the activation probability of level 1 basic ability factor is set to 80%.

On the inheritance character selection screen 170, an increase value that increases the ability parameter in the first turn is displayed. For example, in FIG. 7C, one inheritance character in the first inheritance group is provisionally selected. In this case, the type of the ability parameter to be increased in the first turn and the increase value thereof are displayed for the one inheritance character being provisionally selected. Here, “+63” is displayed below the power ability parameter, which indicates that the power ability parameter increases by 63 points in the first turn. Further, in the ability parameter display portion 152a, the value to which the increase value increased in the first turn is added is displayed.

Further, in FIG. 7D, two inheritance characters in the first inheritance group and the second inheritance group are provisionally selected. In this case, the type of the ability parameter to be increased in the first turn and the increase value thereof are displayed for the two inheritance character being provisionally selected. Here, “+21”, “+63”, and “+42” are displayed under the ability parameters for speed, power, and wisdom, respectively, which indicate that the ability parameters for speed, power, and wisdom increase by 21 points, 63 points, and 42 points, respectively, in the first turn.

In the inheritance character selection screen 170, the increase value of the ability parameter to be increased by the inheritance character in the first inheritance group and the increase value of the ability parameter to be increased by the inheritance character in the second inheritance group are displayed in a distinguishable manner. For example, in FIG. 7D, the “+63” displayed under the power ability parameter and the “+21” and “+42” displayed under the speed and wisdom ability parameters are displayed in different colors.

The aptitude factor illustrated in FIG. 9 increases the aptitude parameter of the nurture target character. The aptitude factors include six factors: a turf factor, a dirt factor, a short distance factor, a mile factor, a medium distance factor, and a long distance factor. The nurtured character always obtains one aptitude factor from among the six aptitude factors. The six aptitude factors correspond to turf aptitude, dirt aptitude, short distance aptitude, mile aptitude, medium distance aptitude, and long distance aptitude. For example, when the nurtured character of the first inheritance generation or the second inheritance generation includes a nurtured character having a turf factor, the aptitude parameter for the turf aptitude of the nurture target character increases.

The activation timing and the activation condition are also set for the aptitude factor, and whether to activate is determined for each aptitude factor in the same factor activation turn as that of the basic ability factor. If activation of the aptitude factor is determined, the corresponding aptitude parameter is increased by one level. In this example, in the first turn, the activation probability of the aptitude factor is set to 100% regardless of the factor level.

For example, the aptitude factors of three nurtured characters belonging to the first inheritance group are the turf factor, the short distance factor, and the mile factor; and the aptitude factors of three nurtured characters belonging to the second inheritance group are the turf factor, the short distance factor, and the medium distance factor. In this case, the turf aptitude and the short distance aptitude of the nurture target character are each increased by two levels, and the mile aptitude and the medium distance aptitude are each increased by one level.

Further, for example, the aptitude factors of the three nurtured characters belonging to the first inheritance group are all the turf factor, and the aptitude factors of the three nurtured characters belonging to the second inheritance group are all the short distance factors. In this case, the turf aptitude and the short distance aptitude of the nurture target character each increase by three levels. In another example, the aptitude factors of the three nurtured characters belonging to the first inheritance group are all the turf factor, and the aptitude factors of the three nurtured characters belonging to the second inheritance group are the turf factor, the short distance factor, and the mile factor. In this case, the turf aptitude of the nurture target character increases by four levels, and the short distance aptitude and the mile aptitude each increase by one level.

However, for the first turn, a limit is placed on the increase value of the aptitude parameter. Specifically, in the first turn, the upper limits of all the aptitude parameters are set to A. Thus, if the initial value of the turf aptitude of the nurture target character is A, the turf aptitude does not increase in the first turn even if the inheritance character has the turf factor.

On the other hand, in the 30th turn and the 54th turn, a lottery is used to determine whether to activate based on the factor level for each aptitude factor. As an example, in the 30th turn and the 54th turn, the activation probability of a level 3 aptitude factor is set to 5%, the activation probability of a level 2 aptitude factor is set to 3%, and the activation probability of a level 1 aptitude factor is set to 1%. In the 30th turn or the 54th turn, when the activation of the aptitude factor is determined through a lottery, the aptitude parameter corresponding to the aptitude factor increases. In the 30th turn and the 54th turn, the upper limit of each aptitude is raised from A to S. Thus, in the 30th turn and the 54th turn, the value of the aptitude parameter can be increased to S by activation of the aptitude factor.

The value of the aptitude parameter increased in the first turn is displayed in the aptitude parameter display portion 152b of the inheritance character selection screen 170.

The race factor increases the ability parameter of the nurture target character. The race factor is provided for each race with a high difficulty (hereinafter referred to as a factor target race), such as GI races, from among the races that can be entered in the nurture main game. When the nurture game is completed, a lottery to determine whether a race factor is obtained is performed for each factor target race in which the nurture target character comes in first place. The nurtured character can obtain a race factor via a successful lottery.

Note that the race factor is provided with factor levels, and the factor level is determined through a lottery for each race factor determined to be obtained. Here, there is no upper limit to the number of race factors that can be obtained by one nurtured character, and the nurtured character can obtain a plurality of race factors.

For each race factor, an ability parameter to be increased by activation and an increase value thereof are set in advance. For example, race factors may include a factor to increase the speed ability parameter and a factor to increase the power ability parameter. At this time, the higher the factor level, the greater the increase value of the ability parameter.

In addition, the activation timing and the activation condition are also set for the race factor, and whether to activate is determined for each race factor in the factor activation turn. If activation of a race factor is determined, the ability parameter corresponding to the race factor is increased. The factor activation turns of the race factor are limited to the 30th turn and the 54th turn. In addition, the activation probability of the race factor in the factor activation turn varies depending on the factor level, and the higher the factor level, the higher the activation probability.

The character factor is a factor specific to the character, and for example, only when a character strengthened to a predetermined level is nurtured as a nurture target character, the character factor set for the character is always given to the nurtured character at the completion of the nurture game. Since only one character factor is set for one character, the maximum number of character factors that one nurtured character can obtain is one. When a nurtured character based on a character that is not strengthened to a predetermined level is produced, a character factor cannot be obtained.

The character factor can be activated in a factor activation turn set in advance and is activated by a successful lottery executed in the factor activation turn. When a character factor is activated, a hint event set for each character factor occurs, and a skill hint can be obtained as described above.

The skill factor is given based on the obtained skill obtained by the nurtured character. Specifically, at the completion of the nurture game, for each obtained skill obtained by the nurtured character, whether a skill factor is obtained is determined through a lottery. By being successful in the lottery, a skill factor is given to the nurtured character. In other words, the nurtured character can obtain some or all of the skill factors corresponding to the obtained skills. When it is determined to obtain a skill factor, the factor level of the skill factor is determined through a lottery.

The skill factor can be activated in a factor activation turn set in advance and is activated by a successful lottery executed in the factor activation turn. At this time, the higher the factor level, the higher the success probability. When a skill factor is activated, a hint event set for each skill factor occurs, and a skill hint can be obtained. Thus, the nurture target character can obtain the same skill as the obtained skill obtained by the inheritance character or the like.

As described above, whether the skill factor is obtained is determined from within a range of the obtained skill obtained by the nurtured character. Thus, the more obtained skills the nurtured character has, the higher the possibility of obtaining the skill factor. However, since whether a skill factor is obtained is determined through a lottery, even if the nurtured character has many obtained skills, a skill factor may not be obtained.

Although the nurtured character obtains the skill factor separately from the obtained skill, the skill that can be obtained by the nurture target character may be determined based on the obtained skill of the nurtured character as the inheritance character without providing the skill factor.

As described above, the ability parameter of the nurture target character greatly changes depending on the inheritance character used to form the deck. In addition, even if the ability of the nurtured character itself is high, since whether a factor is obtained is determined through a lottery, the nurtured character with higher ability does not necessarily correspond to the inheritance character. On the other hand, even when the ability of the nurtured character itself is not high, the nurtured character may effectively function as an inheritance character by obtaining a large number of factors having a high factor level. In this manner, by making it possible to form a deck using the inheritance characters, not only simply nurturing a strong nurtured character but also nurturing a nurtured character that is effective as an inheritance character is made enjoyable.

Furthermore, in the present embodiment, the compatibility between the nurture target character, the nurtured character of the first inheritance generation, and the nurtured character of the second inheritance generation is determined. Then, in the case of a combination of characters having good compatibility, an advantageous factor activation condition is achieved.

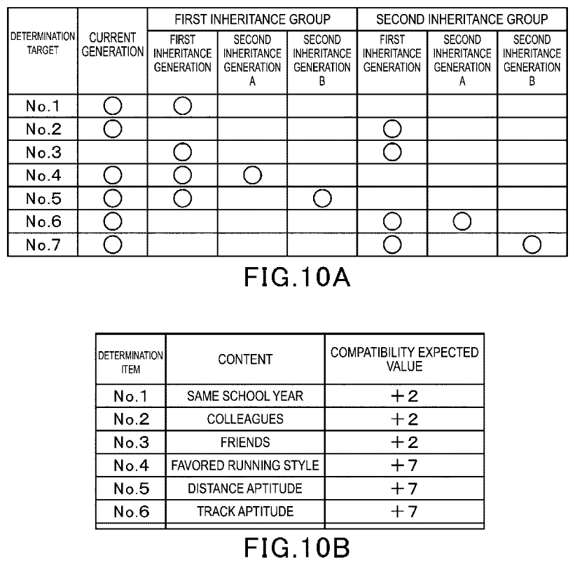

FIG. 10A is a diagram for describing a compatibility determination target, and FIG. 10B is a diagram for describing compatibility determination items. As illustrated in FIG. 10A, in the present embodiment, seven determination targets from No. 1 to No. 7 are provided. The first determination target (No. 1) is the nurture target character of the current generation and the nurtured character of the first inheritance generation in the first inheritance group. The second determination target (No. 2) is the nurture target character of the current generation and the nurtured character of the first inheritance generation in the second inheritance group.

The third determination target (No. 3) is the nurtured character of the first inheritance generation in the first inheritance group and the nurtured character of the first inheritance generation in the second inheritance group. The fourth determination target (No. 4) is the nurture target character of the current generation, the nurtured character of the first inheritance generation in the first inheritance group, and one of the nurtured characters (nurtured character A) of the second inheritance generation in the first inheritance group. The fifth determination target (No. 5) is the nurture target character of the current generation, the nurtured character of the first inheritance generation in the first inheritance group, and the other nurtured character (nurtured character B) of the second inheritance generation in the first inheritance group.

The sixth determination target (No. 6) is the nurture target character of the current generation, the nurtured character of the first inheritance generation in the second inheritance group, and one of the nurtured characters (nurtured character A) of the second inheritance generation in the second inheritance group. The seventh determination target (No. 7) is the nurture target character of the current generation, the nurtured character of the first inheritance generation in the second inheritance group, and the other nurtured character (nurtured character B) of the second inheritance generation in the second inheritance group.

For each determination target, it is determined whether the condition is satisfied for each one of the plurality of determination items. Example of the determination items are illustrated in FIG. 10B. In the present embodiment, the world view of the game is set such that characters that can be selected as nurture target characters are students and each character performs training in a school.

As illustrated in FIG. 10B, settings including same school year, colleagues, and friends are set in advance for each character. The determination items include, for example, whether the two or three determination target characters are in the same school year, are colleagues, or are friends. In addition, the determination items include whether the running style, the distance aptitude, and the track aptitude that the determination target character is good at match.

Each determination item is associated with a compatibility expected value, and the compatibility expected values of the determination items established between the determination target characters are accumulated. Here, the compatibility expected value differs depending on the determination item, but the compatibility expected value may be common to all the determination items.

For example, in the case of determining the compatibility, first, it is determined whether all determination items are established between the nurture target character of the current generation which is a first determination target and the nurtured character of the first inheritance generation of the first inheritance group. At this time, the compatibility expected values associated with the established determination items are accumulated and counted. As described above, the calculation of the compatibility expected value is sequentially performed from the first determination target to the seventh determination target, and the activation probability of the factor is corrected based on the finally calculated compatibility expected value. That is, the higher the compatibility expected value, the higher the activation probability of all the factors, and the lower the compatibility expected value, the lower the activation probability of all the factors.

The activation probability may be calculated by using the calculated compatibility expected value as a correction value. For example, a correction value for correcting the activation probability of a factor may be set for each compatibility level, and the compatibility level may be determined based on the calculated compatibility expected value.

As described above, since the activation probability of the factor varies depending on the compatibility between the nurture target character and the inheritance character or the compatibility between the inheritance characters, the combination of the two inheritance characters greatly affects the nurturing of the nurture target character. In other words, the compatibility between characters is an important criterion for selecting an inheritance character.

As illustrated in FIGS. 7B, 7C, and 7D, in a state in which the inheritance character is selected, a compatibility mark indicating compatibility is displayed on an upper right of the inheritance character selection screen 170 and the nurtured character list screen 180. Here, the compatibility level of the selected characters is indicated by three compatibility marks: ⊚, ∘, and Δ. As illustrated in FIG. 7A, the compatibility mark is not displayed in a state in which an inheritance character is not selected.

As illustrated in FIG. 7B, a switch display button 183 is provided on the nurtured character list screen 180. When the switch display button 183 is operated, a display condition setting screen (not illustrated) is displayed. On the display condition setting screen, the player can rearrange or filter the nurtured character icons 182 displayed on the nurtured character list screen 180, that is, the nurtured characters selectable as inheritance characters.

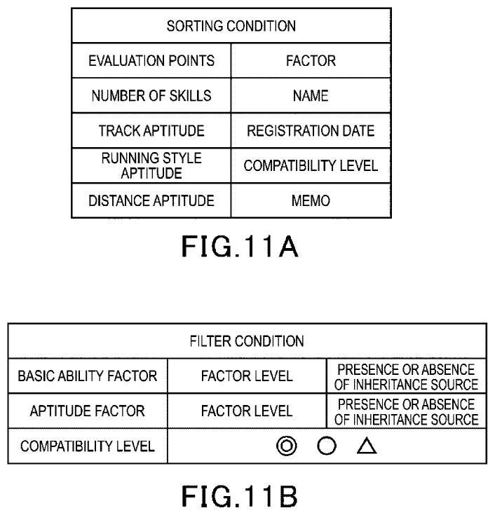

FIG. 11A is a diagram for describing sorting conditions. FIG. 11B is a diagram for describing filter conditions. On the display condition setting screen, the player can select and set a sorting condition illustrated in FIG. 11A. Here, as the sorting condition, any one of an evaluation score, factor, number of skills, name, track aptitude, registration date, running style aptitude, compatibility level, distance aptitude, and memo can be selected and set. When the sorting condition is set, the nurtured character list screen 180 is displayed. At this time, in the nurtured character list screen 180, the display order of the nurtured character icons 182 is changed in accordance with the sorting condition.

Further, the player can select and set a filter condition illustrated in FIG. 11B on the display condition setting screen. Here, basic ability factor, aptitude factor, and compatibility level are provided as the filter conditions. When the basic ability factor or the aptitude factor is set as the filter condition, only the nurtured characters having the factor selected by the player are displayed on the nurtured character list screen 180.

At this time, the player can set the factor level. For example, when the factor level is set to level 3 for filtering, only the nurtured characters having the factor with a factor level of level 3, from among the factors selected by the player, are displayed on the nurtured character list screen 180. The player can filter the nurtured characters by selecting whether the nurtured character itself has a factor or whether the inheritance character of the nurtured character has a factor.

In addition, the player can filter using the compatibility level. Here, it is possible to filter for nurtured characters having a compatibility of ⊚, nurtured characters having a compatibility of ∘, and nurtured characters having a compatibility of Δ. In this manner, sorting and filtering can be performed using various conditions, and user-friendliness for the player is enhanced.

Further, when tapping and holding the nurtured character icon 182 on the nurtured character list screen 180 illustrated in FIG. 7B, detailed information of the nurtured character corresponding to the nurtured character icon 182 is displayed.

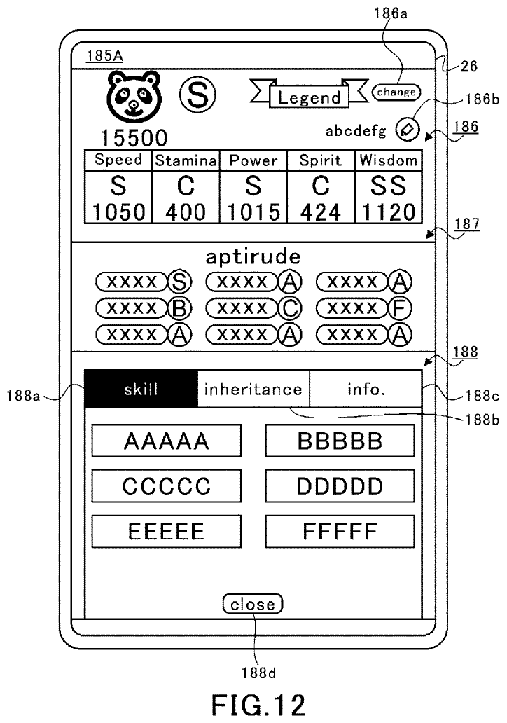

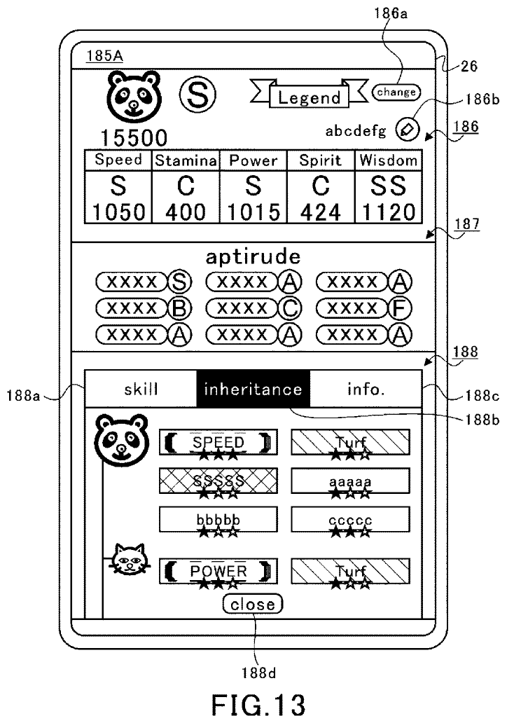

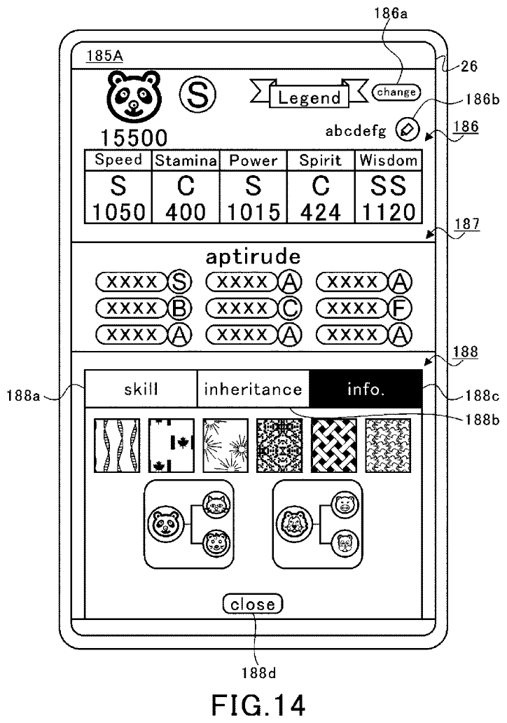

FIG. 12 is a first diagram for describing a character detail dialog 185A. FIG. 13 is a second diagram for describing the character detail dialog 185A. FIG. 14 is a third diagram for describing the character detail dialog 185A. In the character detail dialog 185A, detailed information of the nurtured character is displayed. In the upper part of the character detail dialog 185A, an ability parameter display field 186 indicating the ability parameters of the nurtured character is displayed.

At the upper left of the ability parameter display field 186, an icon indicating a character based on the nurtured character, the evaluation score of the nurtured character, and a nurture rank are displayed. A nickname change button 186a and a memo input button 186b are provided at an upper right of the ability parameter display field 186. When the nickname change button 186a is tapped, a nickname list screen (not illustrated) is displayed. A list of the nicknames obtained by the nurtured character is displayed on the nickname list screen. In the nurture main game, a large number of nicknames are provided, and an obtaining condition is set for all of the nicknames.

In the nurture main game, nicknames satisfying the obtaining condition are given to the nurtured character. The player can select one of the nicknames obtained by the nurtured character and set the selected one for the nurtured character. The player can change the nickname to be set for the nurtured character on the nickname list screen. The currently set nickname (here, Legend) is displayed on the left side of the nickname change button 186a.

Examples of the nickname obtaining conditions include the nurture target character obtaining a predetermined number of fans, an ability parameter or aptitude parameter being equal to or greater than a predetermined value, the nurture target character obtaining a predetermined skill, the number of race wins being equal to or greater than a predetermined number, the nurture target character obtains a predetermined placing (for example, first) in a specific race, and the like.

When the memo input button 186b is tapped, a character input screen (not illustrated) is displayed. On the character input screen, for example, hiragana, katakana, numbers, roman characters, and the like can be input up to a limit of nine characters. The characters input on the character input screen are stored as a memo in association with the nurtured character. When a memo is stored for the nurtured character, a memo (abcdefg in this case) is displayed on a left side of the memo input button 186b.

Note that the above-described memo is included as a sorting condition for the nurtured character icons 182 on the nurtured character list screen 180. Thus, the player can more easily search for a nurtured character to be used as the inheritance character by registering a memo in association with the nurtured character.

An aptitude information display field 187 is displayed below the ability parameter display field 186. In the aptitude information display field 187, aptitude parameters related to track aptitude for turf and dirt; aptitude parameters related to distance aptitude for short distance, mile, medium distance, and long distance; and aptitude parameters related to running style aptitude for front-runner, stalker, midfielder, and closer are displayed.

Below the aptitude information display field 187, a various information display field 188 is displayed. In the various information display field 188, a skill display tab 188a, an inheritance information display tab 188b, a nurture information display tab 188c, and a close operation portion 188d are provided. When the skill display tab 188a is tapped, as illustrated in FIG. 12, the obtained skill of the nurtured character is displayed in the various information display field 188. When the inheritance information display tab 188b is tapped, the inheritance information of the nurtured character is displayed as illustrated in FIG. 13.

In the various information display field 188, inheritance information is displayed based on a nurtured character that can be set as an inheritance character and an inheritance character used for nurturing the nurtured character. The inheritance information includes information of an inheritance character used for nurturing the nurtured character, factor information of the nurtured character, and factor information of the inheritance character. Here, a list of inheritance information is displayed for each nurtured character.

Specifically, factor information associated with a nurtured character and factor information associated with an inheritance character of the nurtured character are displayed for each character. Thus, by scrolling the various information display field 188 in the vertical direction, the player can check the factor information of each of the three characters.

In the various information display field 188, the basic ability factor, the aptitude factor, and the character factor are displayed in different colors. For example, the basic ability factor is displayed in blue, the aptitude factor is displayed in red, and the character factor is displayed in green. In the various information display field 188, the race factor and the skill factor are displayed in white. Further, a star indicating the factor level is superimposed on each factor information.

When the nurture information display tab 188c is tapped, the nurture information of the nurtured character is displayed as illustrated in FIG. 14. The nurture information includes the type of support card used to nurture the nurtured character, the first inheritance generation and second inheritance generation characters, race performance in the nurture game, and an evaluation score.

As described above, in the character detail dialog 185A, the player can check various types of information related to the nurtured character. Thus, the player can easily recognize the information associated with the inheritance character in the deck, and the user-friendliness for the player can be enhanced.

Note that in the character detail dialog 185A, when the close operation portion 188d is tapped, the character detail dialog 185A is closed, and the nurtured character list screen 180 is displayed on the display 26. As illustrated in FIGS. 7A, 7B, 7C, and 7D, a skill display button 172 is provided at the upper right of the inheritance character selection screen 170 and the nurtured character list screen 180. When the skill display button 172 is tapped, a list of skills that may be obtained by the nurtured character that is provisionally selected as the inheritance character is displayed.

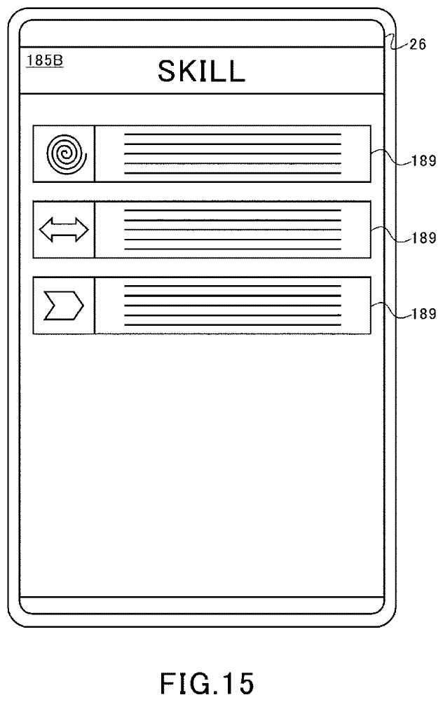

FIG. 15 is a diagram for describing a skill display dialog 185B. In the skill display dialog 185B, a skill description display field 189 including an icon corresponding to a skill and a description of the skill is displayed. The list of skills displayed in the skill description display field 189 are all skills that the nurture target character has a possibility of obtaining if the currently selected nurtured character is used as an inheritance character.

In other words, in the skill display dialog box 185B, a list of information related to skills associated with character factors or skill factors of the nurtured character is displayed. As illustrated in FIG. 7C, when the skill display button 172 is tapped in a state in which one nurtured character is selected as an inheritance character, the skill associated with the character factor and the race factor of the one nurtured character (inheritance character) is displayed in the skill display dialog 185B.

On the other hand, as illustrated in FIG. 7D, when the skill display button 172 is tapped in a state in which two nurtured characters are selected as inheritance characters, the skill associated with the character factor and the race factor of each of the two nurtured characters (inheritance characters) is displayed in the skill display dialog 185B.

As described above, in the present embodiment, a list of inheritance information (factor information) is displayed for each nurtured character that can be set as an inheritance character in the character detail dialog box 185A. Also, in the skill display dialog 185B, a list of information (skill) associated with the inheritance information (factor information) is displayed. At this time, the character detail dialog 185A and the skill display dialog 185B are displayed based on the nurtured character that can be set as the inheritance character and the inheritance character used to produce the nurtured character. By displaying the character detail dialog 185A and the skill display dialog 185B, the user-friendliness for the player is enhanced.

Then, when the two nurtured characters are put in a provisionally selected state, the next operation portion 154 provided on the inheritance character selection screen 170 becomes enabled. When the enabled next operation portion 154 is tapped, the nurtured character in the provisionally selected state is provisionally registered in the deck as an inheritance character, and a support card organization screen 190 described below is displayed.

It should be noted that the player must select two nurtured characters as inheritance characters on the inheritance character selection screen 170. When two inheritance characters are not in a provisionally selected state, the next operation portion 154 is grayed out as illustrated in FIGS. 7A and 7C, and a player operation is not accepted. Further, the return operation portion 153 is provided on the inheritance character selection screen 170, and when the return operation portion 153 is tapped, the nurture target character selection screen 150 is displayed.

### Registration of Support Card

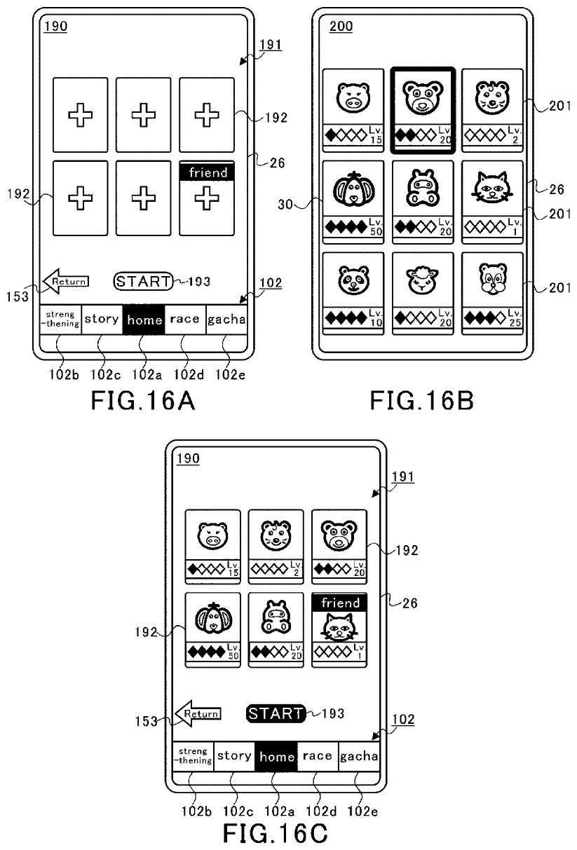

FIG. 16A is a first diagram for describing the support card organization screen 190. When two inheritance characters are registered on the inheritance character selection screen 170, the support card organization screen 190 illustrated in FIG. 16A is displayed. A support card display region 191 is provided at a central portion of the support card organization screen 190. The support card display region 191 includes a plurality of support card display frames 192. In addition, the return operation portion 153 denoted by “Return” and a start operation portion 193 denoted by “START” are displayed at a lower portion of the support card organization screen 190.

In the support card display region 191, a plurality of (here, six) support card display frames 192 are displayed. The number of support card display frames 192 displayed is the same as the number of support cards that can be set by the player. When the support card organization screen 190 is first displayed, the support card display frames 192 are blank.

In the present embodiment, the player can set six types of support cards in the deck. One or more (for example, five types) of the six types that can be set by the player can be selected from among the support cards possessed by the player. In addition, the remaining (for example, one type) of the six types that can be set by the player can be selected from support cards set as rental cards by other players such as friends.

FIG. 16B is a diagram for describing a support card selection screen 200. When the support card display frame 192 (excluding the support card display frame 192 displayed at a lower right) is tapped on the support card organization screen 190 of FIG. 16A, the support card selection screen 200 illustrated in FIG. 16B is displayed on the display 26. The support card selection screen 200 displays a list of card icons 201 corresponding to the support cards owned by the player. By tapping the card icon 201 displayed on the support card selection screen 200, the player can select a support card.

Although not illustrated, when the support card display frame 192 displayed at the lower right of the support card organization screen 190 is tapped, a support card set as a rental card by a friend or a player extracted based on a predetermined condition such as a lottery is displayed on the support card selection screen 200. At this time, the player can select one friend support card by tapping a support card displayed on the support card selection screen 200. In this manner, the player can use a support card possessed by another player in the nurture game.

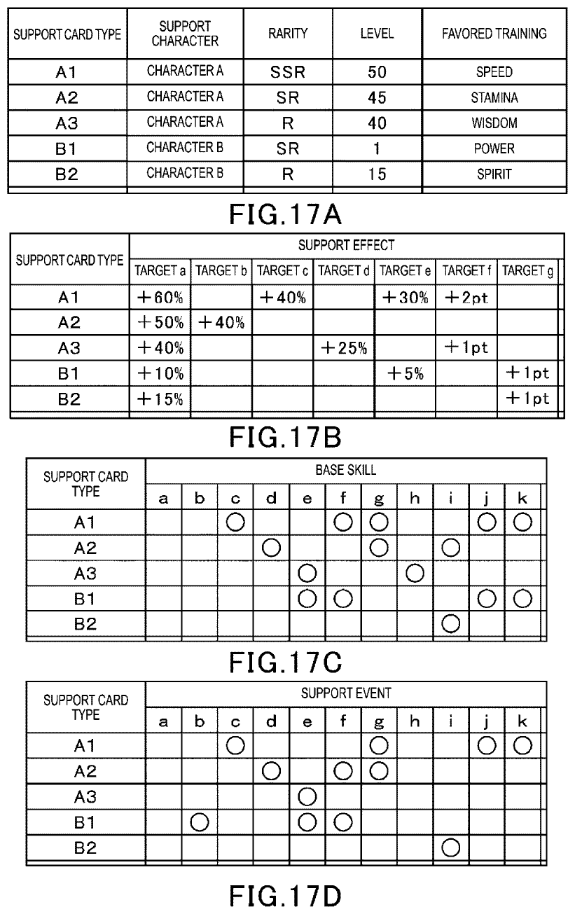

FIG. 17A is a diagram for describing a support card table. As illustrated in FIG. 17A, the support card table stores the type of support character (that is, a character ID), rarity, level, and favored training for each type of support card possessed by the player (that is, support card ID). The support characters are in one to-one correspondence with the types of support cards. That is, one character ID is always associated with a support card ID. In other words, one support card is always associated with one support character.

In the present embodiment, a rarity is set for each support card. The rarity has three levels: R (rare), SR (super rare), and SSR (super special rare). R is set to the lowest rarity and SSR is set to the highest rarity. In the present embodiment, a support card having a higher rarity tends to have a higher support effect to be described below. In the present embodiment, the number of base skills and the number of support events to be described below tend to increase as the rarity of a support card increases.

For the levels of the support card, 50 levels from level 1 to level 50 are provided. The level of the support card can be increased by the player, and the level increased by the player is stored for each support card. The level of the support card can be raised by using in-game currency, an item, or the like. The level of the support card has an upper limit depending on rarity.

For example, level 20 is set as the upper limit for a support card with a rarity of R, level 25 is set as the upper limit for a support card with a rarity of SR, and level 30 is set as the upper limit for a support card with a rarity of SSR.

The upper limit of the level can be raised incrementally when a predetermined condition is satisfied. For example, a support card with a rarity of R may have its upper limit raised to level 40, a support card with a rarity of SR may have its upper limit raised to level 45, and a support card with a rarity of SSR may have its upper limit raised to level 50.

FIG. 17B is a diagram for describing a support effect table. As illustrated in FIG. 17B, the support effect table stores a support effect for each type of support card possessed by the player.

The support effects increase various stats in the nurture main game. A support card has support effects for a plurality of targets. Examples of the support effect targets include energy, speed, stamina, power, spirit, and wisdom.

FIG. 17C is a diagram for describing a base skill table. As illustrated in FIG. 17C, in the base skill table, a base skill is set for each support card possessed by the player. In the present embodiment, the base skill is set for each support card so that the character set as the nurture target character by the player possesses the base skill. The base skill set for each support card can be obtained by the nurture target character selected by the player when a hint event occurs during the nurture main game.

FIG. 17D is a diagram for describing a support event table. As illustrated in FIG. 17D, the support event table stores support events that may occur for each support card owned by the player. A support event is an event that may occur during the nurture main game. When a support event occurs, the values of various stats in the nurture main game may increase or decrease.

For example, a support event that occurs according to the turn number, or a support event that occurs according to a predetermined lottery may be determined. A plurality of support events to occur may be selected in one turn. In any case, the support event to occur may be determined according to a predetermined determination method set in advance.

Note that the support events may include a first hint event that may occur at the start of a turn in the nurture game, a second hint event that may occur after training is performed in the nurture game which will be described below, a first ability event that may occur at the start of a turn in the nurture game, a second ability event that may occur after training is performed in the nurture game, and the like. The first hint event and the second hint event are events that make it possible to possess or obtain a skill. Further, the first ability event and the second ability event are events for increasing or decreasing the numerical value of an ability parameter of the character. Hereinafter, the first hint event and the first ability event are collectively referred to as a first event, and the second hint event and the second ability event are collectively referred to as a second event.

FIG. 16C is a second diagram for describing the support card organization screen 190. In the present embodiment, when all six support cards are selected, the start operation portion 193 becomes operable as illustrated in FIG. 16C. On the other hand, when all the six support cards are not selected, the start operation portion 193 cannot be operated as illustrated in FIG. 16A.

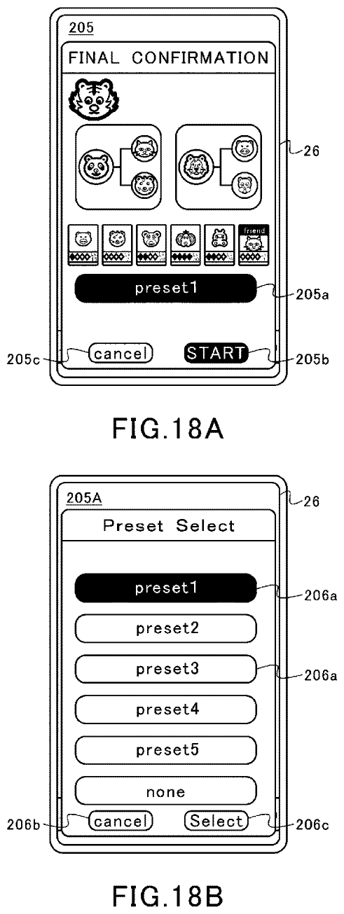

When the return operation portion 153 is operated on the support card organization screen 190, the inheritance character selection screen 170 illustrated in FIG. 7D is displayed on the display 26. Further, as illustrated in FIG. 16C, when the start operation portion 193 is tapped on the support card organization screen 190, the selected support card is provisionally registered, and a final confirmation screen 205 (FIG. 18A) is displayed.

FIG. 18A is a diagram for describing the final confirmation screen 205. FIG. 18B is a diagram for describing a preset selection screen 205A. On the final confirmation screen 205, the nurture target character selected by the player, the nurtured character in the first inheritance group, the nurtured character in the second inheritance group, and the support cards are displayed. Further, a preset display portion 205a is displayed on the final confirmation screen 205. In the preset display portion 205a, the number of the preset currently selected is indicated.

Here, the preset is reservation information of a race in which the nurture target character is entered in the nurture main game. The player can select any race from all the races to create a preset. A plurality of presets can be stored, and one preset can be selected from the stored presets on the final confirmation screen 205. To be more specific, when the preset display portion 205a is tapped, the preset selection screen 205A illustrated in FIG. 18B is displayed.

On the preset selection screen 205A, preset read buttons 206a corresponding to stored presets are displayed. The player can set a preset by tapping any of the preset read buttons 206a and then tapping a select operation portion 206c. When the select operation portion 206c is tapped, the preset selection screen 205A is closed, and the final confirmation screen 205 is displayed. When a cancel operation portion 206b of the preset selection screen 205A is tapped, the preset selection screen 205A is displayed without changing the preset.

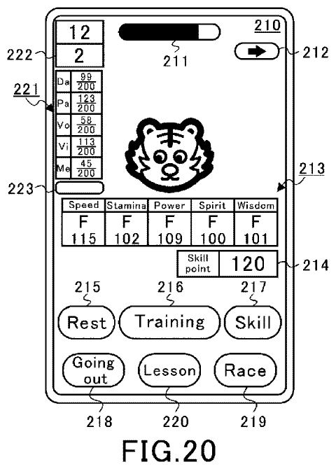

When a cancel operation portion 205c is tapped on the final confirmation screen 205, the support card organization screen 190 is displayed. On the other hand, when a start operation portion 205b is tapped, a game screen 210 (FIG. 20A) is displayed on the display 26.

In the present embodiment, when a support card is registered, the character type set as the nurture target character and the character type set as the support character are restricted so as to not be the same.

As described above, when the nurture target character, the inheritance character, and the support card are registered, the preparation stage processing ends.

### Nurture Stage Processing

When the preparation stage processing ends, the nurture stage processing is started. Via the nurture stage processing, the nurture main game in which the nurture target character can be nurtured progresses. Hereinafter, in order to facilitate understanding, first, a basic flow of the nurture main game will be described.

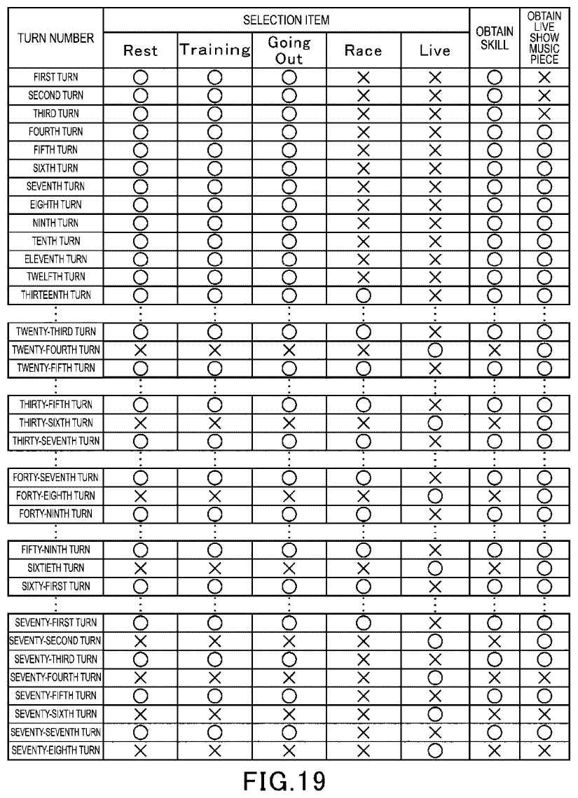

FIG. 19 is a diagram for describing selection items in each turn. Here, the selection items that can be selected are the same for each turn regardless of the type of the nurture target character. However, the selection items that can be selected may be different in each turn depending on the type of the nurture target character. As illustrated in FIG. 19, the nurture main game includes a first turn to a 78th turn. Various parameters are updated in accordance with the selection item selected by the player in each turn.

FIG. 20 is a diagram for describing the game screen 210. In the nurture stage processing, the game screen 210 illustrated in FIG. 20 is displayed on the display 26. In an upper portion of the game screen 210, an energy display portion 211 and a mood display portion 212 are displayed. The nurture target character is provided with an “energy” parameter. The “energy” parameter is mainly used for calculation of a failure rate which is a probability of failure in training described below. The energy display portion 211 is displayed so that the current remaining amount of the “energy” of the nurture target character can be visually recognized with respect to the upper limit value of the “energy”.

The nurture target character is provided with a “mood” parameter. The mood display portion 212 displays the current “mood” of the nurture target character using a plurality of levels (five levels including very bad, bad, normal, good, and very good) so that the user can visually recognize the mood. With better “mood”, race developments become more advantageous for the nurture target character and the increase value of ability parameters in training are increased.

As illustrated in FIG. 20, an image of the nurture target character, a stats display portion 213, and a skill point display portion 214 are displayed at a central portion of the game screen 210. In the stats display portion 213, the current stats of the nurture target character are indicated by numerical values and ranks of a plurality of levels (18 levels including G, G⁺, F, F⁺, E, E⁺, D, D⁺, C, C⁺, B, B⁺, A, A⁺, S, S⁺, SS, and SS⁺).

Specifically, in the present embodiment, the numerical values and ranks of the ability parameters for “Speed”, “Stamina”, “Power”, “Spirit”, and “Wisdom” are displayed. In the skill point display portion 214, the remaining amount of skill points possessed by the nurture target character in the nurture game is indicated by a numerical value.

As illustrated in FIG. 20, a rest operation portion 215 denoted by “Rest”, a training operation portion 216 denoted by “Training”, a skill operation portion 217 denoted by “Skill”, a going out operation portion 218 denoted by “Going out”, a race operation portion 219 denoted by “Race”, and a live show preparation operation portion 220 denoted by “Lesson” are displayed at a lower portion of the game screen 210.

When the rest operation portion 215 is selected, a rest event occurs and energy is recovered. When the training operation portion 216 is selected, training to be described below can be performed. When the skill operation portion 217 is selected, a skill can be obtained. When the going out operation portion 218 is selected, a going out event occurs, and mainly the mood increases.

When the race operation portion 219 is selected, it is possible to enter the nurture target character in a race. When a race is performed, a reward such as in-game currency, fans, and the like is given in accordance with the placing of the nurture target character in the race. At this time, the higher the placing, the greater the reward to be obtained. In addition, the higher the difficulty of the race, the more rewards can be obtained. For example, for the grades of GI, GII, and GIII, the higher the grade of the race, the more rewards can be obtained.

When the live show preparation operation portion 220 is selected, a live show music piece or skill to be performed at a live show event described below (hereinafter referred to as a live show music piece and the like) can be obtained. Hereinafter, the portions from the rest operation portion 215 to the live show preparation operation portion 220 are referred to as commands. In addition, the executed processing or the event itself based on an operation of a portion from the rest operation portion 215 to the live show preparation operation portion 220 may be referred to as a command.

When a rest event occurs, a going out event occurs, training is performed, or a race is entered, the current turn ends, and the flow proceeds to the next turn. On the other hand, when a skill is obtained and a live show music piece is obtained, the current turn does not end and another command can be selected.

In FIG. 19, a command that can be selected by the player in each turn is denoted by ∘, and a command that cannot be selected by the player in each turn is denoted by x. The commands that can be selected by the player in each turn illustrated in FIG. 19 are merely examples. Here, in the present embodiment, the 24th turn, the 36th turn, the 48th turn, the 60th turn, the 72nd turn, the 74th turn, the 76th turn, and the 78th turn are set as live show performance turns. In the live show performance turn, a live show event denoted by “Live” in FIG. 19 occurs. In the live show performance turn, commands that can be selected by the player are limited to performing a live show event or obtaining a live show music piece.

However, in the live show performance turn, a command other than performing a live show event and obtaining a live show music piece may be selectable. In this case, for example, a live show event may be performed after a command to end the current turn is selected and a predetermined event occurs.

Although details will be described below, in the present embodiment, the live show event is performed based on the live show music piece obtained up until the live show performance turn. The nurture target character obtains a parameter for each performance (hereinafter referred to as a performance parameter) described below by performing training. The live show music piece can be obtained by spending a performance parameter possessed by the nurture target character. When the live show event is performed, a reward is given to the player. As the number of live show music pieces obtained up until the live show event is performed increases, the reward given to the player becomes more advantageous.

It should be noted that, during the nurture main game, the player can check the live show music pieces obtained up until the next live show event is performed on various screens. However, when a live show event is performed, the number of live show music pieces obtained up until the next live show event, that is, the number of live show music pieces currently obtained becomes 0. Thus, the player needs to obtain live show music pieces as appropriate during a period from the start of the nurture main game to the first live show performance turn or between live show performance turns.

As illustrated in FIG. 20, a performance parameter display portion 221, a turn display portion 222, and an obtaining status display icon 223 are provided in an upper left portion of the game screen 210. The value of the performance parameter possessed by the nurture target character is displayed in the performance parameter display portion 221. In the present embodiment, five types of performance items are provided: dance, passion, vocal, visual, and mind. A parameter is provided for each performance item.

Da, Pa, Vo, Vi, and Me displayed in the performance parameter display portion 221 indicate the performance items dance, passion, vocal, visual, and mind, respectively. In the performance parameter display portion 221, the upper limit value of the parameter for each performance item is indicated with the denominator, and the current value is indicated with the numerator. It should be noted that the upper limit value of the parameter for each performance item increases for each live show performance turn. For example, up until the first live show performance turn, the upper limit values of the parameters for all the performance items are set to 200. Thus, each performance parameter increases or decreases in a range of 200 or less until the 24th turn, which is the first live show performance turn. Then, with the end of the 24th turn, the upper limit value of the parameter for each performance item is raised to, for example, 300.

As described above, in the present embodiment, the upper limit value of the parameter for each performance item is raised incrementally. Thus, the player is requested to obtain live show music pieces frequently.

The turn display portion 222 displays the remaining number of turns until the next live show performance turn and the current number of turns from the start of the nurture main game. When the obtaining status display icon 223 is tapped, an obtaining status display screen (not illustrated) is displayed. On the obtaining status display screen, a list of pieces of music obtained since the previous live show performance turn and to be performed in the next live show event is displayed. In addition, on the obtaining status display screen, it is possible to check all the live show music pieces obtained since the start of the nurture main game.

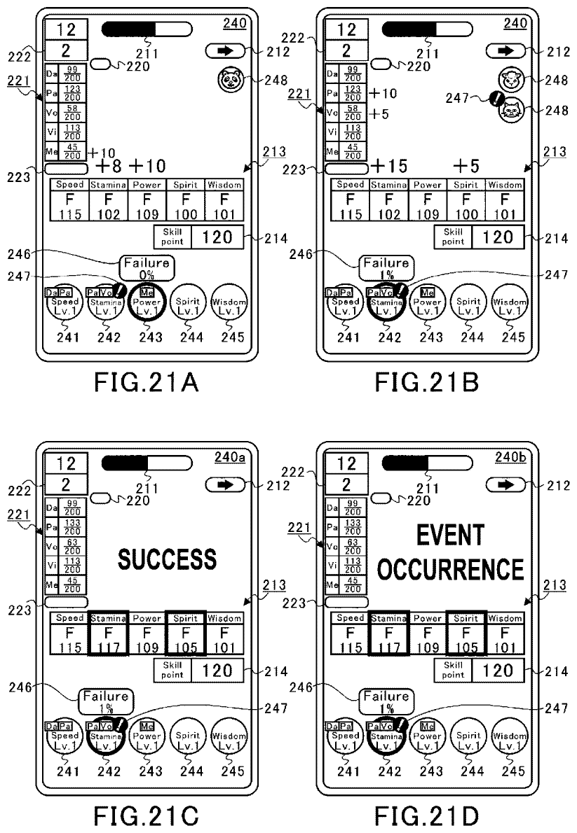

FIG. 21A is a first diagram for describing a training screen 240. FIG. 21B is a second diagram for describing the training screen 240. When the training operation portion 216 of the game screen 210 is operated, the training screen 240 is displayed on the display 26.

As illustrated in FIG. 21A, the stats display portion 213 and the skill point display portion 214 are displayed near the center of the training screen 240. In an upper left portion of the training screen 240, the live show preparation operation portion 220, the performance parameter display portion 221, the turn display portion 222, and the obtaining status display icon 223 are displayed. Further, training items are displayed in a lower portion of the training screen 240. Here, a speed operation portion 241 denoted by “Speed”, a stamina operation portion 242 denoted by “Stamina”, a power operation portion 243 denoted by “Power”, a spirit operation portion 244 denoted by “Spirit”, and a wisdom operation portion 245 denoted by “Wisdom” are displayed.

When the player taps one of the operation portions 241 to 245, the training item corresponding to the tapped operation portion 241 to 245 is provisionally selected. At this time, the operation portion 241 to 245 corresponding to the provisionally selected training item is highlighted. In FIG. 21A, the power operation portion 243 is provisionally selected. In FIG. 21B, the stamina operation portion 242 is provisionally selected.

In addition, a training level for each training item is also displayed together with each of the operation portions 241 to 245. The training level is a parameter that increases according to the number of times each training item has been selected. When the training levels are higher, the increase value of the ability parameter when the training is performed is larger. The training level is initially set to level 1 and can increase up to level 5.

In addition, a failure rate display portion 246 denoted by “Failure” is displayed at the operation portion 241 to 245 which is provisionally selected. The failure rate displayed as a numerical value in the failure rate display portion 246 is set so as to increase in inverse proportion to the remaining energy displayed in the energy display portion 211.

Further, in the stats display portion 213, the value of the ability parameter that increases when training during the provisional selection is successful is displayed. For example, in the example illustrated in FIG. 21A, the power operation portion 243 is provisionally selected, and “+8” is displayed in “Stamina” and “+10” is displayed in “Power” of the stats display portion 213. In the example illustrated in FIG. 21B, the stamina operation portion 242 is provisionally selected, and “+15” is displayed in “Stamina” and “+5” is displayed in “Spirit” of the stats display portion 213.

In addition, when the training is successful, an event notification display 247 is displayed at the operation portion 241 to 245 corresponding to the training item for which the predetermined event occurs. Note that the event notification display 247 may have different display modes depending on the type of the event.

Also, as illustrated in FIG. 21B, in an upper right portion of the training screen 240, a placed character icon 248 corresponding to the character placed in the provisionally selected training is displayed. When the training is successful, a predetermined event may occur corresponding to the character displayed in the placed character icon 248. In this case, the event notification display 247 is displayed on the corresponding placed character icon 248.

In the present embodiment, a support character is included with a character placed in training. When training with a placed support character is performed, a second event associated with the placed support character may occur. When the second event occurs, the event notification display 247 is displayed on the placed character icon 248. When training with a placed support character is successful, the parameter increase value of the nurture target character is higher than that when training without a placed support character is successful.

The characters placed in the training include characters other than the support characters corresponding to the support cards registered by the player in the preparation stage processing. For example, a character selected through a lottery from among all the support characters implemented in the game may be placed in training. In this case, a character icon 248 indicating a character other than the support characters registered by the player is displayed on the training screen 240.

When the training in which the character icon 248 is displayed is performed, an event associated with the character other than the support characters registered by the player may occur. Here, the occurrence rate of an event associated with a character not registered by the player is lower than the occurrence rate of an event associated with a support character registered by the player. Also in this case, the event notification display 247 may be displayed on the character icon 248 displayed on the training screen 240.

FIG. 21C is a diagram for describing a training result notification screen 240a. When any one of the provisionally selected operation portions 241 to 245 is tapped again, training corresponding to the tapped operation portion 241 to 245 is performed. When the training is performed, the training result notification screen 240a for notifying of the success or failure of the training is displayed on the display 26. Here, the text “success” is displayed to notify the player of the success of the training.

At this time, based on the success of the training, the ability parameter of the stats display portion 213 is updated and displayed. That is, the ability parameter (ability information) of the nurture target character corresponding to the training item (nurturing event) selected by the player is updated.

Here, the value of the ability parameter that increases when the training displayed in the stats display portion 213 in FIG. 21A or 21B is successful is added. In addition, the display of the energy display portion 211 is updated according to the performed training item. When speed, stamina, power, or spirit training is performed and the training is successful, the energy decreases. On the other hand, when wisdom training is performed and the training is successful, energy is recovered.

When the training is failed, a predetermined penalty is given. Specifically, the content of the penalty may include a decrease in energy, a decrease in a numerical value of an ability parameter, a decrease in mood, and the like. Note that, for example, the penalty given when the failure rate is high may be more disadvantageous than the penalty given when the failure rate is low (for example, the numerical value of the decrease in energy is large, the numerical value of the decrease in the ability parameter is large, or the level of the decreasing mood is large).

The content of the penalty may be determined in accordance with the training item. For example, the value of the ability parameter for speed may be decreased when the training of speed has failed, and the value of the ability parameter for power may be decreased when the training of power has failed. In addition, for one or more training items (for example, wisdom), even if training fails, a penalty may not be given.

Here, in the present embodiment, a performance item is associated with each training item with a predetermined probability. For example, at the start of a turn, for each training item, a performance item to be associated is determined through a lottery. Here, a maximum of two performance items are associated with one training item. As illustrated in FIGS. 21A and 21B, the performance items associated with the training items are identifiably displayed at the speed operation portion 241 to the vigilance operation portion 245.

To be specific, in the example illustrated in FIG. 21A, two performance items dance and passion are associated with the training item speed. In this case, “Da” indicating dance and “Pa” indicating passion are displayed at the speed operation portion 241. Similarly, the performance items passion and vocal are associated with the stamina operation portion 242. Further, a mind performance item is associated with the power operation portion 243. On the other hand, no performance items are associated with the training items spirit and wisdom. However, in all of the turns, one or more performance items may be necessarily associated with all the training items. Further, the same performance item may be associated with two or more different training items.

Let's assume that a training item is selected and the training is successful. At this time, when a performance item is associated with the successful training, the parameter for the associated performance item increases. As described above, in the example illustrated in FIG. 21A, the mind performance item is associated with the power training item. In a state where the power training item is provisionally selected, “+10” is indicated on the right side of the mind display portion in the performance parameter display portion 221. This indicates that the mind performance parameter will increase by 10 if the power training is successful.

Similarly, the example illustrated in FIG. 21B indicates that the performance parameter for passion will increase by 10 and the performance parameter for vocal will increase by 5 if the training of stamina is successful. In this manner, in a state where a training item is provisionally selected, the value of the performance parameter that increases when the provisionally selected training is successful is displayed at the performance parameter display portion 221.

Then, when the training item is determined and the training is successful, the performance parameter increases. In FIG. 21C, a case where the training of stamina is successful is illustrated. Here, as can be seen from a comparison between FIG. 21B and FIG. 21C, in the performance parameter display portion 221, the performance parameter for passion is increased by 10 and the performance parameter for vocal is increased by 5. The increase value of the performance parameter will be described below.

FIG. 21D is a diagram for describing an event screen 240b. When the display of the training result notification screen 240a ends, the event screen 240b may be displayed on the display 26. Various events are performed via the event screen 240b. Note that a plurality of events may occur during one turn.

For example, when a first hint event or a second hint event occurs, a skill hint may be obtained. When skill hint is obtained, the player can obtain the skill by spending skill points. A plurality of types of skills are provided, and a predetermined ability may be activated for each skill. An activation condition and an effect are determined for each skill, and when an activation condition is satisfied, a predetermined effect is activated. A skill may be activated while a race is being executed as described below.

The events include, in addition to the first hint event and the second hint event for possessing a skill, an event for recovering energy, an event for decreasing energy, a first ability event and a second ability event for increasing or decreasing an ability parameter, an event for increasing mood, an event for decreasing mood, and the like. As will be described in detail below, examples of the event include an event that occurs in a predetermined turn and an event that occurs via a successful lottery. In addition, there are events that occur at the start of a turn and events that occur before the end of a turn. When all the events that have occurred end, the game screen 210 related to the next turn is displayed.

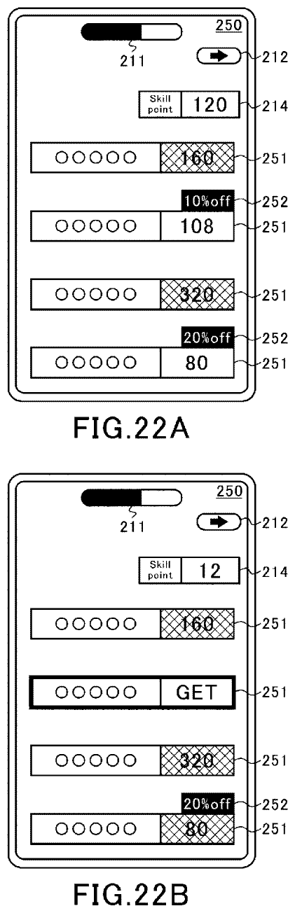

FIG. 22A is a first diagram for describing a skill screen 250. FIG. 22B is a second diagram for describing the skill screen 250. When the skill operation portion 217 of the game screen 210 is operated, the skill screen 250 illustrated in FIG. 22A is displayed on the display 26.

A skill display field 251 is displayed on the skill screen 250. In the skill display field 251, an obtained skill, a base skill set in advance for the nurture target character, a base skill possessed due to one of various types of events, and the like are displayed. When the first hint event or the second hint event occurs for a base skill, the skill points spent to obtain the base skill is discounted. Here, with respect to the base skill for which a hint has been obtained, the skill points needed for obtaining the hint are discounted and displayed. At this time, a discount rate display icon 252 indicating the discount rate is displayed together with the skill display field 251.

For each skill displayed on the skill screen 250, the activation condition and the effect when activated of each skill are displayed. When the player obtains the base skill by spending the skill points based on an operation by the player, “GET” is displayed at the obtained skill as illustrated in FIG. 22B to notify that the base skill has been obtained, and the spent skill points are subtracted from the skill points displayed in the skill point display portion 214 to update the display.

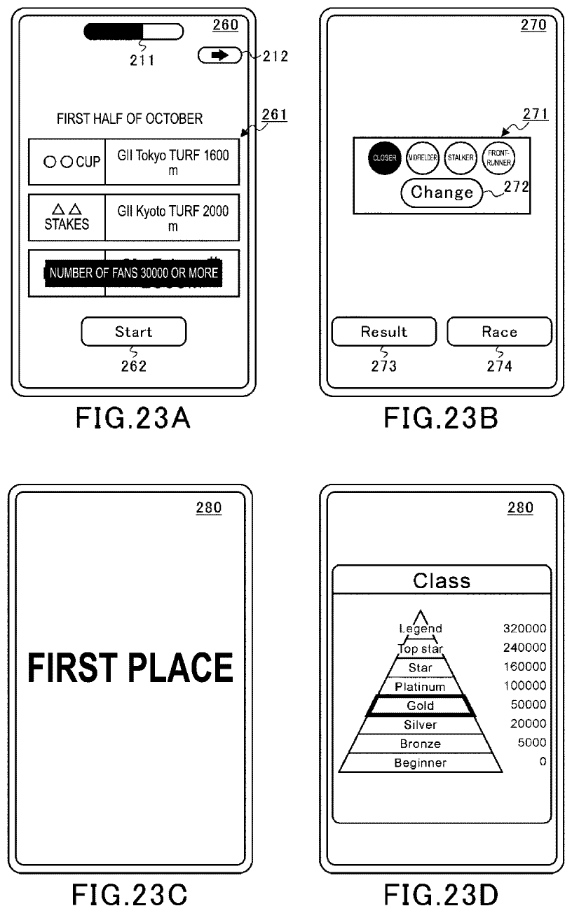

FIG. 23A is a first diagram for describing a race selection screen 260. When the race operation portion 219 of the game screen 210 is operated, the race selection screen 260 illustrated in FIG. 23A is displayed. Races have a game property in which the nurture target character races with NPCs.

In the upper portion of the race selection screen 260, the energy display portion 211 and the mood display portion 212 are displayed. In addition, a race selection operation portion 261 for selecting a race event for the nurture target character to be entered in is displayed in a central portion of the race selection screen 260. A plurality of the race selection operation portions 261 may be displayed on the race selection screen 260. In addition, a start operation portion 262 denoted by “Start” is displayed at a lower portion of the race selection screen 260. A race that can be selected via the race selection operation portion 261 of the race selection screen 260 is set in advance for each turn.

In addition, the race entry condition is set in advance for each race, and the player can only enter the nurture target character in a race with race entry conditions that are satisfied. As described above, a race may have the number of fans set as a race entry condition. For a race with a set number of fans that is not satisfied, as illustrated in FIG. 23A, the race selection operation portion 261 displays the race entry condition and notifies that the race cannot be selected.

FIG. 23B is a diagram for describing a race start screen 270. When the start operation portion 262 is operated in a state where the race event of the race to be run in is selected by the race selection operation portion 261, the race start screen 270 illustrated in FIG. 23B is displayed. A strategy display portion 271 is displayed at a central portion of the race start screen 270. In the strategy display portion 271, the currently selected strategy (closer, midfielder, stalker, front-runner) is highlighted, and a change operation portion 272 denoted by “Change” is displayed. When the change operation portion 272 is operated, a strategy change screen (not illustrated) is displayed on the display 26. The player can change the strategy in the race to any strategy by an operation on the strategy change screen.

Further, at a lower portion of the race start screen 270, a result operation portion 273 denoted by “Result” and a race operation portion 274 denoted by “Race”.

When the race operation portion 274 is operated, a race screen (not illustrated) is displayed on the display 26. On the display 26, a moving image of developments in the race (hereinafter also referred to as a race moving image) is displayed.

FIG. 23C is a first diagram for describing a race result screen 280. FIG. 23D is a second diagram for describing the race result screen 280. When playback of the race moving image described above ends and when the result operation portion 273 is operated, the race result screen 280 is displayed on the display 26. On the race result screen 280, as illustrated in FIG. 23C, the placing of the nurture target character in the race is displayed. Further, on the race result screen 280, as illustrated in FIG. 23D, the current class of the nurture target character is displayed.

In the present embodiment, the nurture target character is classified according to the obtained number of fans. In each class, a range for the number of fans is set, and here, the nurture target character is classified into one of eight levels of classes according to the number of fans. On the race result screen 280, the number of fans obtained in the current race is displayed. Further, on the race result screen 280, the cumulative number of fans obtained by adding the newly obtained number of fans to the number of fans obtained before is displayed. In addition, the current class corresponding to the accumulated number of fans is displayed in an identifiable manner.

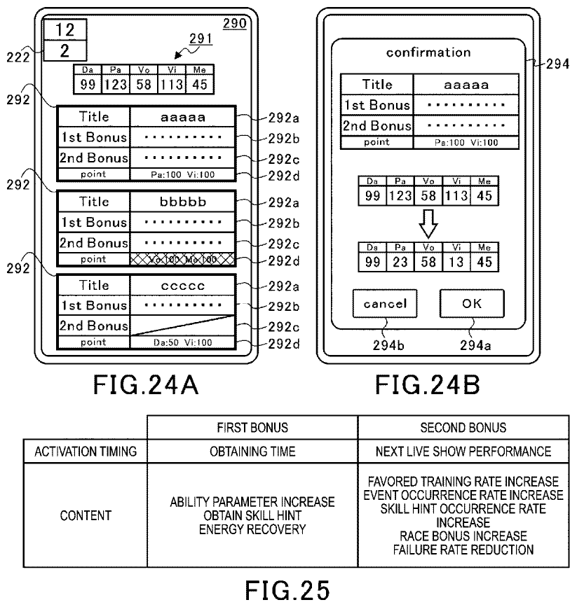

FIG. 24A is a diagram for describing an example of a live show preparation screen 290. When the live show preparation operation portion 220 of the game screen 210 or the training screen 240 is operated, the live show preparation screen 290 illustrated in FIG. 24A is displayed. The live show preparation screen 290 is a screen for obtaining live show music pieces by spending a performance parameter. A performance parameter display portion 291 is displayed in an upper portion of the live show preparation screen 290. In the performance parameter display portion 291, current parameter values are displayed for each of the five types of performance items.

On the live show preparation screen 290, three live show music pieces that can be obtained by the player are presented. Below the performance parameter display portion 291, a live show music piece details display field 292 is displayed for each live show music piece. That is, on the live show preparation screen 290, three live show music piece details display fields 292 are always displayed. The three live show music piece details display fields 292 are each associated with a different live show music piece. The player can obtain the live show music piece associated with the live show music piece details display field 292 by tapping the live show music piece details display field 292.

The live show music piece details display field 292 includes a title display field 292a, a first bonus display field 292b, a second bonus display field 292c, and a spend parameter display field 292d. In the title display field 292a, the title name of a live show music piece is displayed. In the first bonus display field 292b, the content of the first bonus is displayed, and in the second bonus display field 292c, the content of the second bonus is displayed. In the spend parameter display field 292d, the performance parameters to be spent to obtain a live show music piece, in other words, the performance parameters necessary to obtain a live show music piece, is displayed.

FIG. 25 is a diagram for describing examples of the first bonus and the second bonus. The first bonus is always associated with a live show music piece. The first bonus is advantageous to the player. Examples of the first bonus include effects such as an increase in an ability parameter, obtaining a skill hint, and recovery of energy.

In addition to the first bonus, a second bonus may be associated with a live show music piece. Specifically, a live show skill associated with only the first bonus and the live show music piece associated with both the first bonus and the second bonus are provided. Like the first bonus, the second bonus is also advantageous to the player. Examples of the second bonus include effects such as an increase in the probability that a character is placed in a favored training (favored training rate), an increase in an occurrence probability of an event, an increase in an occurrence rate of a skill hint, an increase in the reward obtained in a race (race bonus), and a decrease in the failure rate.

Here, the first bonus and the second bonus are different from each other in terms of the activation timing of the effect. In other words, the first bonus and the second bonus are different from each other in terms of the timing at which the effect is achieved. The effect of the first bonus occurs in a turn when the player obtains a live show music piece. On the other hand, the effect of the second bonus occurs in a predetermined specific turn after a turn when the player obtains a live show music piece. Specifically, the effect of the second bonus occurs at the time of the next live show performance, that is, in the next live show performance turn.

In the first bonus display field 292b and the second bonus display field 292c illustrated in FIG. 24A, the effects that occur as the contents of the first bonus and the second bonus, respectively, are illustrated. In FIG. 24A, the second bonus display field 292c of the live show music piece details display field 292 displayed at the bottom is blank. This indicates that the second bonus is not associated with a live show music piece.

In addition, when the performance parameter necessary for obtaining the live show music piece is insufficient, the live show music piece displayed on the live show preparation screen 290 cannot be obtained. For a live show music piece that cannot be obtained due to a lack of a performance parameter, the spend parameter display field 292d of the live show music piece details display field 292 is displayed grayed out. In the example illustrated in FIG. 24A, the live show music piece corresponding to the live show music piece details display field 292 at the top and bottom can be obtained, and the live show music piece corresponding to the live show music piece details display field 292 in the middle cannot be obtained.

FIG. 24B is a diagram for describing a confirmation dialog 294. When the live show music piece details display field 292 corresponding to the live show music piece that can be obtained is tapped, the confirmation dialog 294 illustrated in FIG. 24B is displayed. In the confirmation dialog 294, the same information as in the live show music piece details display field 292 tapped by the player is displayed. In addition, the current performance parameter and the remaining performance parameter in the case of obtaining the live show music piece are displayed.

The confirmation dialog 294 is provided with an OK button 294a and a cancel button 294b. When the cancel button 294b is tapped, the confirmation dialog 294 is closed and the live show preparation screen 290 is displayed. When the OK button 294a is tapped, the live show music piece selected by the player is obtained. When the live show music piece is obtained, the first bonus associated with the obtained live show music piece is activated. When the first bonus is activated, various parameters are updated. Although not illustrated in the drawings, the effect provided by the first bonus is provided through notification by a performance.

As described above, when the player obtains a live show music piece, three live show music pieces that can be obtained next by the player are newly determined. That is, among the three live show music pieces presented on the live show preparation screen 290, the player loses an opportunity to obtain the two live show music pieces that the player has not obtained.

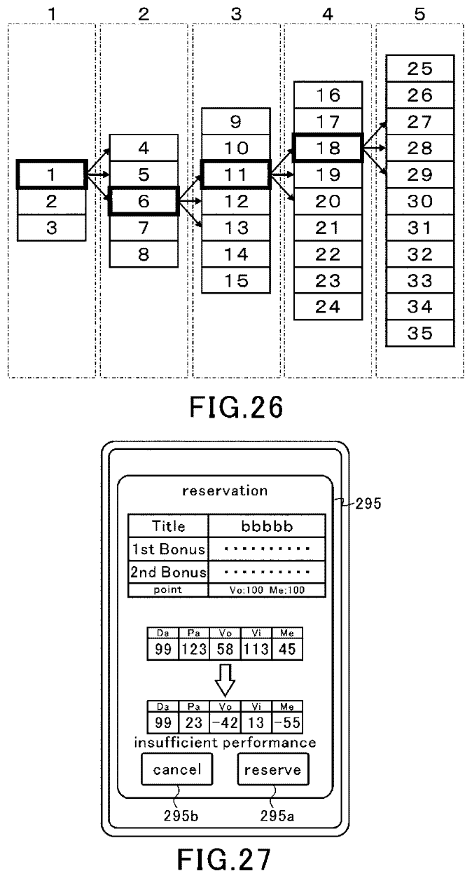

FIG. 26 is a diagram for describing an example of path information for live show music pieces. The live show music pieces presented as obtainable by the player have a so-called tree structure. For example, let's assume that three live show music pieces No. 1, No. 2, and No. 3 are first presented to the player after the start of the nurture main game. Then, when the player obtains the live show music piece No. 1, three live show music pieces No. 4, No. 5, and No. 6 are presented next. Thereafter, when the player obtains the live show music piece No. 6, three live show music pieces No. 11, No. 12, and No. 13 are presented next. Further, when the player obtains the live show music piece No. 11, three live show music pieces No. 18, No. 19, and No. 20 are presented next.

When the column with respect to the horizontal axis in FIG. 26 reaches the final column, the path may be looped so as to be connected to a predetermined column. Accordingly, the player can obtain live show music pieces regardless of the limits of the tree structure.

As described above, for the three live show music pieces presented to the player, three live show music pieces presented as obtainable next are set in advance. Different effects are associated with the live show music pieces obtained by the player. Thus, it is an important strategy element for the player to choose what live show music pieces to obtain following which path.

In the present embodiment, duplicate live show music pieces cannot be obtained. Thus, whether to display three live show music pieces that can be obtained next by the player may be determined based on whether the player has already obtained the live show music pieces. For example, a live show music piece that has already been obtained by the player is not displayed, and only a live show music piece that has not been obtained by the player is displayed. At this time, the obtained live show music piece may be replaced with another live show music piece that has not been obtained. As described above, by not displaying obtained music pieces or the like, it is ensured that three obtainable options are always displayed.

An upper limit may be placed on the number of music pieces that can be obtained during a specific turn. In this case, whether to display three live show music pieces that can be obtained next by the player is suitably determined based on whether the upper limit number of music pieces has been obtained during a specific turn. Accordingly, the pace of obtaining during the game is controlled with respect to the music pieces or the like which bring a particularly large effect, and it is possible to enhance enjoyment of the game.

Further, the method of determining the live show music pieces to be presented to the player is not limited thereto. For example, when the player obtains a live show music piece, a plurality of live show music pieces that can be newly obtained by the player may be determined through a lottery. In this case, for example, three live show music pieces that can be obtained next by the player may be determined through a lottery. Alternatively, two new live show music pieces may be determined through a lottery while leaving any one of the remaining two live show music pieces that the player has not obtained.

Further, for example, one live show music piece presented to the player may have the order of three routes determined, that is, a first route, a second route, and a third route. In this case, for example, when the player obtains the live show music piece of the first route, the next live show music piece determined on the first route is presented to the player. At this time, the live show music piece of the second route and the third route may be presented as they are or the next live show music piece may be presented to the player as with the first route.

Further, here, the player can obtain only one of the three presented live show music pieces. However, the player may be able to obtain a part or a plurality of the presented three live show music pieces.

When the player obtains a live show music piece, the live show music piece details display field 292 corresponding to the new live show music piece is displayed on the live show preparation screen 290. Thus, the player can obtain a plurality of live show music pieces during one turn.

Here, all of the three options that can be selected by the player are live show music pieces. However, the three options selectable by the player may include a first bonus or a second bonus which is not associated with a live show music piece in addition to a live show music piece. For example, No. 1 illustrated in FIG. 26 may be a first bonus, No. 2 may be a second bonus, and No. 3 may be a live show music piece. In this case, when No. 2 is selected, the second bonus is given to the player, and the options No. 5, No. 6, and No. 7 are newly presented.

In addition, here, a fixed first bonus and a fixed second bonus are associated with each live show music piece. However, for example, the first bonus group or the second bonus group may be associated with each live show music piece. In this case, a success probability of one or more effects is set in advance for each of the first bonus group and the second bonus group. Then, based on the first bonus group or the second bonus group associated with the live show music pieces obtained by the player, the given effect may be determined through a lottery.

In this manner, the player can obtain the first bonus and the second bonus by obtaining live show music pieces. Here, a performance parameter is required to obtain a live show music piece. However, the target performance item and the parameter value of the required performance parameter vary depending on the live show music piece.

Thus, when the required parameter value is insufficient for the live show music piece that the player intends to obtain, the player has to progress through the game while checking by how much the parameter value is insufficient. A plausible method for checking the insufficient value of the parameter value includes displaying the insufficient value on the live show preparation screen 290. However, for example, the operation of displaying the live show preparation screen 290 every turn is very troublesome for the player, and this may cause a reduction in the player's motivation to play the game. Thus, in the present embodiment, the following configuration is provided in order to enhance operability for the player.

FIG. 27 is a diagram for describing an example of a reservation dialog 295. In the live show preparation screen 290 illustrated in FIG. 24A, when the live show music piece details display field 292 corresponding to unobtainable live show music pieces or the like is tapped, the reservation dialog 295 illustrated in FIG. 27 is displayed. FIG. 27 illustrates, as an example, the reservation dialog 295 that is displayed when the live show music piece details display field 292 in the middle is tapped on the live show preparation screen 290 illustrated in FIG. 24A.

In an upper portion of the reservation dialog 295, similar to the confirmation dialog 294, the title name of a live show music piece, the first bonus, the second bonus, and the performance parameter necessary for obtaining the live show music piece are displayed. In addition, the performance parameter currently possessed by the player and the remaining performance parameter in the case of obtaining the live show music piece are displayed from a central portion to the lower side of the reservation dialog 295.

Here, the reservation dialog 295 is displayed when the requested performance parameter is insufficient. Thus, at least one parameter value of the remaining performance parameters displayed in the reservation dialog 295 when the live show music piece is obtained is negative. Specifically, in the example illustrated in FIG. 27, 100 points are required for both vocal and mind performance parameters in order to obtain the live show music piece. However, the current possessed points of the player for vocal and mind are “58 points” and “45 points”, respectively.

Thus, in the display indicating the values of the remaining performance parameters when obtaining the live show music piece, vocal is “−42” and mind is “−55”. Accordingly, the player can recognize that the performance parameters for vocal and mind are insufficient by “42 points” and “55 points”, respectively, in the reservation dialog 295.

In addition, a reserve button 295a and a cancel button 295b are provided at a lower portion of the reservation dialog 295. When the cancel button 295b is tapped, the reservation dialog 295 is closed and the live show preparation screen 290 is displayed. In other words, the cancel button 295b of the reservation dialog 295 has the same function as the cancel button 294b of the confirmation dialog 294. Also, the reserve button 295a of the reservation dialog 295 is provided instead of the OK button 294a of the confirmation dialog 294.

When the reserve button 295a is tapped, the live show music piece selected by the player is put in a reserved state. The reserved state is a state in which the live show music piece selected by the player is reserved. The player can reserve only one live show music piece from among the three presented live show music pieces. When the reserve button 295a is tapped, reservation information indicating the currently reserved state and the type of music or the like reserved by the player is stored.

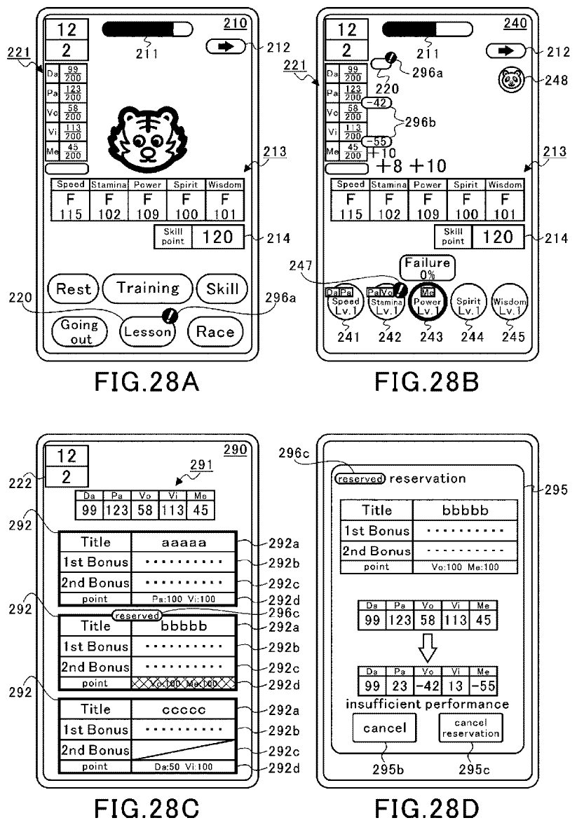

FIG. 28A is a first diagram for describing an example of a reservation notification mark 296a. FIG. 28B is a second diagram for describing an example of the reservation notification mark 296a. In the reserved state, the reservation notification mark 296a is displayed on the game screen 210 and the training screen 240. As illustrated in FIGS. 28A and 28B, the reservation notification mark 296a is superimposed and displayed on the live show preparation operation portion 220. By superimposing and displaying the reservation notification mark 296a on the live show preparation operation portion 220, the player is notified that the live show music piece is in a reserved state.

Here, the display mode of the reservation notification mark 296a is the same as the display mode of the event notification display 247. However, the display mode of the reservation notification mark 296a may be different from that of the event notification display 247. In addition, here, the same reservation notification mark 296a is displayed on the game screen 210 and the training screen 240. However, the display mode of the reservation notification mark 296a may be different between the game screen 210 and the training screen 240.

In addition to the reservation notification mark 296a, reservation notification information 296b is displayed on the training screen 240. The reservation notification information 296b is displayed near the performance parameter display portion 221. To be more specific, the reservation notification information 296b is displayed in the performance parameter display portion 221 at a position corresponding to a performance item for which points are insufficient for obtaining a reserved live show music piece.

That is, in the performance parameter display portion 221, the possessed value of the performance parameter, the value of the performance parameter that increases when the provisionally selected training is successful, and the reservation notification information 296b are displayed in association with each other. In other words, the reservation notification information 296b is displayed corresponding to the performance parameter whose possessed value is not equal to or greater than the required value among the plurality of performance parameters. That is, the reservation notification information 296b can be considered to be information corresponding to the performance parameter associated with the reserved live show music piece.

In the present embodiment, in the reservation notification information 296b, the points insufficient for obtaining the reserved live show music piece are displayed. That is, the reservation notification information 296b is information that can be used to identify the difference between the possessed value of the points possessed by the player and the required value required to obtain the live show music piece.

According to the present embodiment, since the reservation notification information 296b is displayed on the training screen 240, the player can easily recognize which performance item to obtain points for without the live show preparation screen 290 being displayed. That is, the player can recognize which training item should be selected without needing to perform an additional operation. As described above, according to the present embodiment, the operability and user-friendliness for the player are enhanced.

It should be noted that although the points insufficient for obtaining the reserved live show music piece are provided through notification in the reservation notification information 296b in this example, the content provided through notification by the reservation notification information 296b is not limited thereto. For example, the reservation notification information 296b may simply notify of a performance item for which points are insufficient. In addition, for example, the reservation notification information 296b may notify of a performance item for which points can be spent in order to obtain the live show music piece.

FIG. 28C is a diagram for describing an example of the live show preparation screen 290 in the reserved state. For example, let's assume that, in the state illustrated in FIG. 28A or 28B, the live show preparation operation portion 220 is tapped. When the live show preparation operation portion 220 is tapped with a live show music piece in a reserved state, the live show preparation screen 290 is displayed as illustrated in FIG. 28C. On the live show preparation screen 290, a reserved mark 296c is displayed in the live show music piece details display field 292 corresponding to the reserved live show music piece.

FIG. 28D is a diagram for describing an example of the reservation dialog 295 in the reserved state. For example, let's assume that in the state illustrated in FIG. 28C, the live show music piece details display field 292 corresponding to the reserved live show music piece, that is, the live show music piece details display field 292 in the middle of the live show preparation screen 290 is tapped. In this case, the reservation dialog 295 is displayed as illustrated in FIG. 28D. The reserved mark 296c is displayed in the reservation dialog 295 corresponding to the reserved live show music piece. At this time, the reservation dialog 295 is provided with a cancel reservation button 295c instead of the reserve button 295a.

When the cancel reservation button 295c provided in the reservation dialog 295 is tapped, the reservation information is deleted. With the deletion of the reservation information, the reservation dialog 295 is hidden and the live show preparation screen 290 is displayed. At this time, the reserved mark 296c is removed from the live show music piece details display field 292.

When the cancel reservation button 295c is tapped, a confirmation screen (not illustrated) may be displayed. Then, the reservation information may be deleted by tapping an OK button provided on the confirmation screen.

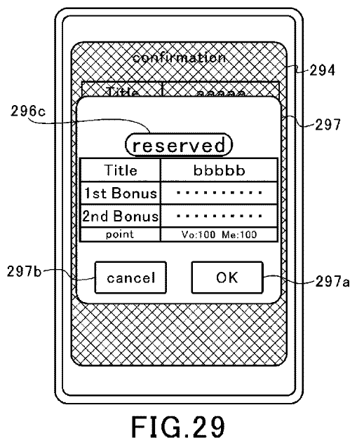

In addition, in the reserved state, the player can obtain a live show music piece different from the reserved live show music piece. For example, let's assume that, in the state illustrated in FIG. 28C, the live show music piece details display field 292 at the top of the live show preparation screen 290 is tapped. That is, in this example, on the live show preparation screen 290, instead of the live show music piece details display field 292 corresponding to the reserved live show music piece, the live show music piece details display field 292 corresponding to an unreserved and obtainable live show music piece is tapped. In this case, the confirmation dialog 294 illustrated in FIG. 24B is displayed as in the case of a non-reserved state. When the OK button 294a of the confirmation dialog 294 is tapped, a reserved confirmation dialog 297 illustrated in FIG. 29 is displayed.

FIG. 29 is a diagram for describing an example of the reserved confirmation dialog 297. The reserved confirmation dialog 297 is superimposed and displayed on the confirmation dialog 294. In the reserved confirmation dialog 297, information relating to the currently reserved live show music piece and the reserved mark 296c are displayed. In addition, a final confirmation button 297a and a cancel button 297b are provided at a lower portion of the reserved confirmation dialog 297. When the cancel button 297b is tapped, the reserved confirmation dialog 297 is hidden and the confirmation dialog 294 is displayed.

Further, when the final confirmation button 297a is tapped, the live show music piece newly selected by the player on the live show preparation screen 290 is obtained. At this time, the reservation information is erased. Further, in conjunction with obtaining the live show music piece, the reserved confirmation dialog 297 and the confirmation dialog 294 are hidden. At this time, the display 26 may display the live show preparation screen 290 provided with three new live show music piece details display fields 292. Alternatively, the screen displayed immediately before the live show preparation screen 290 may be displayed.

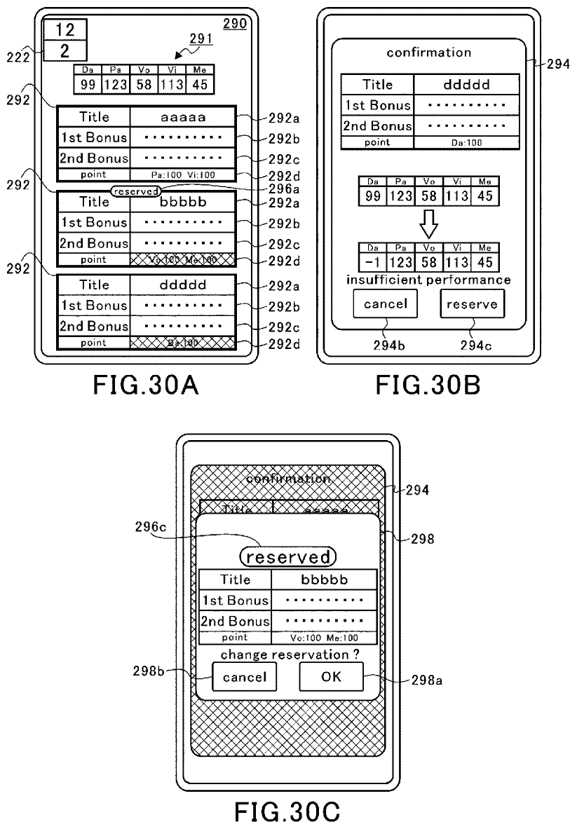

FIG. 30A is a diagram for describing another example of the live show preparation screen 290 in the reserved state. FIG. 30B is a diagram for describing an example of the confirmation dialog 294 at the time of a reservation change. For example, let's assume that two live show music pieces among three live show music pieces are in a state in which obtaining them is impossible. FIG. 30A illustrates a state in which live show music pieces corresponding to the live show music piece details display field 292 displayed at the middle and bottom of the live show preparation screen 290 cannot be obtained. In addition, FIG. 30A illustrates a state in which a live show music piece corresponding to the live show music piece details display field 292 displayed in the middle of the live show preparation screen 290 is reserved.

Then, let's assume that, in the state illustrated in FIG. 30A, the live show music piece details display field 292 at the bottom of the live show preparation screen 290 is tapped. That is, in this example, on the live show preparation screen 290, instead of the live show music piece details display field 292 corresponding to the reserved live show music piece, the live show music piece details display field 292 corresponding to an unreserved and unobtainable live show music piece is tapped. In this case, the confirmation dialog 294 illustrated in FIG. 30B is displayed.

In this case, the confirmation dialog 294 is provided with a reservation change button 294c instead of the OK button 294a. When the reservation change button 294c of the confirmation dialog 294 is tapped, a reservation change confirmation dialog 298 illustrated in FIG. 30C is displayed.

FIG. 30C is a diagram for describing an example of the reservation change confirmation dialog 298. The reservation change confirmation dialog 298 is superimposed and displayed on the confirmation dialog 294. In the reservation change confirmation dialog 298, information relating to the currently reserved live show music piece and the reserved mark 296c are displayed. Further, a change approval button 298a and a cancel button 298b are provided below the reservation change confirmation dialog 298. When the cancel button 298b is tapped, the reservation change confirmation dialog 298 is hidden and the confirmation dialog 294 is displayed.

When the change approval button 298a is tapped, the reservation information is changed. Specifically, the information indicating the live show music piece currently reserved is changed to the information indicating the live show music piece newly selected by the player on the live show preparation screen 290. As the reservation information is changed, the reservation change confirmation dialog 298 and the confirmation dialog 294 are hidden and the live show preparation screen 290 is displayed. At this time, on the live show preparation screen 290, the reserved mark 296c is displayed in the live show music piece details display field 292 corresponding to the newly reserved live show music piece.

As described above, in the present embodiment, a reservation for obtaining a live show music piece can be performed. In addition, in a state in which any live show music piece is reserved, the reservation may be canceled based on selection of a live show music piece different from the reserved live show music piece.

FIG. 31 is a diagram for describing an example of a notification information dialog 299. When the turn starts, the game screen 210 is displayed. When an event occurs, the game screen 210 is displayed upon the end of the display of the event screen. In each turn, when the game screen 210 is initially displayed, if the reserved live show music piece becomes obtainable, the notification information dialog 299 is superimposed and displayed on the game screen 210.

In other words, the notification information dialog 299 is displayed based on the possessed value of a performance parameter possessed by the player becoming equal to or greater than the required value of the performance parameter associated with the reserved live show music piece. In the notification information dialog 299, information related to the reserved live show music piece is displayed. The notification information dialog 299 is provided with the live show preparation operation portion 220 and a close operation portion 299b.

When the live show preparation operation portion 220 of the notification information dialog 299 is tapped, the notification information dialog 299 is hidden and the live show preparation screen 290 is displayed. That is, a plurality of live show music pieces are displayed based on an operation input by the player to the notification information dialog 299. By selecting the live show music piece details display field 292 corresponding to the reserved live show music piece on the live show preparation screen 290, the player can obtain the live show music piece.

When the reserved live show music piece becomes obtainable, a notification indicating that the reserved live show music piece is obtainable may be provided on the live show preparation screen 290. In addition, for example, when the live show preparation operation portion 220 of the notification information dialog 299 is tapped, the confirmation dialog 294 for obtaining the reserved live show music piece may be displayed.

When the close operation portion 299b is tapped in the notification information dialog 299, the notification information dialog 299 is hidden and the game screen 210 is displayed. In this case, the player taps the live show preparation operation portion 220 provided on the game screen 210 or the training screen 240 to display the live show preparation screen 290, allowing the player to obtain the reserved live show music piece.

Note that the notification information dialog 299 is displayed in conjunction with the start of the first turn after the reserved live show music piece becomes obtainable. However, after a reserved live show music piece has become obtainable, if the reserved state and the obtainable state of the live show music piece continue, the notification information dialog 299 may be displayed also at the start of the second or subsequent turns.

As described above, by displaying the notification information dialog 299, the operability for the player is further enhanced. In addition, there is no possibility that the player forgets to obtain a desired live show music piece, and user-friendliness is enhanced.

FIG. 32A is a diagram for describing an example of a live show start screen 300. FIG. 32B is a diagram for describing an example of a live show event screen 301. In a live show performance turn, the live show start screen 300 is displayed instead of the game screen 210. The performance parameter display portion 291 is displayed on the live show start screen 300. In addition, the live show preparation operation portion 220 and a live show start button 300a are displayed at a lower portion of the live show start screen 300.

When the live show preparation operation portion 220 is tapped on the live show start screen 300, the live show preparation screen 290 illustrated in FIG. 24A is displayed. Thus, even in a live show performance turn, the player can obtain a live show music piece. When the live show start button 300a is tapped, the live show event screen 301 illustrated in FIG. 32B is displayed.

The live show event screen 301 includes a cut-in image in which a plurality of characters are displayed. On the live show event screen 301, an image in which the nurture target character or the like is playing live is displayed. The number of characters displayed on the live show event screen 301 is, for example, one, three, or five. In this case, for example, the number of characters displayed on the live show event screen 301 may be increased as the number of live show music pieces obtained between the live show performance turns is increased. Alternatively, the number of characters displayed on the live show event screen 301 may be fixed.

In this case, only the cut-in image is displayed on the live show event screen 301, and live video is not actually displayed. However, a live video corresponding to the actually obtained live show music piece may be output. Alternatively, only live video corresponding to one or more of the obtained live show music pieces may be output.

As will be described in detail below, in the present embodiment, the live show cooperation members are determined in a preset turn. Thus, the reward provided after the end of a live show event may vary depending on the number of live show cooperation members and the type of characters. Specifically, in a predetermined turn, a character set in advance becomes a live show cooperation member, or a character obtained through a lottery becomes a live show cooperation member. That is, as the player proceed through turns, the number of live show cooperation members gradually increases. At this time, the character displayed on the live show event screen 301 may be determined from among the live show cooperation members through a lottery or the like. In this case, the display mode of the live show event screen 301 differs depending on the progress status of the nurture main game, thus enhancing the enjoyment of the game.

In addition, as the number of live show music pieces obtained by the player between the previous live show event and the current live show event increases, the reward provided after the end of the live show event may be more advantageous. For example, when the number of live show music pieces obtained by the player is less than a predetermined number, the live show event is successful, and a predetermined reward is given. On the other hand, when the number of live show music pieces obtained by the player is equal to or greater than the predetermined number, the live show event is regarded as a great success, and a reward more advantageous than that at the time of success is given.

In the present embodiment, the live show event is determined to be successful when no live show music piece is obtained. In this case, for example, a story element in which a fixed live show music piece is presented in the live show event is suitably provided. However, in a case where no live show music piece is obtained in the live show performance turn, the live show event may be determined as a failure or the game may be over.

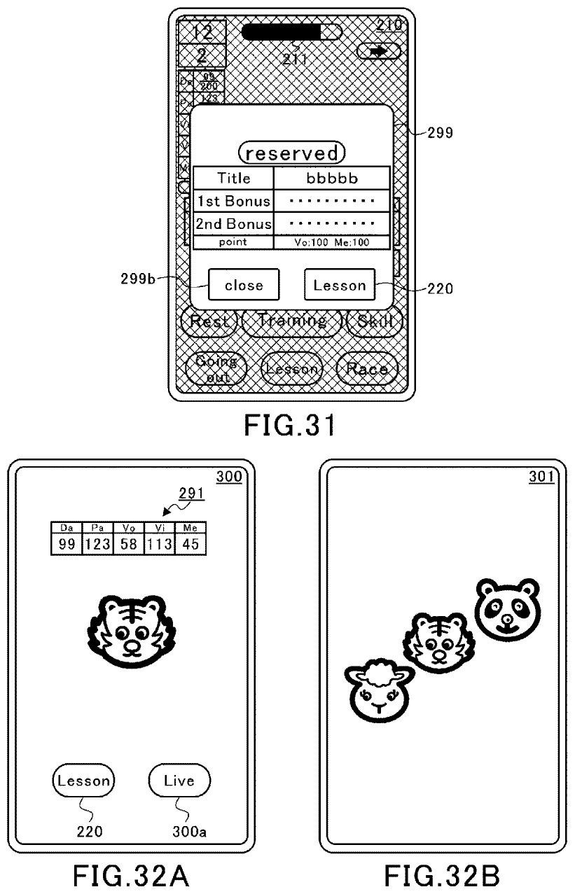

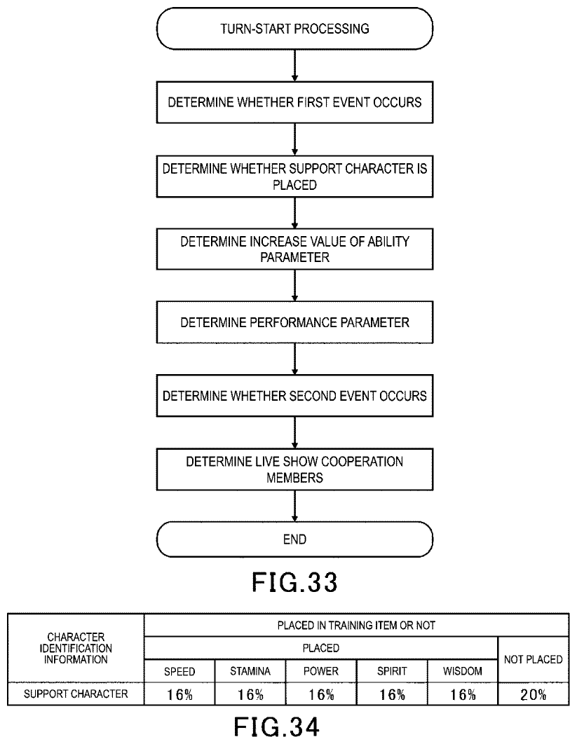

FIG. 33 is a diagram for describing a rough flow of turn-start processing. The nurture stage processing includes the turn-start processing executed at the start of each turn of the nurture game. Although the details of the turn-start processing will be described below, a rough flow of the turn-start processing will be described here.

During the nurture main game, processing to determine whether to cause various events to appear is executed in each turn. Events are roughly classified into three types: a scenario event, the above-described exclusive event provided for each nurture target character, and a support event. In each scenario, a scenario event, an exclusive event, and a support event that may appear in the nurture main game are predetermined.

A scenario event is an event set for each scenario of the nurture main game. In the present embodiment, a plurality of scenarios are provided, and the player can select a scenario. A scenario event appears for each scenario selected by the player. In other words, the scenario event that appears in the nurture main game is determined based on the scenario selected by the player.

The scenario event may include a scenario-specific event and a scenario-shared event. A scenario-specific event is an event associated with only one scenario. For example, a scenario-specific event associated with a first scenario appears only when the first scenario is selected and does not appear when another scenario is selected.

A scenario-shared event is an event that appears shared across a plurality of scenarios. Thus, the scenario-shared event appears in both cases when the first scenario is selected and when the second scenario is selected.

In this example, scenario-specific events and scenario-shared events are provided as scenario events. However, only one of the scenario-specific events and the scenario-shared events may be provided.

As described above, an exclusive event is an event set in advance for each character. In the nurture main game, an exclusive event for a character registered as a nurture target character by the player in the setting game, that is, the preparation stage processing, appears.

As described above, the support event is an event set in advance for each support card. In the nurture main game, a support event associated with the support card registered by the player in the setting game appears. The support event includes a first event that may occur at the start of a turn and a second event that may occur after training is performed. At the start of a turn, whether the first event occurs is determined based on a random number obtained at random and a first event table.

Whether the second event occurs is determined based on a randomly obtained random number and a second event table after the determination processing for each support character placed in the training is executed. Note that whether the second event occurs is determined for the placed support character only in a case where a support character is placed in training.

In the present embodiment, the first event is selected through a lottery from among the support events associated with the support cards registered in the deck by the player in the preparation stage processing. However, the present invention is not limited thereto, and a support event associated with a support card selected through a lottery from among all support cards implemented in the game may be selectable. In this case, the selection probability of the support event associated with the support card registered in the deck is suitably higher than the selection probability of the support card events associated with the support cards not registered in the deck.

As described above, whether a scenario event appears is determined based on the scenario. Also, whether an exclusive event and a support event appear is determined based on the nurture target character and the support card, respectively. These event types are classified by information that is referenced when determining whether an event appears.

On the other hand, in the present embodiment, each event is classified into one of six event classifications according to the content brought about by the appearance of the event. Here, each event is classified into one of the event classifications including a first hint event, a second hint event, a first ability event, a second ability event, an aptitude event, and a story event.

As described above, the first hint event and the second hint event are events that make it possible to possess or obtain a skill. The first ability event and the second ability event are events for increasing or decreasing the ability parameter of the nurture target character. The aptitude event is an event for increasing or decreasing the aptitude parameter of the nurture target character. The story event is an event for displaying a story related to a character appearing in the nurture game. Note that story events may change an ability parameter or an aptitude parameter in addition to a story being displayed.

Here, the scenario event includes a first hint event, a second hint event, a first ability event, a second ability event, an aptitude event, and a story event. The exclusive event and the support event include a first hint event, a second hint event, a first ability event, and a second ability event. Note that the exclusive event may include a story event.

In the present embodiment, the turn-start processing includes, in addition to processing of determining a scenario event and processing of determining an exclusive event, the “processing of determining whether a first event occurs”, “processing of determining whether a support character is placed”, “processing of determining an increase value of an ability parameter”, “processing of determining a performance parameter”, “processing of determining a second event”, and “processing of determining a live show cooperation member” illustrated in FIG. 33. Although various other processing is executed in the turn-start processing, the processing illustrated in FIG. 33 will be sequentially described here.

### Processing of Determining Whether First Event Occurs

A first event is selected through a lottery from among the support events (first events) associated with the support cards registered by the player in the preparation stage processing. Specifically, at the start of a turn, a random number is obtained at random, and based on the obtained random number and the first event table, whether the first event occurs and the content of the first event are determined. In the first event table, a selection ratio of “cause to occur” or “not cause to occur” is set for the first event. In the present embodiment, the first event includes four types of events: event a, event b, event c, and event d. For example, in the first event table, the probability of “causing” each event (events a to d) to occur is set to 20%, and the probability of “not causing” the first event is set to 20%. The selection ratio of the first event may be individually set for each support card, that is, for each support character.

### Processing of Determining Whether Support Character is Placed

FIG. 34 is a diagram for describing a placed/not placed table. As illustrated in FIG. 34, in the placed/not placed table, a selection ratio for whether a support character is placed in a training item (“placed in a training item” or “not placed”) is set. In the present embodiment, based on the placed/not placed table illustrated in FIG. 34, whether they are placed is determined for all support characters corresponding to all support cards registered by the player in the preparation stage processing. Specifically, at the start of a turn, a random number is obtained at random, and whether each support character is placed in a training item is determined based on the obtained random number and the placed/not placed table. However, the present invention is not limited thereto, and whether each support character is placed in a training item may be selected through a lottery from among all the support characters corresponding to all the support cards implemented in the game.

Specifically, as illustrated in FIG. 34, in the present embodiment, the support character is selected to be “placed” in any one of the training items speed, stamina, power, spirit, or wisdom with a probability of 16% and is selected to be “not placed” in any one of the training items with a probability of 20%. Note that as illustrated in FIG. 17A, a plurality of types of favored training are set for the support character. Thus, for example, the selection ratio of the placement of the support character in each training item may be set to be higher for the training item corresponding to the favored training compared to that for the training item corresponding to the training other than the favored training. When a lottery is performed, a lottery table in which the selection ratios in the lottery are determined may be stored in advance, or a lottery table may be created each time the lottery is performed.

When the training item in which the support character is placed is determined, the support character determined to be placed and the determined training item may be associated with each other and stored in the server 1000. More specifically, association information in which a training ID indicating the type of training item is associated with a character ID of a support character or a support card ID of a support card associated with the support character may be stored in the server 1000.

### Processing of Determining Increase Value of Ability Parameter

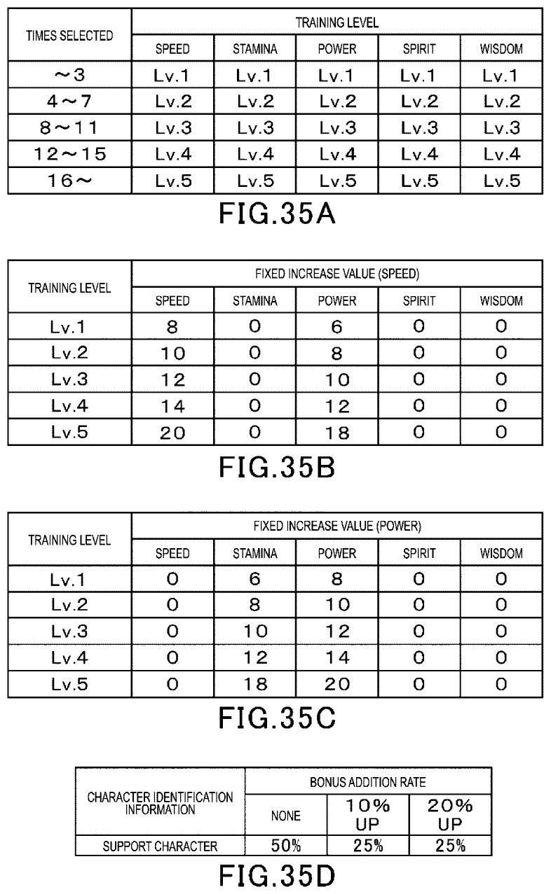

FIG. 35A is a diagram for describing a training level table. As illustrated in FIG. 35A, the training level is set to increase in accordance with the number of times each training is selected. Specifically, when the number of times each training is selected is 3 or less, each training level related to speed, stamina, power, spirit, and wisdom is set to “level 1”; when the number of times each training is selected is in a range from 4 to 7, each training level is set to “level 2”; when the number of times each training is selected is in a range from 8 to 11, each training level is set to “level 3”; when the number of times each training is selected is in a range from 12 to 15, each training level is set to “level 4”; and when the number of times each training is selected is 16 or more, each training level is set to “level 5”.

In the present embodiment, when the training selected by the player has been performed and has been successful, the value of a predetermined ability parameter is increased by the performed training item.

Specifically, in the present embodiment, if speed training is performed and it is successful, the values of the ability parameters for speed and power are increased.

In addition, if stamina training is performed and the training is successful, the values of the ability parameters for stamina and spirit are increased.

In addition, if power training is performed and the training is successful, the values of the ability parameters for stamina and power are increased.

In addition, if spirit training is performed and the training is successful, the values of the ability parameters for speed, power, and spirit are increased.

In addition, if wisdom training is performed and the training is successful, the values of the ability parameters for speed and wisdom are increased.

In the present embodiment, the value of the ability parameter to be increased when the training is successful is calculated by adding a value obtained by multiplying a fixed increase value determined corresponding to the performed training item and training level by a bonus addition rate described below to the fixed increase value.

FIG. 35B is a diagram for describing a fixed increase value (speed) table. FIG. 35C is a diagram for describing a fixed increase value table (power). That is, FIG. 35B indicates the fixed increase value when the training item is speed. Also, FIG. 35C indicates the fixed increase value when the training item is power.

As illustrated in FIGS. 35B and 35C, the fixed increase value table stores fixed increase values determined corresponding to the performed training item and the training level. Further, in the present embodiment, as illustrated in FIGS. 35B and 35C, the ability parameter is set to increase more as the training level is higher.

It should be noted that although description is omitted here, fixed increase value tables in a case where stamina, spirit, and wisdom are selected as the training item are also provided.

In addition to the fixed increase value described above, the bonus addition rate is determined based on the support character placed for each training item.

FIG. 35D is a diagram for describing a bonus addition rate table. In the present embodiment, the bonus addition rate is determined based on the support character determined to be placed in each training. To be specific, as illustrated in FIG. 35D, in the bonus addition rate table, the presence or absence of a bonus addition rate and the selection ratio of the addition rate (10% up or 20% up) are set for the support character.

As the bonus addition rate, “none” is selected at a probability of 50%, “10% up” is selected at a probability of 25%, and “20% up” is selected at a probability of 25%.

Then, a value obtained by multiplying the fixed increase value determined by the fixed increase value table by the bonus addition rate is derived as the bonus addition value. A value obtained by adding the bonus addition value to the fixed increase value is determined as the increase amount of the value of the ability parameter when the training is successful. For a training in which a plurality of support characters are placed, the bonus addition values of the plurality of placed support characters are added to the fixed increase value. In this manner, the increase amount of the ability parameter of the nurture target character in a case where the training is successful is determined for all training types.

### Processing of Determining Performance Parameter

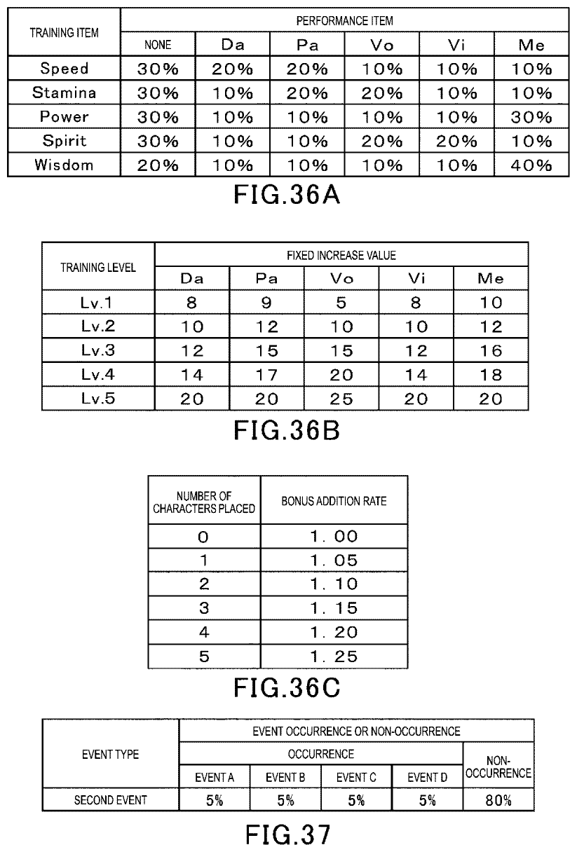

FIG. 36A is a diagram for describing performance items associated with training items. In a turn in which training can be performed, whether to associate a performance item with each of the five training items and the performance item to be associated are determined at the start of the turn. Specifically, first, whether to associate a performance item with the speed training item is determined through a lottery.

At this time, the probability that the performance item is determined not to be associated with the speed training item (indicated as “none” in the drawing) is set to 30%. In addition, the probabilities that the performance items dance, passion, vocal, visual, and mind are determined to be associated with the speed training item are set to 20%, 20%, 10%, 10%, and 10%, respectively.

Also, for example, the probability that the performance item is determined not to be associated with the power training item is set to 30%. In addition, the probabilities that the performance items dance, passion, vocal, visual, and mind are determined to be associated with the power training item are set to 10%, 10%, 10%, 10%, and 30%, respectively. Here, as illustrated in FIG. 36A, the probability for associating a performance item is set in advance for each training item and for each performance item.

In the present embodiment, a maximum of two performance items can be associated with one training item in one turn. Thus, for example, when determining for a performance item to be associated with the speed training item, the lottery is performed twice with probability illustrated in FIG. 36A. When the results of the two lotteries are both “none”, no performance item is associated with the speed training item.

For example, when the results of the two lotteries are both dance, only the dance performance item is associated with the speed training item. When any one of the performance items are determined in the first lottery, the second lottery may be performed excluding the performance item determined in the first lottery. In this case, the probability that each performance item is determined may be changed between the first lottery and the second lottery.

Here, in one turn, the same performance item may be associated with a plurality of training items. For example, depending on the result of the lottery, a dance performance item may be associated with both speed and stamina. However, in one turn, performance items may not be redundantly associated with a plurality of training items.

In addition, here, a performance item having a high probability of being associated with the training item and a performance item having a low probability of being associated with the training item are provided. For example, the dance and passion performance items are associated with the speed training item with higher probabilities than the other performance items.

Also, a training item with a high probability of being associated with the performance item and a training item with a low probability of being associated with the performance item are provided. For example, the probability that the mind performance item is associated with the power and wisdom training items is higher than the probability that the mind performance item is associated with the other training items.

However, the probability that each performance item is associated may be the same for all of the training items. The probability associated with each training item may be the same for all of the performance items. In any case, the probabilities illustrated in FIG. 36A are merely examples. The method of determining a performance item to be associated with a training item may be designed as appropriate.

FIG. 36B is a diagram for describing fixed increase values of performance parameters. When the performance items to be associated with the training items have been determined, for each performance item associated with a training item, a fixed increase value for the performance parameter is determined. A fixed increase value is preset for each performance item. The fixed increase value is set for each training level of the training item.

In FIG. 36B, the fixed increase value of the speed training item is illustrated. In this example, the dance performance item is associated with the speed training item. In this case, the fixed increase value of the dance performance parameter associated with the speed training item is determined. At this time, if the speed training level is level 1, the fixed increase value is determined to be 8, and if the speed training level is level 5, the fixed increase value is determined to be 20. As can be seen from FIG. 36B, the higher the training level, the higher the fixed increase value.

Here, in this example, the fixed increase value for each training level is different for each training item. That is, the table illustrated in FIG. 36B is provided for each training item. However, the table illustrated in FIG. 36B may be shared by all of the training items.

FIG. 36C is a diagram for describing the bonus addition rate of a performance parameter. When the fixed increase value is determined as described above, the bonus addition rate is determined next. The bonus addition rate varies depending on the number of characters placed in the training item associated with the performance item. In this example, the dance performance item is associated with the speed training item with a training level of level 5. At this time, the fixed increase value of the dance performance parameter is 20.

If no character is placed in the speed training item, the bonus addition rate is determined to be 1.00. When one to five characters are placed in the speed training item, the bonus addition rate is determined to be in a range from 1.05 to 1.25 in accordance with the number of placed characters as illustrated in FIG. 36C. Here, as the number of placed characters increases, the bonus addition rate increases.

The increase value of the performance parameter is calculated by multiplying the fixed increase value by the bonus addition rate. For example, in the above-described example, if the number of characters placed in the speed training item is 0, the increase value of the performance parameter is calculated as 20×1.00=20. Also, if the number of characters placed in the speed training item is 5, the increase value of the performance parameter is calculated as 20×1.25=25. The increase value of the performance parameter calculated in this manner is displayed at the performance parameter display portion 221 as illustrated in FIG. 21A.

Note that the above-described method of calculating the increase value of a performance parameter is merely an example. For example, the increase value of a performance parameter may be determined through a lottery. Further, the bonus addition rate is not essential. Also, the bonus addition rate may be determined based on other factors instead of or in addition to the number of placed characters.

### Processing of Determining Whether Second Event Occurs

FIG. 37 is a diagram for describing a second event table. A second event is selected through a lottery from among the support events (second events) associated with the support cards corresponding to the support characters placed in the respective training items. Specifically, after the “processing of determining whether a support character is placed”, a random number is obtained at random, and whether the second event occurs is determined based on the obtained random number and the second event table. In the second event table, a selection ratio of “cause to occur” or “not cause to occur” is set for the second event.

For example, as illustrated in FIG. 37, the second event includes four types of events: event A, event B, event C, and event D. For example, in the second event table, the probability of “causing” each event (events A to D) to occur is set to 5%, and the probability of “not causing” the second event is set to 80%. The selection ratio of the second event may be individually set for each support card, that is, for each support character.

In the present embodiment, after the “processing of determining whether a support character is placed”, processing is executed to determine whether a second event occurs for all support characters placed in the respective training items. Then, based on the determination of the occurrence of the second event, the event notification display 247 is displayed on the training screen 240. When the player selects the training in which the character for which a second event is determined to occur is placed, the second event occurs after the training is performed.

For example, in a case where the appearance of the second hint event of a support character placed in speed training is determined, when the speed training is performed, the second hint event always appears after the training is performed. However, when training other than the speed training is performed, the second hint event does not appear after the training is performed. At this time, when the second event is determined to occur for two or more characters, which second event is to be caused to occur is determined through a lottery, the priority of the preset support events, or the like.

For example, which of the plurality of second events is caused to occur is determined with equal probability. However, the present invention is not limited thereto, and weighting may be set in accordance with the type of the second event, and one of the plurality of second events may be determined to be caused to occur in accordance with the set weighting. Note that when a second event is determined to occur for two or more characters, all the determined second events may be caused to occur.

Here, for example, when the second event is determined to appear, the appearance information indicating whether a support event will appear may be associated with the support card or the support character associated with the second event and stored in the server 1000. More specifically, association information in which the appearance information is associated with a character ID of a support character or a support card ID of a support card associated with the support character may be stored in the server 1000.

### Processing of Determining Live Show Cooperation Member

As described above, a live show cooperation member is determined in a preset turn. Note that the method of determining a live show cooperation member is not particularly limited. For example, a preset character may be determined as a live show cooperation member for each predetermined turn. Alternatively, a character to be a live show cooperation member may be determined through a lottery for each predetermined turn. Furthermore, in all the turns, a character to be a live show cooperation member may be determined through a lottery.

In the nurture main game, when all the turns are finished, the nurture game ends. If the goal set for each character was not achieved during the nurture main game, the nurture game ends at this point.

Here, when the nurture game ends, the nurture target character nurtured in the nurture game is stored as a nurtured character. More strictly, the information relating to the nurtured character nurtured in the nurture game (hereinafter referred to as nurtured character information) is stored in association with the player ID. The nurtured character information is stored in both the player terminal 1 and the server 1000. The nurtured character information stored in association with the player ID includes an ability parameter, an aptitude parameter, an obtained skill, inheritance information, and the like.

When the nurture game ends, the evaluation score of the nurtured character is calculated. Here, the evaluation score is calculated based on the ability parameter, the aptitude parameter, the obtained skill, race results, and the like at the end of the nurture game. Note that the method for calculating the evaluation score, in other words, a calculation formula for calculating the evaluation score, is prepared in advance, and the evaluation score is calculated based on a predetermined calculation formula. The calculation method and the calculation formula for the evaluation score are not particularly limited. For example, the evaluation score may be calculated based on only a parameter that affects a race result when a nurtured character has run in a race in a team competition game or another racing game, such as an ability parameter, an aptitude parameter, an obtained skill, or the like at the end of the nurture game.

A nurture rank is set for the nurtured character based on the evaluation score. The nurture rank is an indicator of the strength of the nurtured character, and a range of evaluation score is associated with each nurture rank. For example, a nurture rank of “A+” is given to a nurtured character having an evaluation score ranging from 13000 to 14499, and a nurture rank of “S” is given to a nurtured character having an evaluation score ranging from 14500 to 15499. In this manner, by giving the nurture rank based on the evaluation score, the approximate strength of the nurtured character is made easy to understand. The nurtured character information includes the evaluation score and the nurture rank.

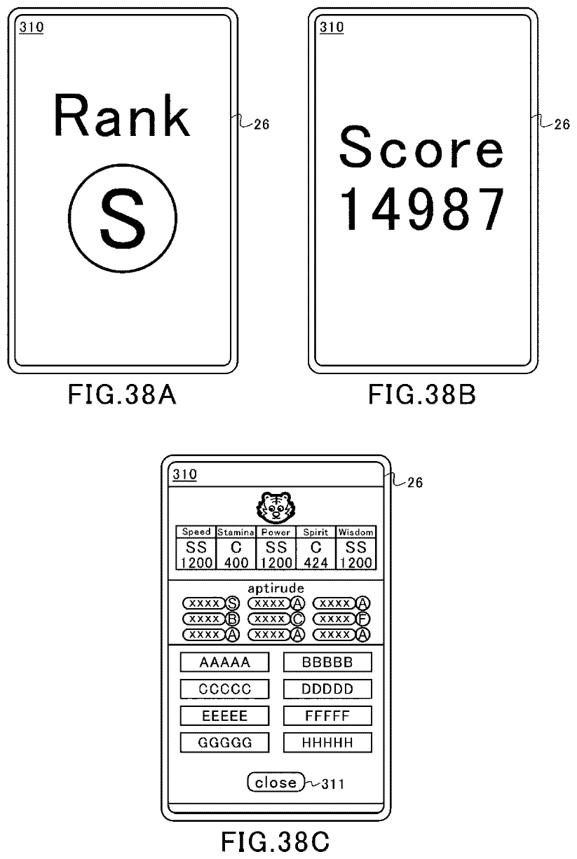

FIG. 38A is a first diagram for describing a nurture completion screen 310. FIG. 38B is a second diagram for describing the nurture completion screen 310. FIG. 38C is a third diagram for describing the nurture completion screen 310. When the nurture game ends, the nurture completion screen 310 is displayed on the display 26 as illustrated in FIG. 38A. On the nurture completion screen 310, the nurture rank of the nurtured character is first displayed, and thereafter, the evaluation score is displayed as illustrated in FIG. 38B.

When a predetermined amount of time elapses after the evaluation score is displayed, the ability parameter, the aptitude parameter, and the obtained skill of the nurtured character are displayed on the nurture completion screen 310 as illustrated in FIG. 38C. At this time, a close operation portion 311 is provided on the nurture completion screen 310. When the close operation portion 311 is tapped, the nurture completion screen 310 is hidden, and the home screen 100 is displayed on the display 26.

When the nurture game ends, a lottery for a factor to be obtained by the nurture target character is performed, and factor information is stored in association with the nurtured character. Although not illustrated, the player can display the factor information obtained by the nurtured character on the nurture completion screen 310.

As described above, in the nurture game, a nurtured character having an ability parameter, an aptitude parameter, an obtained skill, and the like is created. In the nurture game, since the placement of the support characters, the occurrence of various events, and the like are determined through a lottery, even if the same character is set as the nurture target character, nurtured characters having different parameters are created.

Next, the functional configuration of the player terminal 1 and the server 1000 for executing the above-described nurture game will be described.

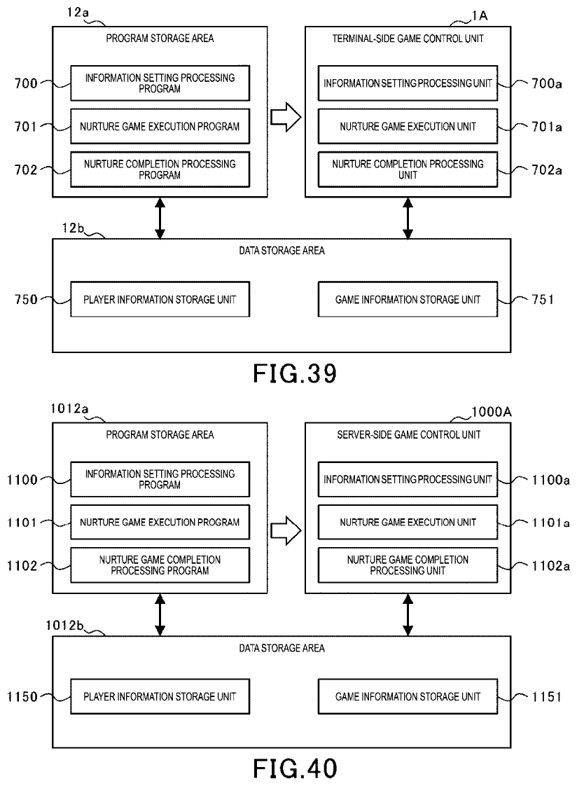

Functional Configuration of Player Terminal 1 FIG. 39 is a diagram for describing a configuration of the memory 12 in the player terminal 1 and a function as a computer. The memory 12 is provided with a program storage area 12a and a data storage area 12b. When the game is started, the CPU 10 stores a terminal-side game control program (module) in the program storage area 12a.

The terminal-side game control program includes an information setting processing program 700, a nurture game execution program 701, and a nurture completion processing program 702. Note that the programs listed in FIG. 39 are examples, and many other programs are provided in the terminal-side game control program.

In the data storage area 12b, a player information storage unit 750 and a game information storage unit 751 are provided as storage units that store data. It should be noted that the data storage area 12b is provided with a large number of other storage units. Here, information directly related to a game such as a nurture game (hereinafter referred to as game information) is stored in the game information storage unit 751.

Note that various types of information during the progress of each game such as the nurture game are also temporarily stored in the game information storage unit 751. Thus, all information related to the nurtured character nurtured in the nurture game is stored in the game information storage unit 751. In addition, for example, all information other than the game information, such as information related to the player or another player, setting information of the player terminal 1, and information related to a character that can be set as a nurture target character, is set as player information. The player information is stored in the player information storage unit 750.

The CPU 10 runs each program stored in the program storage area 12a and updates the data in each storage unit of the data storage area 12b. Then, the CPU 10 causes the player terminal 1 (computer) to function as a terminal-side game control unit 1A by run each program stored in the program storage area 12a. The terminal-side game control unit 1A includes an information setting processing unit 700a, a nurture game execution unit 701a, and a nurture completion processing unit 702a.

To be specific, the CPU 10 runs the information setting processing program 700 to cause the computer to function as the information setting processing unit 700a. Similarly, the CPU 10 runs the nurture game execution program 701 and the nurture completion processing program 702 to cause the computer to function as the nurture game execution unit 701a and the nurture completion processing unit 702a.

When various types of information are set in the player terminal 1, the information setting processing unit 700a stores information related to the setting in the player information storage unit 750 as player information. When the information in the player information storage unit 750 is updated, the information setting processing unit 700a transmits the updated information to the server 1000.

The nurture game execution unit 701a executes all processing related to the nurture game. To be specific, the nurture game execution unit 701a executes the preparation stage processing and the nurture stage processing.

The nurture completion processing unit 702a stores nurtured character information including the ability parameter, the aptitude parameter, the obtained skill, the inheritance information, the factor information, the type of the character used for nurturing, and the like of the nurtured character at the time of completion of the nurture game.

### Functional Configuration of Server 1000

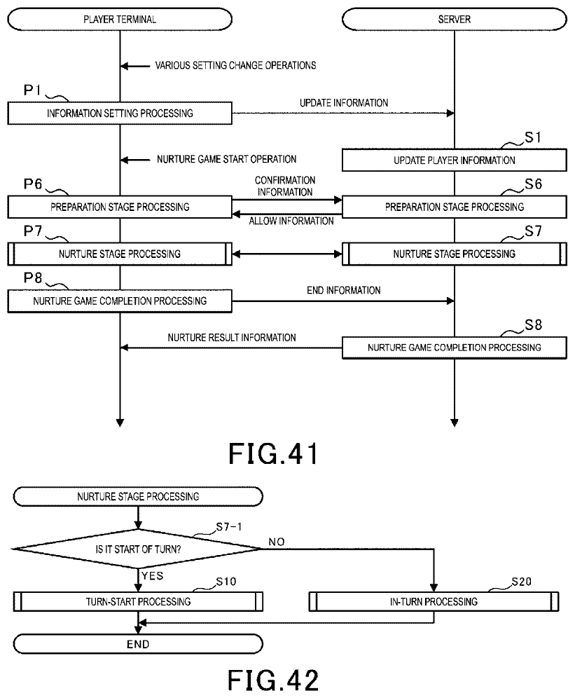

FIG. 40 is a diagram for describing a configuration of the memory 1012 in the server 1000 and a function as a computer. The memory 1012 is provided with a program storage area 1012a and a data storage area 1012b. When the game is started, the CPU 1010 stores a server-side game control program (module) in the program storage area 1012a.

The server-side game control program includes an information setting processing program 1100, a nurture game execution program 1101, and a nurture game completion processing program 1102. Note that the programs listed in FIG. 40 are examples, and many other programs are provided in the server-side game control program.

In the data storage area 1012b, a player information storage unit 1150 and a game information storage unit 1151 are provided as storage units that store data. It should be noted that the data storage area 1012b is provided with a large number of other storage units. Here, the game information of all the players is stored in the game information storage unit 1151 in association with the player ID. The player information of all the players is stored in the player information storage unit 1150 in association with the player ID.

The CPU 1010 runs each program stored in the program storage area 1012a and updates the data in each storage unit of the data storage area 1012b. Then, the CPU 1010 causes the server 1000 (computer) to function as a server-side game control unit 1000A by run each program stored in the program storage area 1012a. The server-side game control unit 1000A includes an information setting processing unit 1100a, a nurture game execution unit 1101a, and a nurture game end processing unit 1102a.

To be specific, the CPU 1010 runs the information setting processing program 1100 to cause the computer to function as the information setting processing unit 1100a. Similarly, the CPU 1010 runs the nurture game execution program 1101 and the nurture game completion processing program 1102 to cause the computer to function as the nurture game execution unit 1101a and the nurture game end processing unit 1102a.

When various types of information are set in the player terminal 1, the information setting processing unit 1100a updates the player information in the player information storage unit 1150 based on the update information received from the player terminal 1. In addition, the information setting processing unit 1100a measures time and updates the game points of each player.

The nurture game execution unit 1101a executes all processing related to the nurture game. To be specific, the nurture game execution unit 1101a executes the preparation stage processing and the nurture stage processing.

When the nurture game ends, the nurture game end processing unit 1102a derives the evaluation score, nurture rank, and the like for the nurtured character. In addition, the nurture game end processing unit 1102a determines the factor to be obtained by the nurtured character through a lottery. The game information storage unit 1151 stores nurtured character information including the ability parameter, the aptitude parameter, the obtained skill, the inheritance information, the factor information, the type of the character used for nurturing, and the like of the nurtured character associated with the player ID.

Note that the information setting processing unit 700a in the player terminal 1 and the information setting processing unit 1100a in the server 1000 are the same in that both store player information, but are different from each other in the specific content of processing and the range of stored player information. In addition, the nurture game execution unit 701a and the nurture game end processing unit 702a in the player terminal 1 and the nurture game execution unit 1101a and the nurture game end processing unit 1102a in the server 1000 are the same in that they execute processing related to the nurture game, but they have different roles, that is, different ranges of responsibility.

Processing performed by each functional unit in the player terminal 1 and the server 1000 will be described below with reference to a flowchart.

### Processing of Player Terminal 1 and Server 1000 Processing Related to Nurture Game

FIG. 41 is a sequence diagram for describing processing of the player terminal 1 and the server 1000 related to the nurture game. In the following description, the processing in the player terminal 1 is denoted by Pn (n is an arbitrary integer). Processing in the server 1000 is denoted by Sn (n is an arbitrary integer).

When the player performs various setting change operations on the player terminal 1, the information setting processing unit 700a of the player terminal 1 performs information setting processing of updating the player information storage unit 750 based on the operation input of the player (P1). In this information setting processing, the update information is transmitted to the server 1000. In the server 1000, when the update information is received, the information setting processing unit 1100a updates the player information of the player information storage unit 1150 (S1).

The player information updated in P1 and S1 includes, for example, profile information that can be set by the player. In addition, for example, when an operation of adding another player as a friend or an operation of removing a friend is input as a setting change operation, friend information, information related to friends, is updated. In P1 and S1, each of the information setting processing unit 700a and the information setting processing unit 1100a manages the game points spent to execute the nurture game. When the game points are less than the upper limit value, the information setting processing units 700a and 1100a measure time and give a predetermined value of game points to the player at predetermined time intervals.

When a nurture game start operation for starting the nurture game is input to the player terminal 1, the nurture game execution unit 701a executes the preparation stage processing (P6). Further, during the preparation stage processing, communication processing is executed between the player terminal 1 and the server 1000. In the server 1000, the nurture game execution unit 1101a executes the preparation stage processing based on the information received from the player terminal 1 (S6).

When the preparation stage processing (P6) ends, the nurture game execution unit 701a executes the nurture stage processing (P7). Further, during the nurture stage processing, communication processing is executed between the player terminal 1 and the server 1000. In the server 1000, the nurture game execution unit 1101a executes the nurture stage processing based on the information received from the player terminal 1 (S7). In practice, roles are shared between the player terminal 1 and the server 1000, and the nurture main game progresses with the nurture stage processing (P7) in the player terminal 1 and the nurture stage processing (S7) in the server 1000. However, as described below, a part of or all of the processing in the nurture stage processing (P7) of the player terminal 1 may be executed in the nurture stage processing (S7) in the server 1000, and a part of or all of the processing in the nurture stage processing (S7) in the server 1000 may be executed in the nurture stage processing (P7) in the player terminal 1.

FIG. 42 is a flowchart for describing the nurture stage processing in the server 1000. If it is the start of a turn (YES in S7-1), the nurture game execution unit 1101a of the server 1000 executes turn-start processing (S10). After the turn-start processing is executed, the nurture game execution unit 1101a executes the in-turn processing (S20).

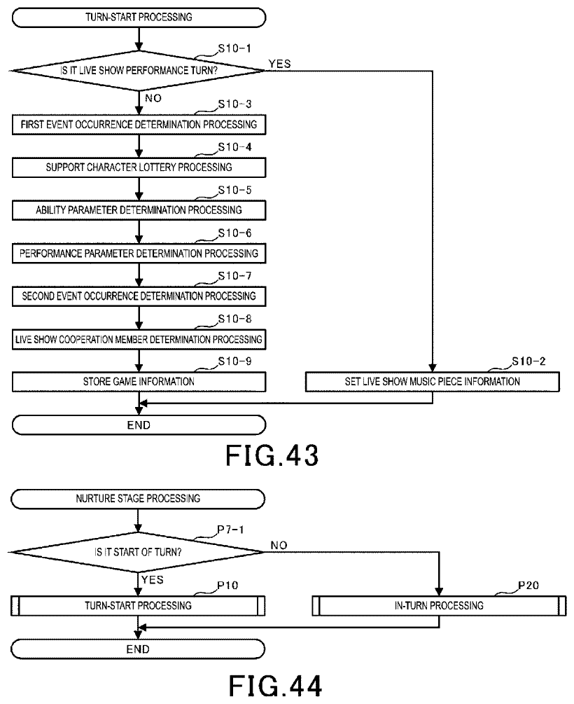

FIG. 43 is a flowchart for describing the turn-start processing in the server 1000. The nurture game execution unit 1101a of the server 1000 determines whether the current turn is a live show performance turn (S10-1). If it is a live show performance turn (YES in S10-1), the nurture game execution unit 1101a sets live show music piece information (S10-2). When the player obtains a live show music piece, information indicating the obtained live show music piece is stored in the player terminal 1 and the server 1000 as live show music piece information. Here, the live show music piece information obtained from the start of the nurture game or from the previous live show performance turn to the current turn is extracted and set to be received by the player terminal 1.

If the current turn is not a live show performance turn (NO in S10-1), the nurture game execution unit 1101a executes processing to determine whether a first event occurs (S10-3). Specifically, at the start of a turn, a random number is obtained at random, and based on the obtained random number and the first event table, whether the first event occurs and the content of the first event are determined.

Next, the nurture game execution unit 1101a executes support character lottery processing (S10-4). To be more specific, the nurture game execution unit 1101a refers to the placed/not placed table illustrated in FIG. 34 and determines through a lottery whether to place a support character in each training item. This processing is executed for each support character. When the placement of support characters in the training items is determined, the nurture game execution unit 1101a associates the support character ID with the training ID corresponding to the training item.

Here, a lottery may be further executed to determine whether to place a support character associated with a support card that is not registered in the deck by the player in a training item. Further, a lottery may be executed to determine whether a predetermined character appearing in the nurture game, which is different from a support character, is placed in the training item.

Next, the nurture game execution unit 1101a executes ability parameter determination processing (S10-5). In the ability parameter determination processing, each training is performed, and an increase value of the ability parameter of the nurture target character when the training is successful is determined. To be more specific, the nurture game execution unit 1101a references the training level table illustrated in FIG. 35A, the fixed increase value tables illustrated in FIGS. 35B and 35C, and the bonus addition rate table illustrated in FIG. 35D and determines the increase value of the ability parameter of the nurture target character when the training is successful for all the training items. In addition, the nurture game execution unit 1101a determines the energy decrease amount or the energy recovery amount when each training item is performed by referencing an energy table (not illustrated). The nurture game execution unit 1101a calculates a failure rate of training for each training item based on the energy of the nurture target character.

Next, the nurture game execution unit 1101a executes performance parameter determination processing (S10-6). In the performance parameter determination processing, a performance item to be associated with each training is determined. To be specific, the nurture game execution unit 1101a executes a lottery for determining whether to associate the performance item to the training item with the probability illustrated in FIG. 36A. This lottery is executed for each training item. Then, 0 to 2 performance items are associated with one training item.

In addition, the nurture game execution unit 1101a determines an increase value of the performance parameter when each training is executed and is successful. To be specific, the nurture game execution unit 1101a determines the increase value of the performance parameter associated with the training item based on the fixed increase value table (see FIG. 36B) and the bonus addition rate table (see FIG. 36C).

Next, the nurture game execution unit 1101a executes second event occurrence determination processing (S10-7). To be more specific, the nurture game execution unit 1101a references the second event table illustrated in FIG. 37 and determines through a lottery whether a second event occurs. The nurture game execution unit 1101a randomly obtains a random number and determines whether a second event occurs based on the obtained random number and the second event table. Here, for example, the nurture game execution unit 1101a determines whether to execute a support event set in advance for the support card associated with the training item through a lottery.

Further, the nurture game execution unit 1101a executes live show cooperation member determination processing (S10-8). Here, when the current turn is a preset turn, the live show cooperation member is determined according to a predetermined algorithm.

Then, the nurture game execution unit 1101a stores game information including information related to the lottery results in S10-3 to S10-8 in the game information storage unit 1151 so that the player terminal 1 can receive the game information (S10-9).

FIG. 44 is a flowchart for describing the nurture stage processing in the player terminal 1. The nurture game execution unit 701a of the player terminal 1 executes turn-start processing (P10) if it is the start of a turn (YES in P7-1) and executes in-turn processing (P20) if it is not the start of a turn.

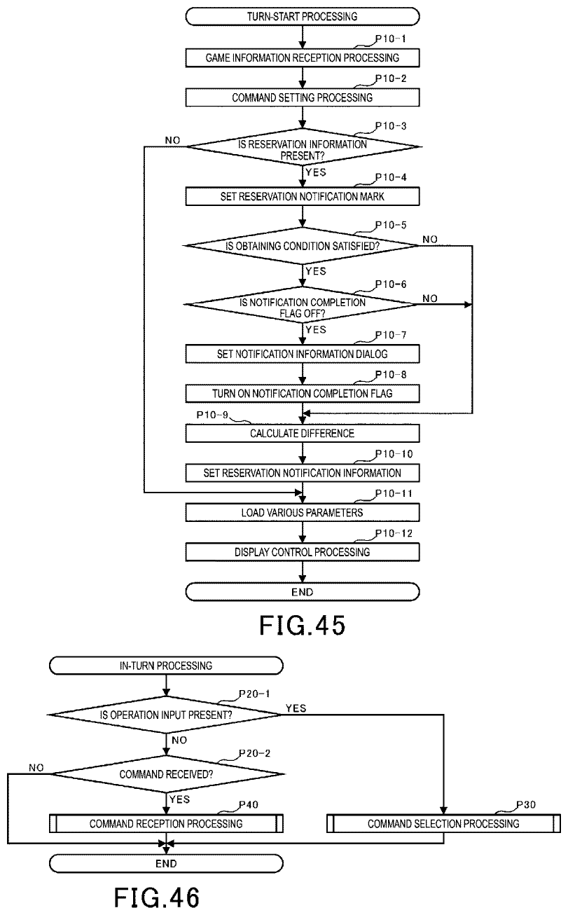

FIG. 45 is a flowchart for describing the turn-start processing in the player terminal 1. At the start of a turn, the nurture game execution unit 701a accesses the game information storage unit 1151 of the server 1000 and receives the game information stored in S10-9 from the server 1000 (P10-1).

Then, the nurture game execution unit 701a executes command setting processing of enabling the player to select various commands related to the nurture stage processing (P10-2). To be more specific, as illustrated in FIG. 19, for example, based on the current turn number, the nurture game execution unit 701a executes processing of enabling the player to select various commands such as the rest operation portion 215, the training operation portion 216, the skill operation portion 217, the going out operation portion 218, the race operation portion 219, and the live show preparation operation portion 220. In addition, the nurture game execution unit 701a executes processing of enabling the player to select the plurality of race selection operation portions 261 associated with the race operation portion 219.

In addition, in the command setting processing, the nurture game execution unit 701a enables the player to select a command including the speed operation portion 241, the stamina operation portion 242, the power operation portion 243, the spirit operation portion 244, and the wisdom operation portion 245 corresponding to each training item. The nurture game execution unit 701a executing processing of enabling the player to select one command from the plurality of commands.

In the command setting processing, the nurture game execution unit 701a executes processing of enabling the player to select the live show music piece details display field 292 on the live show preparation screen 290.

In a live show performance turn, the nurture game execution unit 701a makes the live show preparation operation portion 220 and the live show start button 300a selectable and makes the other operation portions, in other words, commands, non-selectable.

Next, the nurture game execution unit 701a determines whether reservation information is stored relating to obtaining a live show music piece (P10-3). When the reservation information is stored (YES in P10-3), the nurture game execution unit 701a sets a reservation notification mark (P10-4). Accordingly, in the game screen 210 and the training screen 240, the reservation notification mark 296a is displayed in the live show preparation operation portion 220.

Further, the nurture game execution unit 701a determines whether an obtaining condition for obtaining the reserved live show music piece is satisfied (P10-5). It should be noted that the obtaining condition is a value of a performance parameter required to obtain the reserved live show music piece. Here, it is determined that the obtaining condition is satisfied when the player has points equal to or greater than the required points for all of the performance parameters.

When the obtaining condition is satisfied (YES in P10-5), that is, when the points of the performance parameters possessed by the player are equal to or more than the required points for all the required performance items, the nurture game execution unit 701a determines whether the notification completion flag is off (P10-6). It should be noted that the notification completion flag indicates that the notification information dialog 299 has been displayed with respect to the reserved live show music piece. When the notification completion flag is off (YES in P10-6), the nurture game execution unit 701a sets the notification information dialog 299 (P10-7) and turns on the notification completion flag (P10-8). Thus, the notification information dialog 299 is displayed at the start of the turn in which the reserved live show music piece can be obtained.

If there is reservation information (YES in P10-3), the nurture game execution unit 701a calculates the difference between the value of the performance parameter required to obtain the reserved live show music piece and the points currently possessed by the player, that is, the shortage of the performance parameter (P10-9).

Then, the nurture game execution unit 701a sets the reservation notification information 296b based on the difference calculated in P10-9 (P10-10). As a result, the reservation notification information 296b is displayed near the performance parameter display portion 221.

In addition, the nurture game execution unit 701a loads the current values of the performance parameters and the current parameter values of the training items (P10-11). Next, the nurture game execution unit 701a executes display control processing of displaying the game screen 210, the training screen 240, the live show start screen 300, and the like based on the game information received from the server 1000, the current turn, and the processing results of P10-3 to P10-11 (P10-12). Accordingly, in the player terminal 1, it is determined to be during a turn, and the in-turn processing (P20) for receiving an operation input from the player is executed.

FIG. 46 is a flowchart for describing the in-turn processing in the player terminal 1. When an operation input by the player is performed on the player terminal 1 (YES in P20-1), the nurture game execution unit 701a executes command selection processing (P30). When there is no operation input (NO in P20-1) and a command is received from the server 1000 (YES in P20-2), the nurture game execution unit 701a executes command reception processing (P40).

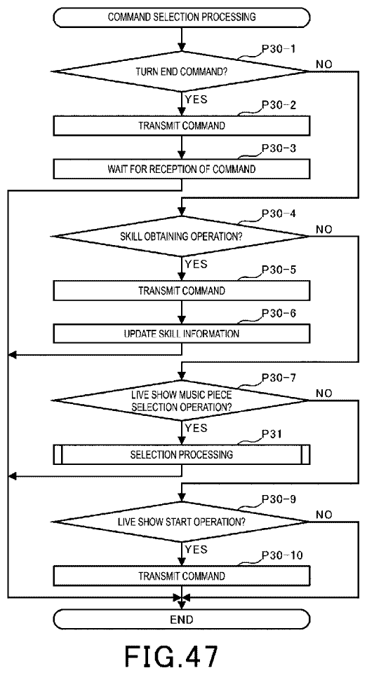

FIG. 47 is a flowchart for describing the command selection processing in the player terminal 1. When the player selects a turn end command (the rest operation portion 215, the going out operation portion 218, the speed operation portion 241, the stamina operation portion 242, the power operation portion 243, the spirit operation portion 244, the wisdom operation portion 245, or the race operation portion 274) which is a predetermined command for ending a turn (YES in P30-1), the nurture game execution unit 701a transmits the selected command to the server 1000 (P30-2). Then, the nurture game execution unit 701a waits for reception of a command from the server 1000 (P30-3).

When a skill obtaining operation (tap of the skill display field 251) for obtaining a skill is input (YES in P30-4), the nurture game execution unit 701a transmits a command corresponding to the input skill display field 251 to the server 1000 (P30-5). In addition, the nurture game execution unit 701a updates the skill information indicating that the corresponding skill has been obtained (P30-6).

When an operation related to obtaining a live show music piece (live show music piece selection operation) is input (YES in P30-7), the nurture game execution unit 701a executes selection processing (P31).

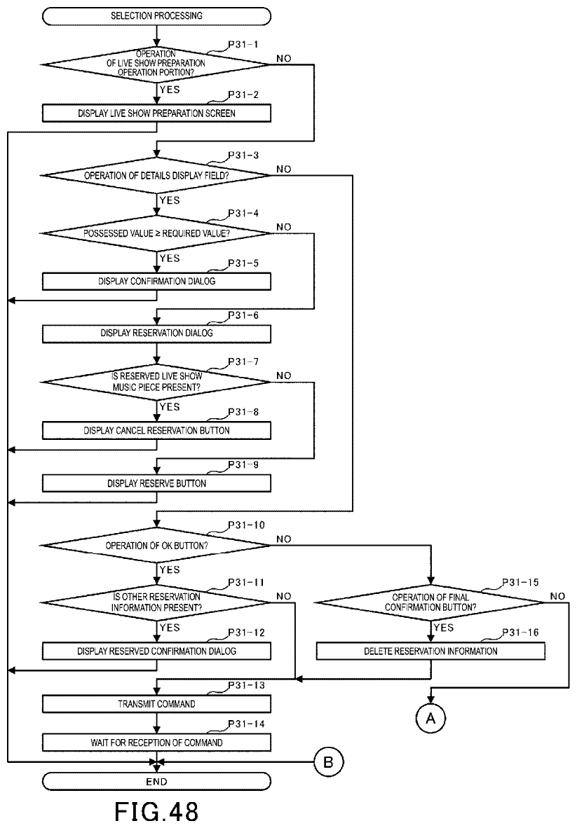

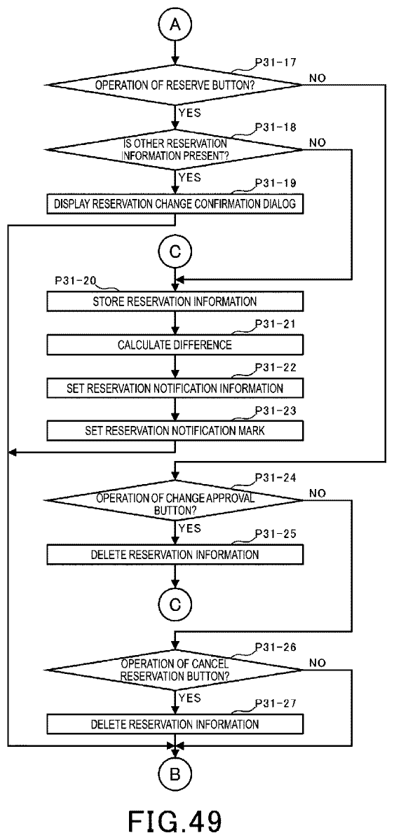

FIG. 48 is a first flowchart for describing the selection processing in the player terminal 1. FIG. 49 is a second flowchart for describing the selection processing in the player terminal 1. When the live show preparation operation portion 220 is operated (YES in P31-1), the nurture game execution unit 701a displays the live show preparation screen 290 (P31-2). When the live show music piece details display field 292 is operated while the live show preparation screen 290 is displayed (YES in P31-3), the nurture game execution unit 701a determines whether the possessed value of the performance parameter possessed by the player is equal to or greater than the required value required to obtain the selected live show music piece (P31-4). When the possessed value is equal to or greater than the required value (YES in P31-4), the nurture game execution unit 701a displays the confirmation dialog 294 (P31-5).

On the other hand, when the possessed value is less than the required value (NO in P31-4), the nurture game execution unit 701a displays the reservation dialog 295 (P31-6). When the selected live show music piece is reserved (YES in P31-7), the nurture game execution unit 701a displays the cancel reservation button 295c on the reservation dialog 295 (P31-8). On the other hand, when the selected live show music piece is not reserved (NO in P31-7), the nurture game execution unit 701a displays the reserve button 295a in the reservation dialog 295 (P31-9).

When the OK button 294a of the confirmation dialog 294 is operated (YES in P31-10), the nurture game execution unit 701a determines whether reservation information of a live show music piece different from the selected live show music piece is present (YES in P31-11). If other reservation information is present (YES in P31-11), the nurture game execution unit 701a displays the reserved confirmation dialog 297 (P31-12).

On the other hand, if no other reservation information is present (NO in P31-11), a command corresponding to the input live show music piece details display field 292 is transmitted to the server 1000 (P31-13). Then, the nurture game execution unit 701a waits for reception of a command from the server 1000 (P31-14).

When the final confirmation button 297a of the reserved confirmation dialog 297 is operated (YES in P31-15), the nurture game execution unit 701a deletes the reservation information (P31-16), and the processing moves to P31-13. In this case, the reservation information of the reserved live show music piece is deleted, and then the live show music piece selected by the player is obtained.

As illustrated in FIG. 49, when the reserve button 295a of the reservation dialog 295 is operated (YES in P31-17), the nurture game execution unit 701a determines whether other reservation information is stored (P31-18). If other reservation information is stored (YES in P31-18), the nurture game execution unit 701a displays the reservation change confirmation dialog 298 (P31-19).

On the other hand, if no other reservation information is stored (NO in P31-18), the nurture game execution unit 701a stores the reservation information of the live show music piece selected by the player (P31-20). Also, the nurture game execution unit 701a calculates the difference between the value of the performance parameter required to obtain the reserved live show music piece and the points currently possessed by the player, that is, the shortage of the performance parameter (P31-21).

Then, based on the difference calculated in P31-21, the nurture game execution unit 701a sets the reservation notification information 296b (P31-22) and sets the reservation notification mark 296a (P31-23).

When the change approval button 298a is operated (YES in P31-24), the nurture game execution unit 701a deletes the stored reservation information (P31-25) and executes the processing of P31-20 onward.

When the cancel reservation button 295c is operated (YES in P31-26), the nurture game execution unit 701a deletes the stored reservation information (P31-27).

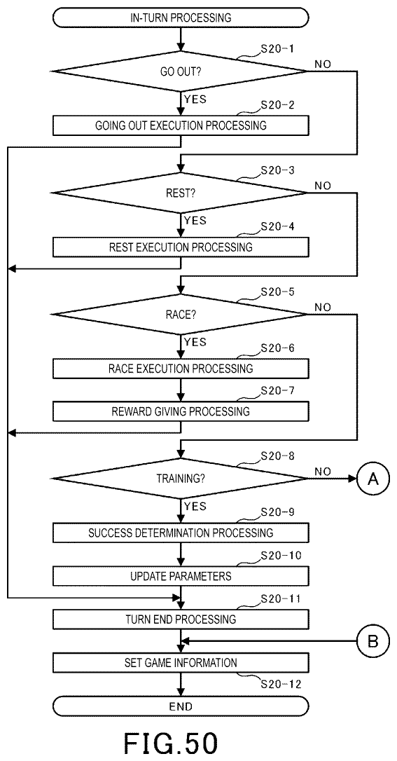

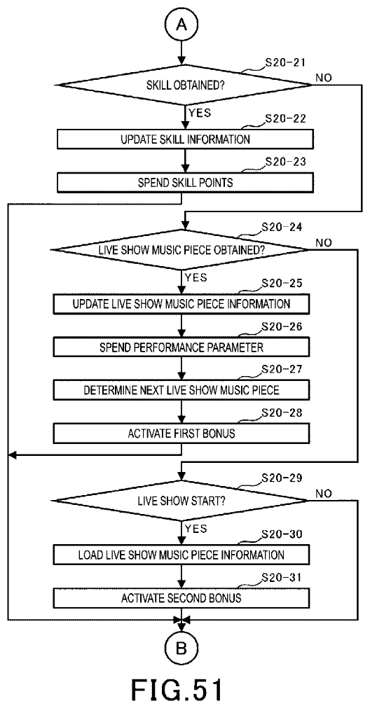

Returning to FIG. 47, when a live show start operation (tap of the live show start button 300a) is input (YES in P30-9), the nurture game execution unit 701a transmits a command indicating that a live show start operation has been performed to the server 1000 (P30-10). When the server 1000 receives the commands transmitted in P30-2, P30-5, P30-10, and P31-13, the in-turn processing (S20) is executed as illustrated in FIGS. 50 and 51.

FIG. 50 is a first flowchart for describing the in-turn processing in the server 1000. FIG. 51 is a second flowchart for describing the in-turn processing in the server 1000. When a command indicating an operation input of the going out operation portion 218 is received (YES in S20-1), the nurture game execution unit 1101a executes going out execution processing (S20-2). Here, a going out event is determined that increases the energy and mood parameters. Further, the parameters for the energy and mood are updated based on the determined going out event.

When a command indicating an operation input of the rest operation portion 215 is received (YES in S20-3), the nurture game execution unit 1101a executes rest execution processing (S20-4). Here, a rest event is determined that increases the energy parameter. Further, the parameter for the energy is updated based on the determined rest event.

When a command indicating an operation input to start a race is received (YES in S20-5), the nurture game execution unit 1101a executes race execution processing (S20-6). Here, a race simulation is executed based on the parameters of the nurture target character and the NPCs that run in the race. Further, the nurture game execution unit 1101a executes reward giving processing of giving a reward to the player (S20-7). Here, a reward is determined based on the result of the simulation, that is, the placing, the race development, and the like of the nurture target character, and the determined reward is given to the player.

When a command indicating execution of any training is received (YES in S20-8), the nurture game execution unit 1101a executes success determination processing (S20-9). Here, the success or failure of the training is determined based on the failure rate calculated in advance. Then, the nurture game execution unit 1101a updates various parameters based on the determination result of S20-9 (S20-10). Here, the ability parameters and the like are updated as determined in S10-5 at the start of the training. Also, the performance parameters are updated as determined in S10-6 at the start of the training.

Then, when a command or the processing accompanying the end of the turn is executed (S20-2, S20-4, S20-6, S20-7, S20-9, S20-10), the nurture game execution unit 1101a executes processing to end the current turn and transition to the next turn (S20-11). Accordingly, in the server 1000, the in-turn processing (S20) ends, and the server 1000 enters a standby state for turn-start processing (S10).

Various types of game information determined and updated in the processing illustrated in FIGS. 50 and 51 are set in the game information storage unit 1151 (S20-12). The game information set here is received by the player terminal 1.

Also, as illustrated in FIG. 51, upon receiving a command indicating an input of a skill obtaining operation (YES in S20-21), the nurture game execution unit 1101a updates the skill information in the game information storage unit 1151 (S20-22). In addition, the nurture game execution unit 1101a spends skill points in accordance with obtaining a skill (S20-23).

When a command indicating obtaining a live show music piece is received (YES in S20-24), the nurture game execution unit 1101a updates the live show music piece information indicating the obtained live show music piece (S20-25). In addition, the nurture game execution unit 1101a spends performance parameters in accordance with obtaining the live show music piece (S20-26).

In addition, the nurture game execution unit 1101a references the path information of the live show music piece and determines three live show music pieces that can be selected next by the player based on the obtained live show music piece (S20-27).

In addition, the nurture game execution unit 1101a activates the first bonus associated with the obtained live show music piece (S20-28). Here, as the activation of the first bonus, an increase in an ability parameter, recovery of energy, obtaining a skill hint, or the like are performed. As described above, the first bonus associated with the live show music piece is activated in the turn in which the live show music piece is obtained.

When a command indicating a live show start operation is received (YES in S20-29), the nurture game execution unit 1101a loads live show music piece information indicating the live show music piece obtained by the player (S20-30). Then, the nurture game execution unit 1101a activates the second bonus associated with the live show music piece obtained during the period from the start of the nurture main game or the previous live show performance turn to the current turn (live show performance turn) (S20-31). Here, as the activation of the second bonus, various parameters such as a favored training rate, an event occurrence rate, a skill hint occurrence rate, a race bonus, and a failure rate are updated. As described above, the second bonus associated with the live show music piece is activated in the turn in which the first live show performance event is executed after the live show music piece is obtained.

Here, the effect of the second bonus is continued after activation until the nurture main game ends. However, the effect of the second bonus may be effective only for a predetermined period. For example, after the activation of the second bonus, the effect of the second bonus may be continued only until the next live show performance turn or until a preset number of turns elapses.

Then, in the player terminal 1, when the game information (command) set in S20-12 is received, the command reception processing (P40) is executed in the in-turn processing (P20) illustrated in FIG. 46.

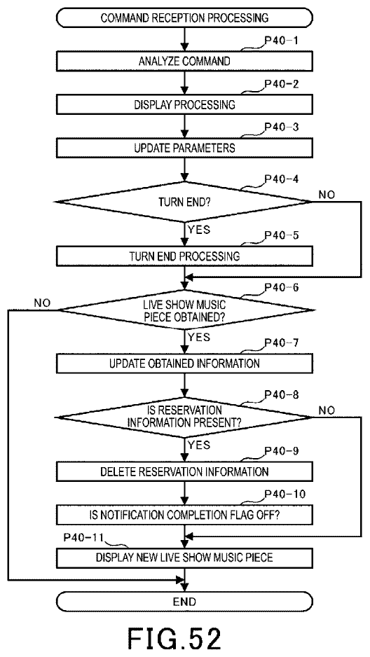

FIG. 52 is a flowchart for describing the command reception processing in the player terminal 1. The nurture game execution unit 701a analyzes the command received from the server 1000 (P40-1). Then, based on the received command, the nurture game execution unit 701a executes display processing of the nurture main game screen, such as displaying various event screens (P40-2).

In the live show performance turn, the number of characters and character types to be displayed on the live show event screen 301 are determined in accordance with the number of live show music pieces and the live show cooperation members. That is, in the live show performance turn, the display pattern of the live show event screen 301 is determined according to the number of live show music pieces and the live show cooperation members. Then, the nurture game execution unit 701a displays the live show event screen 301 in the determined display pattern. In this example, the display pattern of the live show event screen 301 is determined in the player terminal 1. However, the display pattern of the live show event screen 301 may be determined in the server 1000.

Further, the nurture game execution unit 701a updates various parameters in the game information storage unit 751 based on the received command (P40-3). Then, when a command to end the turn is received (YES in P40-4), the nurture game execution unit 701a executes turn end processing (P40-5). Here, after the end of display of various screens such as an event screen, processing of ending the current turn and starting the next turn is executed.

When a live show music piece is obtained (YES in P40-6), the nurture game execution unit 701a updates the information (obtained information) of the obtained live show music pieces (P40-7). When the reservation information of the live show music piece is stored, the nurture game execution unit 701a deletes the reservation information (P40-9) and turns off the notification completion flag (P40-10). In addition, the nurture game execution unit 701a displays the three new live show music pieces determined in the server 1000 on the live show preparation screen 290 (P40-11).

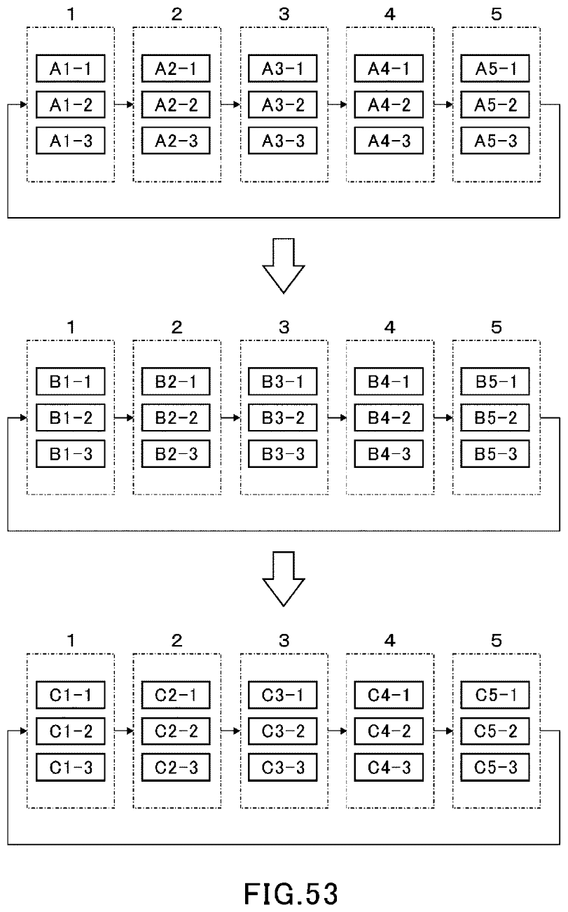

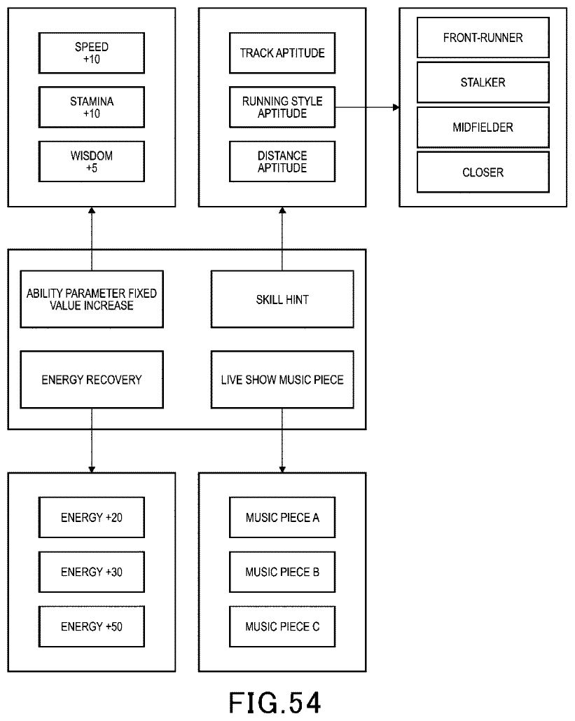

Next, a method of determining a live show music piece according to a modified example will be described. FIG. 53 is a first diagram for describing a method of determining a live show music piece according to a modified example. FIG. 54 is a second diagram for describing a method of determining a live show music piece according to a modified example. In the above-described embodiment, a case has been described in which three live show music pieces selectable by the player have a tree structure. In the modified example, the method of determining three live show music pieces that can be selected by the player is different from that in the above-described embodiment.

In the modified example, the time period of the nurture main game includes a total of five live show preparation periods from the first live show preparation period to the fifth live show preparation period. For example, the 1st turn to the 24th turn correspond to the first live show preparation period, the 25th turn to the 36th turn correspond to the second live show preparation period, and every 12 turns thereafter correspond to the third live show preparation period to the fifth live show preparation period, respectively. The final turn of each live show preparation period, that is, the 24th turn, the 36th turn, the 48th turn, the 60th turn, and the 72nd turn, are live show performance turns.

A plurality of banners and a selection order of the banners are preset for each live show preparation period. For example, as indicated by the dot-dash line in FIG. 53, five banners including from a first banner to a fifth banner are set for one live show preparation period. In addition, a banner order corresponding to the first banner→the second banner→the third banner→the fourth banner→the fifth banner is set for each banner.

In each banner, three banner slots are set. For example, banner slots A1-1, A1-2, and A1-3 are set in the first banner of the first live show preparation period, and the banner slots A5-1, A5-2, and A5-3 are set in the fifth banner of the first live show preparation period. The live show music pieces presented to the player is determined through a lottery for each banner slot.

To be more specific, in the first live show preparation period, first, a live show music piece is determined and set for each of the banner slots A1-1, A1-2, and A1-3 belonging to the first banner for the first live show preparation period. Thereafter, let's assume that the player obtains a live show music piece set in the banner slot A1-1, A1-2, or A1-3. In this case, a live show music piece is determined and set for each of the banner slots A2-1, A2-2, and A2-3 belonging to the second banner.

In this manner, the player can obtain any one of the three live show music pieces set in one banner. Then, when a live show music piece is obtained, three live show music pieces are newly set for the next banner. Then, when any one of the live show music pieces set in the banner slots A5-1, A5-2, and A5-3 belonging to the fifth banner is obtained, a live show music piece is determined and set next for each of the banner slots A1-1, A1-2, and A1-3 belonging to the first banner.

Thereafter, when the first live show preparation period ends and the second live show preparation period starts, a live show music piece is determined and set for each of the banner slots B1-1, B1-2, and B1-3 belonging to the first banner for the second live show preparation period. When the first live show preparation period transitions to the second live show preparation period, live show music pieces may be determined for the banner slots for the second live show preparation period, and the three live show music pieces to be presented to the player may be updated. Alternatively, at the stage of transition to the second live show preparation period, the three live show music pieces presented to the player in the first live show preparation period may be continuously selectable. In this case, when a live show music piece is selected for the first time in the second live show preparation period, live show music pieces are suitably determined for the banner slots belonging to the first banner for the second live show preparation period.

In this manner, in the modified example, a plurality of banners are provided for each live show preparation period, and three banner slots are set for each banner. Then, when a live show music piece is set for each banner slot and any live show music piece is obtained, three live show music pieces are set in the next banner.

FIG. 53 illustrates banners corresponding to three live show preparation periods from the first live show preparation period to the third live show preparation period. However, in practice, banners corresponding to the fourth live show preparation period and the fifth live show preparation period are also provided.

In addition, here, five banners are provided in each live show preparation period. However, the number of banners is not limited. Although the banner order returns to the first banner after the fifth banner in this example, when the banner order advances to the fifth banner, live show music pieces may not be determined thereafter, or live show music pieces may be repeatedly determined in the fifth banner thereafter.

Although the number of banners is equal in all of the live show preparation periods in this example, the number of banners may be different for the live show preparation periods. In addition, the number of banner slots belonging to each banner may be different depending on the banner.

In addition, a banner may not be provided for each live show preparation period. In this case, regardless of the live show preparation period, a banner may be selected in accordance with a preset banner order.

Next, with reference to FIG. 54, a method of randomly determining live show music pieces for the banner slots will be described. A live show music piece and/or live show skill is associated with each banner slot. The first bonus and the second bonus are associated with a live show music piece, and the second bonus is associated with a live show skill. In each banner slot, a live show music piece and/or a live show skill is determined as a reward that can be obtained when the player makes a selection. Here, the live show skill is roughly classified into three types: ability parameter fixed value increase, skill hint, and energy recovery.

In each banner slot, banner categories for determining live show music pieces are set. Here, a total of four banner categories are provided, including the above-described three types of live show skills and live show music piece. At least one of the four banner categories is set in each banner slot.

For example, as illustrated in FIG. 54, four banner categories of ability parameter fixed value increase, skill hint, energy recovery, and live show music piece are set in advance in the banner slot A1-1. In this manner, in the banner slot in which a plurality of banner categories are set, first, one banner category is determined by the lottery. In a banner slot in which only one banner category is set, the set one banner category is always determined. When the banner category is determined, the live show music piece or the live show skill associated with the banner category is further determined.

For example, three live show skills of “speed+10”, “stamina+10”, and “wisdom+5” are associated with the banner categories of the ability parameter fixed value increase set in the banner slot A1-1. That is, a live show skill for increasing any one of the five ability parameters for speed, stamina, power, spirit, and wisdom is associated with the banner category of the ability parameter fixed value increase. Then, when the banner category of the ability parameter fixed value increase is determined, one of the live show skills associated with the banner category is determined through a lottery.

The number of live show skills associated with the banner category of the ability parameter fixed value increase may be one or may be two or more. In addition, for each live show skill, a type of ability parameter and an increase value of each ability parameter are preset. For each live show skill, the spend amount of a performance parameter necessary for obtaining the live show skill may be set. Here, the increase value of the ability parameter is set to increase as the turns in the nurture main game progress. In other words, the increase value of the ability parameter due to the live show skill, or the average or maximum value of the increase values is larger in the fifth live show preparation period than in the first live show preparation period. That is, the increase value of the ability parameter due to the live show skill, or the average or maximum value of the increase values becomes larger in the live show preparation period positioned relatively in the latter half. Further, as the turns in the nurture main game progress, the spend amount of the performance parameter necessary for obtaining the live show skill increases.

In addition, for example, three live show skills of “energy +20”, “energy +30”, and “energy +50” are associated with the energy recovery banner categories set in the banner slot A1-1. That is, a live show skill for increasing the energy parameter by a predetermined value is associated with the energy recovery banner category. The number of live show skills associated with the energy recovery banner category may be one or may be two or more. In a case where a plurality of live show skills are associated with the energy recovery banner category, the increase values of the energy parameter are different among the plurality of live show skills.

In addition, for example, three aptitude frames for “track aptitude”, “running style aptitude”, and “distance aptitude” are associated with the banner category of the skill hint set in the banner slot A1-1. Then, when the banner category of the skill hint is determined, one of the aptitude frames associated with the banner category is determined through a lottery. A plurality of skill hints related to the corresponding aptitude are associated with each aptitude frame as live show skills.

For example, a skill hint related to dirt and a skill hint related to turf are associated with the aptitude frame of the track aptitude. The running style aptitude is associated with a plurality of skill hints related to four running styles of front-runner, stalker, midfielder, and closer and strategy. Similarly, the distance aptitude is associated with a plurality of skill hints related to four distances, namely short distance, mile, medium distance, and long distance. When the aptitude frame is determined, one of the skill hints associated with the aptitude frame is determined through a lottery.

The number of skill hints, that is, live show skills, associated with the aptitude frame may be one or two or more. However, a plurality of skill hints are always associated with one aptitude frame, and a skill hint may be determined as follows.

For example, when the aptitude frame is determined, among the determined aptitudes, the aptitude for which the nurture target character is an A aptitude is extracted. For example, when the running style aptitude is determined, the running style aptitude for which the nurture target character is an A aptitude is extracted. In this example, it is assumed that the nurture target character has an A aptitude for three running styles: front-runner, stalker, and midfielder. In this case, one of the running styles is determined through a lottery from among the three running styles of front-runner, stalker, and midfielder. Then, for example, when the running style of front-runner is determined through a lottery, the “front-runner skill hint” is determined as the live show skill.

Also, for example, when the distance aptitude is determined, the distance aptitude for which the nurture target character is an A aptitude is extracted. In this example, it is assumed that the nurture target character has an A aptitude for mile. In this case, mile distance aptitude is determined and “mile skill hint” is determined as the live show skill.

It should be noted that only the aptitude frame and the aptitude category associated with the aptitude frame (for example, turf or dirt in the case of track aptitude, or front-runner, stalker, midfielder, or closer in the case of running style aptitude) are displayed to the player when the aptitude frame is determined. In other words, the player is not notified of the specific skill hint that the player can obtain in advance.

Thus, for example, when the player selects “mile skill hint” as the live show skill, one skill hint classified as “mile skill hint” is determined and given to the player when the player selects “mile skill hint”. The specific skill hint to be actually given to the player may be determined in advance. In addition, the player may be notified of the content of the skill hint given to the player as a live show skill in advance. In any case, it is possible to reduce the possibility that a skill hint (live show skill) unnecessary for the nurture target character is included in the options.

In addition, for example, three different music pieces are associated with the banner categories of the live show music pieces set in the banner slot A1-1. That is, music pieces for which the first bonus and the second bonus can be obtained are associated with the banner category of live show music pieces. The number of music pieces associated with the banner category of live show music pieces may be one or two or more. When the banner category of live show music pieces is determined, one of the live show music pieces associated with the banner category is determined through a lottery.

For example, in the nurture main game second half, all live show music pieces associated with one banner slot may have been obtained. In this case, for example, one of the banner categories other than live show music pieces may be determined by performing a lottery again, and a live show skill may be presented as selectable instead of a live show music piece.

In addition, for example, a live show music piece may be determined without fail in at least one of three banner slots set for one banner. In this case, for example, a banner slot in which only a live show music piece is set as a banner category is provided. In this manner, it is possible to prevent the problem of live show music pieces being unable to be appropriately obtained before a live show performance turn.

As described above, in the modified example, three banner slots are set for each banner, a banner category is determined for each banner slot, and a live show music piece or a live show skill associated with the banner category is determined. The number and types of banner categories to be set and the number and types of live show music pieces and live show skills associated with the banner categories are set for each banner slot. Thus, it is possible for the player to obtain live show music pieces appropriately and reliably. In addition, for example, as the turns proceeds to the latter half, it is possible for the player to gradually obtain stronger live show skill.

Here, one aspect of an embodiment has been described with reference to the accompanying drawings. However, it goes without saying that the present invention is not limited to the above-described embodiment. It should be apparent that one skilled in the art can arrive at various modified examples or modified examples within the scope described in the claims, and it should be understood that the modified examples or modified examples also naturally belong in the technical scope.

The game properties and the processing in the player terminal 1 and the server 1000 described in the above embodiment are merely examples. In any case, the information processing program causes a computer (in the embodiment, the player terminal 1 and/or the server 1000) to execute the following processing.

### Processing Executed by Computer

Processing of enabling a player to select a first type command (for example, in the embodiment, execute training) that enables a predetermined parameter to be obtained (for example, in the embodiment, obtaining live show music pieces).

Processing of displaying a possessed value of a predetermined parameter (for example, in the embodiment, a performance parameter) possessed by the player on a selection screen (for example, in the embodiment, the training screen 240) that enables the player to select the first type command (for example, in the embodiment, P10-12).

Processing of obtaining a predetermined parameter based on the first type command being selected (for example, in the embodiment, P30-2).

Processing of displaying a plurality of options (for example, in the embodiment, live show music pieces) in which a reward obtainable by the player (for example, in the embodiment, the first bonus or the second bonus) and a required value of a predetermined parameter are associated, based on a second type command (for example, in the embodiment, obtaining live show music pieces), different from the first type command (for example, in the embodiment, P31-2), being selected.

Processing of determining whether the possessed value of the predetermined parameter possessed by the player is equal to or greater than the required value of the predetermined parameter associated with the option selected by the player (for example, in the embodiment, P31-4). Processing of giving a player a reward associated with the option selected by the player when the possessed value is equal to or greater than the required value (for example, in the embodiment, P31-13).

Processing of enabling the option selected by the player to be reserved when the possessed value is not equal to or greater than the required value (for example, in the embodiment, P31-6).

Processing of displaying notification information (for example, in the embodiment, the reservation notification information 296b) corresponding to the predetermined parameter associated with the option reserved on the selection screen (for example, in the embodiment, P10-10).

In the above-described embodiment, a plurality of performance parameters, which are predetermined parameters, are provided, and the reservation notification information 296b, which is notification information, is displayed in accordance with a predetermined parameter with a possessed value that is not equal to or greater than the required value. However, only one type of performance parameter may be provided.

In the above-described embodiment, the reservation notification information 296b, which is the notification information, is information that enables the difference between the possessed value and the required value to be identified. However, the content of the notification information is not limited thereto.

In addition, processing of displaying predetermined notification information (for example, in the embodiment, the notification information dialog 299) may be executed based on the possessed value of the predetermined parameter possessed by the player becoming equal to or greater than the required value of the predetermined parameter associated with the reserved option. However, the notification information dialog 299 is not essential.

In addition, in the processing of displaying the plurality of options, the plurality of options may be displayed based on an operation input by the player with respect to the notification information (for example, in the embodiment, P31-2).

In addition, processing of canceling a reservation may be executed based on an option, other than the reserved option, being selected in a state in which there is a reserved option (for example, in the embodiment, P31-16, P31-25). However, cancellation of a reservation is not essential.

An information processing program for executing the processing in the above-described embodiment and various modified examples may be stored in a non-transitory computer-readable storage medium and provided as a storage medium. Furthermore, a game terminal apparatus including the storage medium may be provided. In addition, the above-described embodiment and various modified examples may correspond to an information processing method for realizing each function and the steps illustrated in the flowcharts.

What is claimed is:

1. A non-transitory computer readable medium storing a program for causing a computer to execute:
processing of enabling a player to select a first type command that enables a predetermined parameter to be obtained;
processing of displaying a possessed value of the predetermined parameter possessed by the player on a selection screen that enables the player to select the first type command;
processing of obtaining the predetermined parameter based on the first type command being selected;
processing of displaying a plurality of options in which a reward obtainable by the player and a required value of the predetermined parameter are associated, based on a second type command, different from the first type command, being selected;
processing of determining whether the possessed value of the predetermined parameter possessed by the player is equal to or greater than the required value of the predetermined parameter associated with the option selected by the player;
processing of giving the player the reward associated with the option selected by the player when the possessed value is equal to or greater than the required value;
processing of enabling the option selected by the player to be reserved when the possessed value is not equal to or greater than the required value; and
processing of displaying, on the selection screen, notification information corresponding to the predetermined parameter associated with the option reserved.

2. The non-transitory computer readable medium according to claim 1, wherein
the predetermined parameter includes a plurality of predetermined parameters, and
the notification information is displayed corresponding to the predetermined parameter with the possessed value not being equal to or greater than the required value.

3. The non-transitory computer readable medium according to claim 2, wherein the notification information is information that enables a difference between the possessed value and the required value to be identified.

4. The non-transitory computer readable medium according to claim 1, wherein the program further causes the computer to execute processing of displaying predetermined notification information based on the possessed value of the predetermined parameter possessed by the player becoming equal to or greater than the required value of the predetermined parameter associated with the reserved option.

5. The non-transitory computer readable medium according to claim 4, wherein the processing of displaying the plurality of options includes displaying the plurality of options based on an operation input by the player with respect to the notification information.

6. The non-transitory computer readable medium according to claim 1, wherein the program further causes the computer to execute processing of canceling a reservation based on the option, other than the reserved option, being selected in a state in which any one of the options is reserved.

7. An information processing method executed by one or more computers, the one or more computers executing:
processing of enabling a player to select a first type command that enables a predetermined parameter to be obtained;
processing of displaying a possessed value of the predetermined parameter possessed by the player on a selection screen that enables the player to select the first type command;
processing of obtaining the predetermined parameter based on the first type command being selected;
processing of displaying a plurality of options in which a reward obtainable by the player and a required value of the predetermined parameter are associated, based on a second type command, different from the first type command, being selected;
processing of determining whether the possessed value of the predetermined parameter possessed by the player is equal to or greater than the required value of the predetermined parameter associated with the option selected by the player;
processing of giving the player the reward associated with the option selected by the player when the possessed value is equal to or greater than the required value;
processing of enabling the option selected by the player to be reserved when the possessed value is not equal to or greater than the required value; and
processing of displaying, on the selection screen, notification information corresponding to the predetermined parameter associated with the option reserved.

8. A game apparatus comprising:
one or more computers, wherein
the one or more computers execute:
processing of enabling a player to select a first type command that enables a predetermined parameter to be obtained;
processing of displaying a possessed value of the predetermined parameter possessed by the player on a selection screen that enables the player to select the first type command;
processing of obtaining the predetermined parameter based on the first type command being selected;
processing of displaying a plurality of options in which a reward obtainable by the player and a required value of the predetermined parameter are associated, based on a second type command, different from the first type command, being selected;
processing of determining whether the possessed value of the predetermined parameter possessed by the player is equal to or greater than the required value of the predetermined parameter associated with the option selected by the player;
processing of giving the player the reward associated with the option selected by the player when the possessed value is equal to or greater than the required value;
processing of enabling the option selected by the player to be reserved when the possessed value is not equal to or greater than the required value; and
processing of displaying, on the selection screen, notification information corresponding to the predetermined parameter associated with the option reserved.
